(19) United States
(12) Patent Application Publication
(10) Pub. No.: US 2025/0277065 A1
(43) Pub. Date: Sep. 4, 2025

(54) Substituted Pyridine-2,6-bis(phenylenephenolate) Complexes with Enhanced Solubility that are Useful as Catalyst Components for Olefin Polymerization

(71) Applicant: ExxonMobil Chemical Patents Inc., Baytown, TX (US)

(72) Inventors: Irene C. Cai, Webster, TX (US); Jo Ann M. Canich, Houston, TX (US); Alexander Z. Voskoboynikov, Moscow (RU); Gregory J. Smith-Karahalis, Houston, TX (US); Hua Zhou, Missouri City, TX (US); John R. Hagadorn, Houston, TX (US); Georgy p. Goryunov, Moscow (RU); Mikhail I. Sharikov, Moscow (RU); Andrei N. Iashin, Moscow (RU); Dmitry Uborsky, Moscow (RU); Catherine A. Faler, Houston, TX (US)

(21) Appl. No.: 18/862,683

(22) PCT Filed: Apr. 27, 2023
(86) PCT No.: PCT/US2023/066304

§ 371 Date: Nov. 4, 2024

Related U.S. Application Data
(60) Provisional application No. 63/338,164, filed on May 4, 2022.

(51) Int. Cl. C08F 4/64; C08F 210/02; C08F 210/06

(52) U.S. Cl. CPC C08F 4/64158; C08F 210/02; C08F 210/06

(57) ABSTRACT

Exemplary embodiments of the present technological advancement include pyridine-2,6-bis(phenylenephenolate) complexes that are useful as catalyst components for olefin polymerization and have improved solubility in non-aromatic hydrocarbons (e.g., isohexane). The improved solubility of these complexes was accomplished by the modification of the ligand framework at a specific position that led to improved solubility, but did not adversely affect the performance of the complex when used as a catalyst for olefin polymerizations.

### CROSS REFERENCE TO RELATED APPLICATIONS

This application claims the benefit of and priority to U.S. Provisional Application No. 63/338,164 filed May 4, 2022, the disclosure of which is incorporated herein by reference.

### FIELD

The present disclosure relates to bis(aryl phenolate) Lewis base transition metal complexes, catalyst systems including bis(aryl phenolate) Lewis base transition metal complexes, and polymerization processes to produce polyolefin polymers such as polyethylene based polymers and polypropylene based polymers.

### BACKGROUND

Polyolefins, such as polyethylene, typically have a comonomer, such as hexene, incorporated into the polyethylene backbone. These copolymers provide varying physical properties compared to polyethylene alone and are typically produced in a low pressure reactor, utilizing, for example, solution, slurry, or gas phase polymerization processes. Polymerization may take place in the presence of catalyst systems such as those using a Ziegler-Natta catalyst, a chromium based catalyst, or a metallocene catalyst.

Additionally, pre-catalysts (neutral, unactivated complexes) should be thermally stable at and above ambient temperature, as they are often stored for weeks before being used. The performance of a given catalyst is closely influenced by the reaction conditions, such as the monomer concentrations and temperature. For instance, the solution process, which benefits from being run at temperatures above 120° C., is particularly challenging for catalyst development. At such high reactor temperatures, it is often difficult to maintain high catalyst activity and high molecular weight capability as both attributes quite consistently decline with an increase of reactor temperature. With a wide range of polyolefin products desired, from high density polyethylene (HDPE) to elastomers (e.g., thermoplastic elastomers (TPE); ethylene-propylene-diene (EPDM)), many different catalyst systems may be needed, as it is unlikely that a single catalyst will be able to address all the needs for the production of these various polyolefin products. The strict set of requirements needed for the development and production of new polyolefin products makes the identification of suitable catalysts for a given product and production process a highly challenging endeavor.

Aromatic solvents are typically used to dissolve catalyst components in industrial olefin polymerization processes. However, typically it is challenging to replace aromatic solvents with non-aromatic solvents, such as isohexane, due to poor solubility of catalyst components in non-aromatic solvents.

Further information regarding the general state of the art for non-metallocene olefin polymerization catalysts can be found in Baier, M. C. (2014) “Post-Metallocenes in the Industrial Production of Poly-olefins,” Angew. Chem. Int. Ed., v.53, pp. 9722-9744, the entire contents of which are hereby incorporated by reference.

Further information regarding complexes can be found in: Goryunov, G. P. et al. (2021) “Rigid Postmetallocene Catalysts for Propylene Polymerization: Ligand Design Prevents the Temperature-Dependent Loss of Stereo- and Regioselectivities,” ACS Catalysis, v.11(13), pp. 8079-8086; US 2020/0255556; US 2020/0255555; US 2020/0254431; and US 2020/0255553, the entirety of each of which is hereby incorporated by reference.

### SUMMARY

A catalyst compound represented by Formula (I):

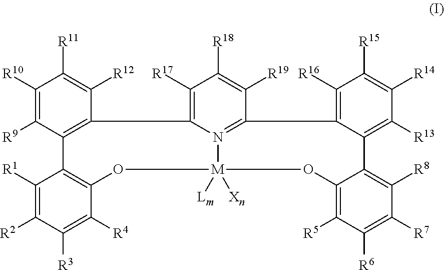

wherein:
M is a group 3, 4, or 5 metal;
L is a Lewis base;
X is an anionic ligand;
n is 1, 2, or 3;
m is 0, 1, or 2;
n+m is not greater than 4;
each of R¹, R², R³, R⁴, R⁵, R⁶, R⁷, and R⁸ is independently hydrogen, C₁-C₄₀ hydrocarbyl, C₁-C₁₂₀ substituted hydrocarbyl, a heteroatom or a heteroatom-containing group, or one or more of R¹ and R², R² and R³, R³ and R⁴, R⁵ and R⁶, R⁶ and R⁷, or R⁷ and R⁸ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R⁹, R¹⁰, R¹¹, and R¹² is independently hydrogen, C₁-C₄₀ hydrocarbyl, C₁-C₁₂₀ substituted hydrocarbyl, a heteroatom or a heteroatom-containing group, or one or more of R⁹ and R¹⁰, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹³, R¹⁴, R¹⁵, and R¹⁶ is independently hydrogen, C₁-C₄₀ hydrocarbyl, C₁-C₁₂₀ substituted hydrocarbyl, a heteroatom or a heteroatom-containing group, or one or more of R¹³ and R⁴, R⁴ and R⁵, or R⁵ and R¹⁶ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹⁷, R¹⁸, and R¹⁹ is independently hydrogen, C₁-C₄₀ hydrocarbyl, C₁-C₁₂₀ substituted hydrocarbyl, a heteroatom or a heteroatom-containing group, or one or more of R¹⁷ and R¹⁸, R¹⁸ and R¹⁹, or R¹⁷ and R¹⁹ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
any two L groups may be joined together to form a bidentate Lewis base;
an X group may be joined to an L group to form a monoanionic bidentate group;
any two X groups may be joined together to form a dianionic ligand group;
and with the proviso that at least one of R¹, R², R³, R⁶, R⁷, R⁸, R⁹, R¹⁰, R, R¹², R¹³, R¹⁴, R¹⁵, and R¹⁶ independently contains a silyl or germyl group of the form A(R^{a})(R^{b})(R^{c}) where A is Si or Ge and each of R^{a}, R^{b}, and R^{c} is independently C₁-C₄₀ hydrocarbyl or C₁-C₄₀ substituted hydrocarbyl, or one or more of R^{a} and R^{b}, R^{a} and R^{c}, or R^{b} and R^{c} may be joined to form one or more substituted hydrocarbyl rings or unsubstituted hydrocarbyl rings.

### DETAILED DESCRIPTION

Exemplary embodiments of the present technological advancement include pyridine-2,6-bis(phenylenephenolate) complexes that are useful as catalyst components for olefin polymerization and have improved solubility in non-aromatic hydrocarbons (e.g. isohexane). The improved solubility of these complexes was accomplished by the modification of the ligand framework at a specific position that led to improved solubility, but did not adversely affect the performance of the complex when used as a catalyst for olefin polymerizations.

For the purposes of the present disclosure, the numbering scheme for the Periodic Table Groups is used as described in Chemical and Engineering News, v.63(5), pg. 27 (1985). Therefore, a “group 4 metal” is an element from group 4 of the Periodic Table, e.g., Hf, Ti, or Zr.

The following abbreviations may be used herein: Me is methyl, Et is ethyl, Ph is phenyl, tBu is tertiary butyl, MAO is methylalumoxane, NMR is nuclear magnetic resonance, t is time, s is second, h is hour, psi is pounds per square inch, psig is pounds per square inch gauge, equiv. is equivalent, RPM is rotation per minute.

The specification describes transition metal complexes. The term complex is used to describe molecules in which an ancillary ligand is coordinated to a central transition metal atom. The ligand is bulky and stably bonded to the transition metal so as to maintain its influence during use of the catalyst, such as polymerization. The ligand may be coordinated to the transition metal by covalent bond and/or electron donation coordination or intermediate bonds. The transition metal complexes are generally subjected to activation to perform their polymerization or oligomerization function using an activator which, without being bound by theory, is believed to create a cation as a result of the removal of an anionic group, often referred to as a leaving group, from the transition metal.

The terms “substituent,” “radical,” “group,” and “moiety” may be used interchangeably.

“Conversion” is the amount of monomer that is converted to polymer product and is reported as mol % and is calculated based on the polymer yield and the amount of monomer fed into the reactor.

“Catalyst activity” is a measure of how active the catalyst is and is reported as the grams of product polymer (P) produced per millimole of catalyst (cat) used per hour (gP.mmolcat⁻¹.h⁻¹).

The term “heteroatom” refers to any group 13-17 element, excluding carbon. A heteroatom may include B, Si, Ge, Sn, N, P, As, O, S, Se, Te, F, Cl, Br, and I. The term “heteroatom” may include the aforementioned elements with hydrogens attached, such as BH, BH2, SiH2, OH, NH, NH2, etc. The term “substituted heteroatom” describes a heteroatom that has one or more of these hydrogen atoms replaced by a hydrocarbyl or substituted hydrocarbyl group(s).

Unless otherwise indicated, (e.g., the definition of “substituted hydrocarbyl”, “substituted aromatic”, etc.), the term “substituted” means that at least one hydrogen atom has been replaced with at least one non-hydrogen group, such as a hydrocarbyl group, a heteroatom, or a heteroatom containing group, such as halogen (such as Br, Cl, F or I) or at least one functional group such as —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring.

The term “substituted hydrocarbyl” means a hydrocarbyl radical in which at least one hydrogen atom of the hydrocarbyl radical has been substituted with at least one heteroatom (such as halogen, e.g., Br, Cl, F or I) or heteroatom-containing group (such as a functional group, e.g., —NR*₂, —OR*, —SeR*, —TeR*, —PR*₂, —AsR*₂, —SbR*₂, —SR*, —BR*₂, —SiR*₃, —GeR*₃, —SnR*₃, —PbR*₃, where each R* is independently a hydrocarbyl or halocarbyl radical, and two or more R* may join together to form a substituted or unsubstituted completely saturated, partially unsaturated, or aromatic cyclic or polycyclic ring structure), or where at least one heteroatom has been inserted within a hydrocarbyl ring. The term “hydrocarbyl substituted phenyl” means a phenyl group having 1, 2, 3, 4 or 5 hydrogen groups replaced by a hydrocarbyl or substituted hydrocarbyl group. For example, the “hydrocarbyl substituted phenyl” group can be represented by the formula:

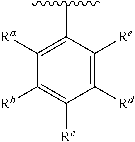

where each of R^{a}, R^{b}, R^{c}, R^{d}, and R^{e} can be independently selected from hydrogen, C₁-C₄₀ hydrocarbyl or C₁-C₄₀ substituted hydrocarbyl, a heteroatom or a heteroatom-containing group (provided that at least one of R^{a}, R^{b}, R^{c}, R^{d}, and R^{e} is not H), or two or more of R^{a}, R^{b}, R^{c}, R^{d}, and R^{e} can be joined together to form a C₄-C₆₂ cyclic or polycyclic hydrocarbyl ring structure, or a combination thereof.

The term “substituted aromatic,” means an aromatic group having 1 or more hydrogen groups replaced by a hydrocarbyl, substituted hydrocarbyl, heteroatom or heteroatom containing group.

The term “substituted phenyl,” mean a phenyl group having 1 or more hydrogen groups replaced by a hydrocarbyl, substituted hydrocarbyl, heteroatom or heteroatom containing group.

The term “substituted carbazole,” means a carbazolyl group having 1 or more hydrogen groups replaced by a hydrocarbyl, substituted hydrocarbyl, heteroatom or heteroatom containing group.

The term “substituted naphthyl,” means a naphthyl group having 1 or more hydrogen groups replaced by a hydrocarbyl, substituted hydrocarbyl, heteroatom or heteroatom containing group.

The term “substituted anthracenyl,” means an anthracenyl group having 1 or more hydrogen groups replaced by a hydrocarbyl, substituted hydrocarbyl, heteroatom or heteroatom containing group.

The term “substituted fluorenyl” means a fluorenyl group having 1 or more hydrogen groups replaced by a hydrocarbyl, substituted hydrocarbyl, heteroatom or heteroatom containing group.

The terms trihydrocarbylsilyl and trihydrocarbylgermyl means a silyl or germyl group bound to three hydrocarbyl groups. Examples of suitable trihydrocarbylsilyl and trihydrocarbylgermyl groups can include trimethylsilyl, trimethylgermyl, triethylsilyl, triethylgermyl, and all isomers of tripropylsilyl, tripropylgermyl, tributylsilyl, tributylgermyl, tripentylsilyl, tripentylgermyl, butyldimethylsilyl, butyldimethygermyl, dimethyloctylsilyl, dimethyloctylgermyl, and the like.

The terms dihydrocarbylamino and dihydrocarbylphosphino mean a nitrogen or phosphorus group bonded to two hydrocarbyl groups. Examples of suitable dihydrocarbylamino and dihydrocarbylphosphino groups can include dimethylamino, dimethylphosphino, diethylamino, diethylphosphino, and all isomers of dipropylamino, dipropylphosphino, dibutylamino, dibutylphosphino, and the like.

The term “substituted adamantyl” means an adamantyl group having 1 or more hydrogen groups replaced by a hydrocarbyl, substituted hydrocarbyl, heteroatom or heteroatom containing group.

The terms “alkoxy” and “alkoxide” mean an alkyl or aryl group bound to an oxygen atom, such as an alkyl ether or aryl ether group/radical connected to an oxygen atom and can include those where the alkyl/aryl group is a C₁ to C₁₀ hydrocarbyl (also referred to as a hydrocarbyloxy group). The alkyl group may be straight chain, branched, or cyclic. The alkyl group may be saturated or unsaturated. Examples of suitable alkoxy radicals can include methoxy, ethoxy, n-propoxy, iso-propoxy, n-butoxy, iso-butoxy, sec-butoxy, tert-butoxy, phenoxy.

The term “aryl” or “aryl group” means an aromatic ring and the substituted variants thereof, such as phenyl, 2-methyl-phenyl, xylyl, 4-bromo-xylyl. Likewise, heteroaryl means an aryl group where a ring carbon atom (or two or three ring carbon atoms) has been replaced with a heteroatom, such as N, O, or S. As used herein, the term “aromatic” also refers to pseudoaromatic heterocycles which are heterocyclic substituents that have similar properties and structures (nearly planar) to aromatic heterocyclic ligands, but are not by definition aromatic; likewise the term aromatic also refers to substituted aromatics.

The term “arylalkyl” means an aryl group where a hydrogen has been replaced with an alkyl or substituted alkyl group. For example, 3,5′-di-tert-butyl-phenyl indenyl is an indene substituted with an arylalkyl group. When an arylalkyl group is a substituent on another group, it is bound to that group via the aryl.

The term “alkylaryl” means an alkyl group where a hydrogen has been replaced with an aryl or substituted aryl group. For example, phenethyl indenyl is an indene substituted with an ethyl group bound to a benzene group. When an alkylaryl group is a substituent on another group, it is bound to that group via the alkyl.

The term “ring atom” means an atom that is part of a cyclic ring structure. By this definition, a benzyl group has six ring atoms and tetrahydrofuran has 5 ring atoms.

A heterocyclic ring is a ring having a heteroatom in the ring structure as opposed to a heteroatom substituted ring where a hydrogen on a ring atom is replaced with a heteroatom. For example, tetrahydrofuran is a heterocyclic ring and 4-N,N-dimethylamino-phenyl is a heteroatom-substituted ring. Other examples of heterocycles may include pyridine, imidazole, and thiazole.

The terms “hydrocarbyl radical,” “hydrocarbyl group,” or “hydrocarbyl” may be used interchangeably and are defined to mean a group consisting of hydrogen and carbon atoms only. For example, a hydrocarbyl can be a C₁-C₁₀₀ radical that may be linear, branched, or cyclic, and when cyclic, aromatic or non-aromatic. Examples of such radicals may include, but are not limited to, alkyl groups such as methyl, ethyl, propyl (such as n-propyl, isopropyl, cyclopropyl), butyl (such as n-butyl, isobutyl, sec-butyl, tert-butyl, cyclobutyl), pentyl (such as iso-amyl, cyclopentyl) hexyl (such as cyclohexyl), octyl (such as cyclooctyl), nonyl, decyl (such as adamantyl), undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl, and aryl groups, such as phenyl, benzyl, and naphthyl.

The term “adamantyl” and “adamantanyl” may be used interchangeably.

As used herein, Mn is number average molecular weight, Mw is weight average molecular weight, and Mz is z average molecular weight, wt % is weight percent, and mol % is mole percent. Molecular weight distribution (MWD), also referred to as polydispersity index (PDI), is defined to be Mw divided by Mn. Unless otherwise noted, all molecular weight units (e.g., Mw, Mn, Mz) are g/mol.

Unless otherwise indicated, as used herein, “high molecular weight” is defined as a number average molecular weight (Mn) value of 100,000 g/mol or more. “Low molecular weight” is defined as an Mn value of less than 100,000 g/mol.

Unless otherwise noted all melting points (Tm) are differential scanning calorimetry (DSC) second melt.

A “catalyst system” is a combination of at least one catalyst compound, at least one activator, an optional coactivator, and an optional support material. The terms “catalyst compound”, “catalyst complex”, “transition metal complex”, “transition metal compound”, “precatalyst compound”, and “precatalyst complex” are used interchangeably. When “catalyst system” is used to describe such a pair before activation, it means the unactivated catalyst complex (precatalyst) together with an activator and, optionally, a coactivator. When it is used to describe such a pair after activation, it means the activated complex and the activator or other charge-balancing moiety. The transition metal compound may be neutral as in a precatalyst, or a charged species with a counter ion as in an activated catalyst system. For the purposes of the present disclosure and the claims thereto, when catalyst systems are described as comprising neutral stable forms of the components, it is well understood by one of ordinary skill in the art, that the ionic form of the component is the form that reacts with the monomers to produce polymers. A polymerization catalyst system is a catalyst system that can polymerize monomers to polymer. Furthermore, catalyst compounds and activators represented by formulae herein are intended to embrace both neutral and ionic forms of the catalyst compounds and activators.

In the description herein, the catalyst may be described as a catalyst, a catalyst precursor, a pre-catalyst compound, catalyst compound or a transition metal compound, and these terms are used interchangeably.

An “anionic ligand” is anegatively charged ligand which donates one or more pairs of electrons to a metal ion. A “Lewis base” is a neutrally charged ligand which donates one or more pairs of electrons to a metal ion. Examples of Lewis bases include diethylether, trimethylamine, pyridine, tetrahydrofuran, dimethylsulfide, and triphenylphosphine. The term “heterocyclic Lewis base” refers to Lewis bases that are also heterocycles. Examples of heterocyclic Lewis bases include pyridine, imidazole, thiazole, and furan. The bis(aryl phenolate) Lewis base ligands are tridentate ligands that bind to the metal via two anionic donors (phenolates) and one heterocyclic Lewis base donor (e.g., pyridinyl group). The bis(aryl phenolate)heterocycle ligands are tridentate ligands that bind to the metal via two anionic donors (phenolates) and one heterocyclic Lewis base donor.

The term “continuous” means a system that operates without interruption or cessation. For example, a continuous process to produce a polymer would be one where the reactants are continually introduced into one or more reactors and polymer product is continually withdrawn.

### Transition Metal Complexes

In at least one embodiment, the catalyst compound represented by Formula (I) is as follows.

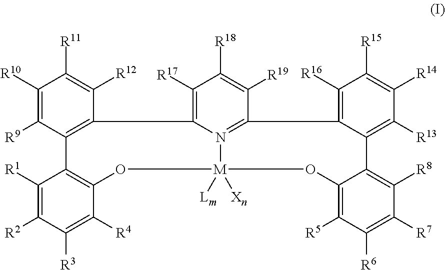

wherein:
M is a group 3, 4, or 5 metal;
L is a Lewis base;
X is an anionic ligand;
n is 1, 2, or 3;
m is 0, 1, or 2;
n+m is not greater than 4;
each of R¹, R², R³, R⁴, R⁵, R⁶, R⁷, and R⁸ is independently hydrogen, C₁-C₄₀ hydrocarbyl, C₁-C₁₂₀ substituted hydrocarbyl, a heteroatom or a heteroatom-containing group, or one or more of R¹ and R², R² and R³, R³ and R⁴, R⁵ and R⁶, R⁶ and R⁷, or R⁷ and R⁸ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R⁹, R¹⁰, R¹¹, and R¹² is independently hydrogen, C₁-C₄₀ hydrocarbyl, C₁-C₁₂₀ substituted hydrocarbyl, a heteroatom or a heteroatom-containing group, or one or more of R⁹ and R¹⁰, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹³, R¹⁴, R¹⁵, and R¹⁶ is independently hydrogen, C₁-C₄₀ hydrocarbyl, C₁-C₁₂₀ substituted hydrocarbyl, a heteroatom or a heteroatom-containing group, or one or more of R¹³ and R⁴, R⁴ and R⁵, or R⁵ and R¹⁶ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹⁷, R¹⁸, and R¹⁹ is independently hydrogen, C₁-C₄₀ hydrocarbyl, C₁-C₁₂₀ substituted hydrocarbyl, a heteroatom or a heteroatom-containing group, or one or more of R¹⁷ and R¹⁸, R¹⁸ and R¹⁹, or R¹⁷ and R¹⁹ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
any two L groups may be joined together to form a bidentate Lewis base;
an X group may be joined to an L group to form a monoanionic bidentate group
any two X groups may be joined together to form a dianionic ligand group;
and with the proviso that at least one of R¹, R², R³, R⁶, R⁷, R⁸, R⁹, R¹⁰, R, R¹², R¹³, R¹⁴, R¹⁵, and R¹⁶ independently contains a silyl or germyl group of the form A(R^{a})(R^{b})(R^{c}) where A is Si or Ge and each of R^{a}, R^{b}, and R^{c} is independently C₁-C₄₀ hydrocarbyl or C₁-C₄₀ substituted hydrocarbyl, or one or more of R^{a} and R^{b}, R^{a} and R^{c}, or R^{b} and R^{c} may be joined to form one or more substituted hydrocarbyl rings or unsubstituted hydrocarbyl rings.

In at least one embodiment, the catalyst compound represented by Formula (II) is as follows.

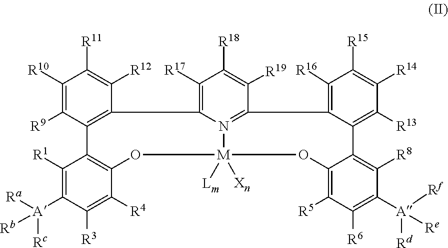

wherein:
M is a group 3, 4, or 5 metal;
L is a Lewis base;
X is an anionic ligand;
n is 1, 2, or 3;
m is 0, 1, or 2;
n+m is not greater than 4;
each of A′ and A″ is independently Si or Ge; and each of R^{a}, R^{b}, R^{c}, R^{d}, R^{e}, and R^{f} is independently C₁-C₄₀ hydrocarbyl or C₁-C₄₀ substituted hydrocarbyl, or one or more of R^{a} and R^{b}, R^{a} and R^{c}, R^{b} and R^{e}, R^{d} and R^{f} or R^{e} and R^{f} or R^{e} and R^{f} may be joined to form one or more substituted hydrocarbyl rings or unsubstituted hydrocarbyl rings;
each of R¹, R³, R⁴, R⁵, R⁶, and R⁸ is independently hydrogen, C₁-C₄₀ hydrocarbyl, C₁-C₁₂₀ substituted hydrocarbyl, a heteroatom or a heteroatom-containing group, or one or more of R³ and R⁴ or R⁵ and R⁶ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R⁹, R¹⁰, R¹¹, and R¹² is independently hydrogen, C₁-C₄₀ hydrocarbyl, C₁-C₁₂₀ substituted hydrocarbyl, a heteroatom or a heteroatom-containing group, or one or more of R⁹ and R¹⁰, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹³, R¹⁴, R¹⁵, and R¹⁶ is independently hydrogen, C₁-C₄₀ hydrocarbyl, C₁-C₁₂₀ substituted hydrocarbyl, a heteroatom or a heteroatom-containing group, or one or more of R¹³ and R⁴, R⁴ and R⁵, or R⁵ and R¹⁶ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹⁷, R¹⁸, and R¹⁹ is independently hydrogen, C₁-C₄₀ hydrocarbyl, C₁-C₁₂₀ substituted hydrocarbyl, a heteroatom or a heteroatom-containing group, or one or more of R¹⁷ and R¹⁸, R¹⁸ and R¹⁹, or R¹⁷ and R¹⁹ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
any two L groups may be joined together to form a bidentate Lewis base;
an X group may be joined to an L group to form a monoanionic bidentate group; and
any two X groups may be joined together to form a dianionic ligand group.

For example, M of Formula (I) or (II) can be a group 3, 4 or 5 metal, such as M can be a group 4 metal. Group 4 metals may include zirconium, titanium, and hafnium. In at least one embodiment, M is zirconium or hafnium.

Each L of Formula (I) or (II) can be independently selected from ethers, amines, phosphines, thioethers, esters, Et₂O, MeOtBu, Et₃N, PhNMe₂, MePh₂N, tetrahydrofuran, and dimethylsulfide, and each X can be independently selected from methyl, benzyl, trimethylsilyl, methyl(trimethylsilyl), neopentyl, ethyl, propyl, butyl, phenyl, hydrido, chloro, fluoro, bromo, iodo, trifluoromethanesulfonate, dimethylamido, diethylamido, dipropylamido, and diisopropylamido. In at least one embodiment, n of Formula (I) or (II) is 2 and each X is independently chloro, benzyl or methyl.

Each of R¹, R², R³, R⁴, R⁵, R⁶, R⁷, R⁸ of Formula (I) can be independently selected from hydrogen, C₁-C₄₀ hydrocarbyl, C₁-C₁₂₀ substituted hydrocarbyl, alkoxy, silyl, amino, aryloxy, halogen, or phosphino, or one or more of R¹ and R², R² and R³, R³ and R⁴, R⁵ and R⁶, R⁶ and R⁷, or R⁷ and R⁸ may be joined to form one or more substituted hydrocarbyl rings, unsubstituted hydrocarbyl rings, substituted heterocyclic rings, or unsubstituted heterocyclic rings each having 5, 6, 7, or 8 ring atoms.

Each of R¹, R³, R⁴, R⁵, R⁶, R⁸ of Formula (II) can be independently selected from hydrogen, C₁-C₄₀ hydrocarbyl, C₁-C₁₂₀ substituted hydrocarbyl, alkoxy, silyl, amino, aryloxy, halogen, or phosphino, or one or more of R³ and R⁴ or R⁵ and R⁶ may be joined to form one or more substituted hydrocarbyl rings, unsubstituted hydrocarbyl rings, substituted heterocyclic rings, or unsubstituted heterocyclic rings each having 5, 6, 7, or 8 ring atoms.

In at least one embodiment, one or more of R¹, R², R³, R⁴, R⁵, R⁶, R⁷, R⁸ of Formula (I) or one or more of R¹, R³, R⁴, R⁵, R⁶, R⁸ of Formula (II) is independently selected from hydrogen, methyl, ethyl, propyl, butyl, pentyl, hexyl, heptyl, octyl, nonyl, decyl, undecyl, dodecyl, phenyl, substituted phenyl, biphenyl or an isomer thereof, which may be halogenated (such as perfluoropropyl, perfluorobutyl, perfluoroethyl, perfluoromethyl), substituted hydrocarbyl radicals and all isomers of substituted hydrocarbyl radicals including trimethylsilylpropyl, trimethylsilylmethyl, trimethylsilylethyl, phenyl, or all isomers of hydrocarbyl substituted phenyl including methylphenyl, dimethylphenyl, trimethylphenyl, tetramethylphenyl, pentamethylphenyl, diethylphenyl, triethylphenyl, propylphenyl, dipropylphenyl, tripropylphenyl, dimethylethylphenyl, dimethylpropylphenyl, dimethylbutylphenyl, or dipropylmethylphenyl.

For example, R⁴ and R⁵ of Formula (I) or (II) can be independently C₁-C₂₀ alkyl, such as R⁴ and R⁵ can be tert-butyl, or adamantanyl. In at least one embodiment, R⁴ and R⁵ are independently selected from unsubstituted phenyl, substituted phenyl, unsubstituted carbazole, substituted carbazole, unsubstituted naphthyl, substituted naphthyl, unsubstituted anthracenyl, substituted anthracenyl, unsubstituted fluorenyl, or substituted fluorenyl, a heteroatom or a heteroatom-containing group, such as R⁴ and R⁵ can be independently unsubstituted phenyl or 3,5-di-tert-butylbenzyl. Furthermore, either (1) R⁴ can be C₁-C₂₀ alkyl (e.g., R⁴ can be tert-butyl) and R⁵ can be an aryl, or (2) R⁵ can be C₁-C₂₀ alkyl (e.g., R⁵ can be tert-butyl) and R⁴ can be an aryl. Alternately, R⁴ and/or R⁵ can be independently a heteroatom, such as R⁴ and R⁵ can be a halogen atom (such as Br, Cl, F, or I). Alternately, R⁴ and/or R⁵ can be independently a silyl group, such as R⁴ and R⁵ can be a trialkylsilyl or triarylsilyl group, where the alkyl is a C₁ to C₃₀ alkyl (such methyl, ethyl, propyl (such as n-propyl, isopropyl, cyclopropyl), butyl (such as n-butyl, isobutyl, sec-butyl, tert-butyl, cyclobutyl), pentyl (such as iso-amyl, cyclopentyl), hexyl (such as cyclohexyl), octyl (such as cyclooctyl), nonyl, decyl (such as adamantyl), undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, or tricontyl, and the aryl is a C₆ to C₃₀ aryl (such as phenyl, benzyl, and naphthyl). Usefully R⁴ and R⁵ can be triethylsilyl.

In some embodiments, R⁴ and R⁵ is independently a C₁-C₄₀ hydrocarbyl, a C₁-C₄₀ substituted hydrocarbyl, more preferably, each R⁴ and R⁵ is independently selected from a tertiary hydrocarbyl groups (such as tert-butyl, tert-pentyl, tert-hexyl, tert-heptyl, tert-octyl, tert-nonyl, tert-decyl, tert-undecyl, tert-dodecyl) and cyclic tertiary hydrocarbyl groups (such as such as 1-methylcyclohexyl, 1-norbornyl,1-adamantanyl, or substituted 1-adamantanyl).

In some embodiments, R⁴ and R⁵ is independently a C₁-C₄₀ hydrocarbyl, a C₁-C₄₀ substituted hydrocarbyl, more preferably, each of R⁴ and R⁵ is independently a non-aromatic cyclic alkyl group (such as cyclohexyl, cyclooctyl, cyclodecyl, cyclododecyl, adamantanyl, norbornyl, or 1-methylcyclohexyl, or substituted adamantanyl), most preferably a non-aromatic cyclic tertiary alkyl group (such as 1-methylcyclohexyl, 1-adamantanyl, substituted 1-adamantanyl, or 1-norbornyl).

The identity of R⁴ and R⁵ can be used to control the molecular weight of the polymer products. For example, when one or both of R⁴ and R⁵ are tert-butyl, the catalyst compound may provide high molecular weight polymers. In contrast, when R⁴, R⁵, or R⁴ and R⁵ are phenyl, the catalyst compound may provide low molecular weight polymers.

Each of R¹, R³, R⁶, R⁸, R⁹, R¹¹, R¹², R¹³, R¹⁵, R¹⁶, R¹⁷, R¹⁸, and R¹⁹ of Formula (I) or (II) can be independently hydrogen or C₁-C₁₀ alkyl, such as R¹, R³, R⁶, R⁸, R⁹, R¹¹, R¹², R¹³, R¹⁵, R¹⁶, R¹⁷, R¹⁸, and R¹⁹ can be independently hydrogen, methyl, ethyl, propyl, or isopropyl. In at least one embodiment, R¹, R³, R⁶, R⁸, R⁹, R¹⁰, R, R¹², R¹³, R¹⁴, R¹⁵, R¹⁶, R¹⁷, R¹⁸, and R¹⁹ are hydrogen. Alternately, each of R¹, R³, R⁶, R⁸, R⁹, R¹⁰, R¹¹, R¹², R¹³, R¹⁴, R¹⁵, R¹⁶, R¹⁷, R¹⁸, and R¹⁹ of Formula (I) can be independently hydrogen, phenyl, cyclohexyl, fluoro, chloro, methoxy, ethoxy, phenoxy, or trimethylsilyl.

At least one of R¹, R², R³, R⁶, R⁷, R⁸, R⁹, R¹⁰, R¹¹, R¹², R¹³, R¹⁴, R¹, or R¹⁶ of Formula (I) independently contains a silyl or germyl group of the form A(R^{a})(R^{b})(R^{c}) where A is Si or Ge and each of R^{a}, R^{b}, and R^{c} is independently C₁-C₄₀ hydrocarbyl or C₁-C₄₀ substituted hydrocarbyl, such as methyl, ethyl, propyl, (such as n-propyl, isopropyl), butyl (such as n-butyl, isobutyl, sec-butyl, tert-butyl), pentyl (such as n-pentyl, iso-pentyl, iso-amyl, neopentyl, cyclopentyl), hexyl (such as n-hexyl, iso-hexyl, cyclohexyl), heptyl (such as n-heptyl, iso-heptyl and norbomyl) octyl (such as n-octyl, isooctyl, cyclooctyl), nonyl (such as n-nonyl, iso-nonyl), decyl (such as n-decyl, iso-decyl, cyclodecyl, adamantyl), undecyl (such as n-undecyl, iso-undecy), dodecyl (such as n-dodecyl, iso-dodecyl, cyclododecyl), tridecyl, tetradecyl, pentadecyl, hexadecyl, heptadecyl, octadecyl, nonadecyl, icosyl, triacontyl, and all isomers thereof, or one or more of R^{a} and R^{b}, R^{a} and R^{c}, or R^{b} and R^{c} may be joined to form one or more substituted hydrocarbyl rings or unsubstituted hydrocarbyl rings. In some embodiments, the silyl or germyl group of the form A(R^{a})(R^{b})(R^{c}) is selected from trimethylsilyl, triethylsilyl, tri(n-propyl)silyl, tri(n-butyl)silyl, or tri(n-hexyl)silyl.

In some embodiments, at least one of R¹, R², R³, R⁶, R⁷, R⁸, R⁹, R¹⁰, R¹¹, R¹², R¹³, R¹⁴, R¹, or R¹⁶ of Formula (I) is independently a silyl or germyl group of the form A(R^{a})(R^{b})(R^{c}).

In some embodiments, at least one of R¹, R², R³, R⁶, R⁷, R⁸, R⁹, R¹⁰, R¹¹, R¹², R¹³, R¹⁴, R¹, or R¹⁶ of Formula (I) is independently a C₁-C₁₂₀ substituted hydrocarbyl in which at least one hydrogen atom of the hydrocarbyl has been substituted with a silyl or germyl group of the form A(R^{a})(R^{b})(R^{c}).

In at least one embodiment, the catalyst compound is one or more of:

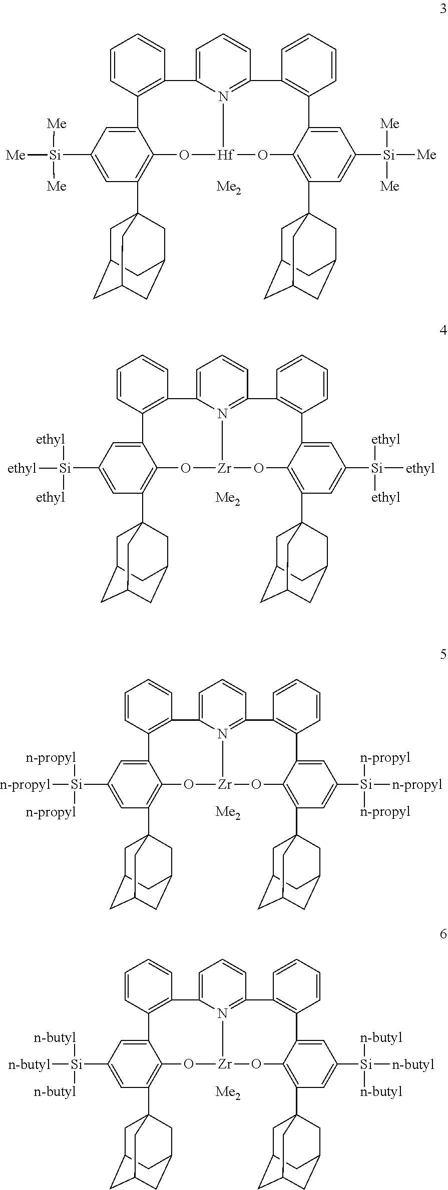

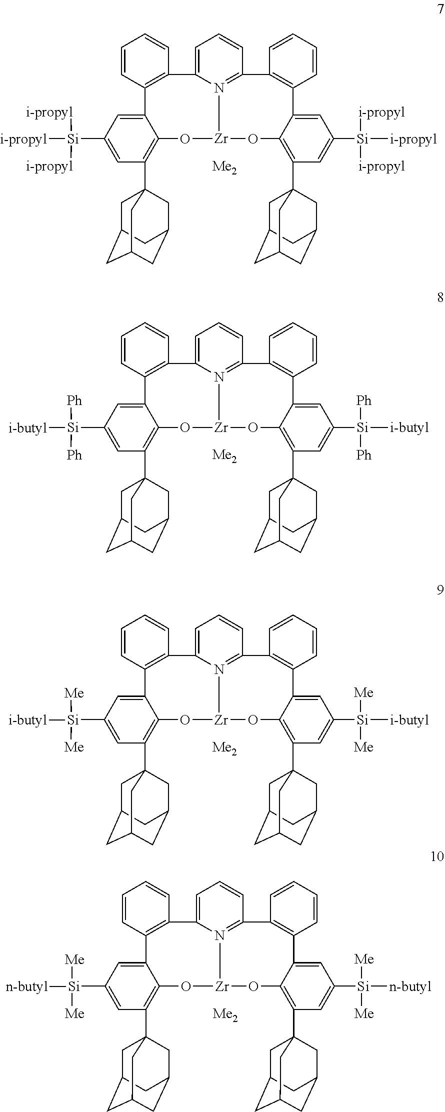

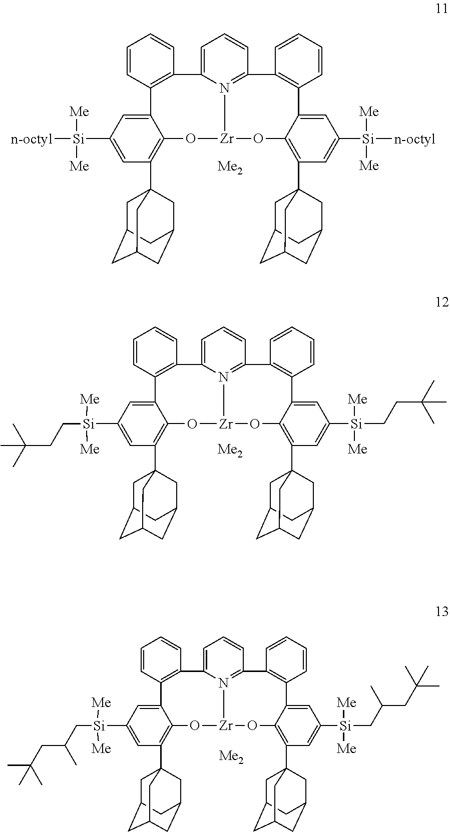

In at least one embodiment, one or more different catalyst compounds are present in a catalyst system. One or more different catalyst compounds can be present in the reaction zone where the process(es) described herein occur. The same activator can be used for the transition metal compounds, however, two different activators, such as a non-coordinating anion activator and an alumoxane, can be used in combination.

Further exemplary embodiments of the present technological advancement include the following. Composition of Formula (I), with R⁴ and R⁵ being adamantyl, R² and R⁷ independently being a silyl or germyl group of the form A(R^{a})(R^{b})(R^{c}) where A is Si or Ge. Composition of Formula (I), with R⁴ and R⁵ being adamantyl, R² and R⁷ independently being a silyl group of the form A(R^{a})(R^{b})(R^{c}) where A is Si, and A(R^{a})(R^{b})(R^{c}) contains at least seven carbons. Composition of Formula (I), with R⁴ and R⁵ being adamantyl, R² and R⁷ independently being a silyl group of the form A(R^{a})(R^{b})(R^{c}) where A is Si, A(R^{a})(R^{b})(R^{c}) contains at least seven carbons, and at least one of R^{a}, R^{b}, and R^{c} is an aliphatic (C₃-C₄₀)hydrocarbyl or (C₂-C₄₀)heterohydrocarbyl containing a linear carbon chain at least three carbons in length terminally bound to A. Composition of Formula (I), with R⁴ and R⁵ being adamantyl, R² and R⁷ independently being a silyl group of the form A(R^{a})(R^{b})(R^{c}) where A is Si, A(R^{a})(R^{b})(R^{c}) contains at least seven carbons, and at least one of R^{a}, R^{b}, and R^{c} is an aliphatic (C₃-C₄₀)hydrocarbyl or (C₂-C₄₀)heterohydrocarbyl containing a linear carbon chain at least four carbons in length terminally bound to A. Composition of Formula (I), with R⁴ and R⁵ being adamantyl, R² and R⁷ independently being a silyl group of the form A(R^{a})(R^{b})(R^{c}) where A is Si, A(R^{a})(R^{b})(R^{c}) contains at least seven carbons, and at least two of R^{a}, R^{b}, and R is an aliphatic (C₃-C₄₀)hydrocarbyl or (C₂-C₄₀)heterohydrocarbyl containing a linear carbon chain at least three carbons in length terminally bound to A. Composition of Formula (I), with R⁴ and R⁵ being adamantyl and R¹⁸ containing a silyl or germyl group of the form A(R^{a})(R^{b})(R^{c}) where A is Si or Ge. Composition of Formula (I), with R⁴ and R⁵ being adamantyl and R¹⁸ containing a silyl or germyl group of the form A(R^{a})(R^{b})(R^{c}) where A is Si or Ge, and at least one of R^{a}, R^{b}, and R^{c} is an aliphatic (C₃-C₄₀)hydrocarbyl or (C₂-C₄₀)heterohydrocarbyl containing a linear carbon chain at least three carbons in length terminally bound to A.

Further exemplary embodiments of the present technological advancement include the following. Composition of Formula (II), with R⁴ and R⁵ being adamantyl, with A′ and A″ being Si, A′(R^{a})(R^{b})(R^{c}) containing at least seven carbons, and A″ (R^{e})(R^{f})(R^{g}) containing at least seven carbons. Composition of Formula (II), with R⁴ and R⁵ being adamantyl, with A′ and A″ being Si, A′(R^{a})(R^{b})(R^{c}) containing at least seven carbons, at least one of R^{a}, R^{b}, and R^{c} being an aliphatic (C₃-C₄₀)hydrocarbyl or (C₂-C₄₀)heterohydrocarbyl containing a linear carbon chain at least three carbons in length terminally bound to A′, A″(R^{e})(R^{f})(R^{g}) containing at least seven carbons, and at least one of R^{d}, R^{e}, and R^{f} being an aliphatic (C₃-C₄₀)hydrocarbyl or (C₂-C₄₀)heterohydrocarbyl containing a linear carbon chain at least three carbons in length terminally bound to A″. Composition of Formula (II), with R⁴ and R⁵ being adamantyl, with A′ and A″ being Si, A′(R^{a})(R^{b})(R^{c}) containing at least seven carbons, at least one of R^{a}, R^{b}, and R^{c} being an aliphatic (C₃-C₄₀)hydrocarbyl or (C₂-C₄₀)heterohydrocarbyl containing a linear carbon chain at least four carbons in length terminally bound to A′, A″ (R^{e})(R^{f})(R^{g}) containing at least seven carbons, and at least one of R^{d}, R^{e}, and R^{f} being an aliphatic (C₃-C₄₀)hydrocarbyl or (C₂-C₄₀)heterohydrocarbyl containing a linear carbon chain at least four carbons in length terminally bound to A″. Composition of Formula (II), with R⁴ and R⁵ being adamantyl, with A′ and A″ are Si, A′(R^{a})(R^{b})(R^{c}) containing at least seven carbons, at least two of R^{a}, R^{b}, and R^{c} being independently an aliphatic (C₃-C₄₀)hydrocarbyl or (C₂-C₄₀)heterohydrocarbyl containing a linear carbon chain at least three carbons in length terminally bound to A′, A″ (R^{e})(R^{f})(R^{g}) containing at least seven carbons, and at least two of R^{d}, R^{e}, and R^{f} being independently an aliphatic (C₃-C₄₀)hydrocarbyl or (C₂-C₄₀)heterohydrocarbyl containing a linear carbon chain at least three carbons in length terminally bound to A″.

Exemplary embodiments of the present technological advancement can also be homogeneous solutions that include an aliphatic hydrocarbon solvent and complexes of Formula (I) or (II), with a concentration of the complex 0.20 wt % or greater (alternatively 0.25 wt % or greater, alternatively 0.30 wt % or greater, alternatively 0.35 wt % or greater, alternatively 0.40 wt % or greater, alternatively 0.50 wt % or greater, alternatively 1.0 wt % or greater, alternatively 2.0 wt % or greater). Without intending to be bound by theory, it is believed that the presence of silyl or germyl groups of the form A(R^{a})(R^{b})(R^{c}) in Formula (I) or (II) aids in solubility of these complexes in aliphatic solvents.

Another exemplary embodiment of the present technological advancement includes a process for the production of a propylene based polymer comprising: polymerizing propylene and one or more optional C₃-C₄₀ olefins by contacting the propylene and the one or more optional C₃-C₄₀ olefins with a catalyst system including a composition of Formula (I) or (II), in one or more continuous stirred tank reactors or loop reactors, in series or in parallel, at a reactor pressure of from 0.05 MPa to 1,500 MPa and a reactor temperature of from 30° C. to 230° C. to form a propylene based polymer.

Another exemplary embodiment of the present technological advancement includes a process for the production of an ethylene based polymer comprising: polymerizing ethylene and one or more optional C₄-C₄₀ olefins by contacting ethylene and the one or more optional C₄-C₄₀ olefins with a catalyst system including a composition of Formula (I) or (II), in one or more continuous stirred tank reactors or loop reactors, in series or in parallel, at a reactor pressure of from 0.05 MPa to 1,500 MPa and a reactor temperature of from 30° C. to 230° C. to form a propylene or ethylene based polymer.

### Activators, and Optional Scavengers, Co-Activators, and Chain Transfer Agents

U.S. patent application Ser. No. 16/788,088 (publication number US 2020/0254431) describes activators, optional scavengers, optional co-activators, and optional chain transfer agents useable with the present technological advancement. Particularly useful activators are also described in PCT Application number 2020/044865 (publication number WO 2021/086467), U.S. patent application Ser. No. 16/394,174 (published as US 2019/0330394) and PCT Application number 2019/029056 (published as WO 2019/210026) describing non-aromatic-hydrocarbon soluble activator compounds such as N-methyl-4-nonadecyl-N-octadecylanilinium [tetrakis(pentafluorophenyl)borate], N-methyl-4-nonadecyl-N-octadecylanilinium [tetrakis(heptafluoronaphthalenyl)borate], N-methyl-N-octadecyl-4-(octadecyloxy)anilinium [tetrakis(pentafluorophenyl)borate)], N-methyl-N-octadecyl-4-(octadecyloxy)anilinium [tetrakis(heptafluoronaphthalenyl) borate], N,N-di(hydrogenated tallow)methylammonium [tetrakis(pentafluorophenyl)borate], N,N-di(hydrogenated tallow)methylammonium [tetrakis(heptafluoronaphthalenyl)borate], N,N-di(octadecyl)methylammonium [tetrakis(pentafluorophenyl)borate], N,N-di(octadecyl)methylammonium [tetrakis(heptafluoronaphthalenyl)borate], N,N-di(hexadecyl)methylammonium [tetrakis(pentafluorophenyl)borate], N,N-di(hexadecyl)methylammonium [tetrakis(heptafluoronaphthalenyl)borate], N-octadecyl-N-hexadecylmethylammonium [tetrakis(pentafluorophenyl)borate], and N-octadecyl-N-hexadecylmethylammonium [tetrakis(heptafluoronaphthalenyl)borate].

While it is preferred to use an activator that is soluble in a non-aromatic hydrocarbon solvent, activators that are poorly soluble or not soluble in non-aromatic hydrocarbon solvents can be used. When used, these activators can be fed into the reactor via a slurry or as a solid. Particularly useful activators in this class include triphenylcarbenium tetrakis(pentafluorophenyl)borate, triphenylcarbenium tetrakis(perfluoronaphthyl)borate, N,N-dimethylanilinium tetrakis(pentafluorophenyl)borate, N,N-dimethylanilinium tetrakis(perfluoronaphthyl)borate, and the like.

The typical activator-to-catalyst ratio is about a 1:1 molar ratio. Alternate preferred ranges include from 0.1:1 to 100:1, alternately from 0.5:1 to 200:1, alternately from 1:1 to 500:1 alternately from 1:1 to 1000:1. A particularly useful range is from 0.5:1 to 10:1, preferably 1:1 to 1:10.

Particularly useful optional scavengers or co-activators or chain transfer agents include, for example tri-alkyl aluminum such as triisobutylaluminum, tri-n-hexylaluminum, tri-n-octylaluminum, and dialkyl zinc, such as diethyl zinc. Additionally, toluene-free hydrocarbon soluble alumoxanes and modified alumoxanes, including trimethylaluminum “free” alumoxanes may be used.

Moreover, those of ordinary skill in the art are capable of selecting a suitable known activator(s) and optional scavengers or co-activators or chain transfer agents for their particular purpose without undue experimentation. Combinations of multiple activators may be used. Similarly, combinations of multiple optional scavengers or co-activators or chain transfer agents may be used.

### Solvents

While it is possible to use the catalyst components of the present technological advancement with an aromatic solvent, such as toluene, preferably they are absent when using the catalysts components in a polymerization process. Solvents useful for solubilizing the catalyst compound, the activator compound, or for combining the catalyst compound and activator, and/or for introducing the catalyst system or any component thereof into the reactor, and/or for use in the polymerization process include, but are not limited to, aliphatic hydrocarbon solvents, such as butanes, pentanes, hexanes, heptanes, octanes, nonanes, decanes, undecanes, dodecanes, tridecanes, tetradecanes, pentadecanes, hexadecanes, or a combination thereof; preferable solvents can include normal paraffins (such as Norpar™ solvents available from ExxonMobil Chemical Company in Houston, TX), isoparaffin solvents (such as Isopar™ solvents available from ExxonMobil Chemical Company in Houston, TX), non-aromatic cyclic solvents (such as Nappar™ solvents available from ExxonMobil Chemical Company in Houston, TX) and combinations thereof.

Preferably the aliphatic hydrocarbon solvent is selected from C₄ to C₁₀ linear, branched or cyclic alkanes, alternatively from C₅ to C₈ linear, branched or cyclic alkanes.

Preferably the aliphatic hydrocarbon solvent is essentially free of all aromatic solvents. Preferably the solvent is essentially free of toluene. Free of all aromatic solvents, such as toluene, means that the solvent is essentially free of aromatic solvents (e.g., present at zero mol %, alternately present at less than 1 mol %, preferably the polymerization reaction and/or the polymer produced are free of “detectable aromatic hydrocarbon solvent,” such as toluene.

Preferred aliphatic hydrocarbon solvents include isohexane, cyclohexane, methylcyclohexane, pentane, isopentane, heptane, and combinations thereof, in addition to commercially available solvent mixtures such as Nappar6™, and IsoparE™. However, those of ordinary skill in the art can select other suitable non-aromatic hydrocarbon solvents without undue experimentation.

Highly preferred aliphatic hydrocarbon solvents include isohexane, methylcyclohexane, and commercially available solvent mixtures such as Nappar6™, and IsoparE™.

For compound solubility testing, preferred solvents include isohexane and methylcyclohexane.

### Optional Support Materials

In embodiments herein, the catalyst system may include an inert support material. The supported material can be a porous support material, for example, talc, and inorganic oxides. U.S. patent application Ser. No. 16/788,088 (publication number US 2020/0254431) describes optional support materials useable with the present technological advancement. Moreover, those of ordinary skill in the art are capable of selecting a suitable known support for their particular purpose without undue experimentation.

### Polymerization Processes

The present disclosure relates to polymerization processes where monomer (e.g., ethylene; propylene), and optionally one or more comonomer (such as C₂ to C₂₀ alpha olefins, C₄ to C₄₀ cyclic olefins, C₅ to C₂₀ non-conjugated dienes) are contacted with a catalyst system including an activator and at least one catalyst compound, as described above. The catalyst compound and activator may be combined in any order. The catalyst compound and activator may be combined prior to contacting with the monomer. Alternatively, the catalyst compound and activator may be introduced into the polymerization reactor separately, wherein they subsequently react to form the active catalyst.

U.S. patent application Ser. No. 16/788,088 (publication number US 2020/0254431) describes monomers useable with the present technological advancement and describes polymerization processes useable with the present technological advancement.

Additionally, catalysts that are highly soluble in aliphatic hydrocarbon solvents may be used as trim catalysts in well-known polymerization processes as described for example in WO 2015/123177 and WO 2020/092587.

### Blends and Films

Polymers made with the present technological advancement can be used to make blends and films as described in U.S. patent application Ser. No. 16/788,088 (publication number US 2020/0254431), without undue experimentation.

### EXAMPLES

### General Considerations for Synthesis

The following chemicals may be abbreviated as indicated in either lower case or capital letters: 1,2-dimethoxyethane (dme), ethyl ether (ether), tetrahydrofuran (thf), diatomaceous earth (Celite), methylcyclohexane (MeCy), 1,4-dioxane (dioxane), hexamethyldisiloxane (hmdso), N,N-dimethylformamide (DMF), N-bromosuccinimide (NBS), n-butyllithium (n-BuLi), tert-butyllithium (t-BuLi). Room temperature is 23° C. unless otherwise noted.

Complexes 1 and 2 (shown below) were prepared as described in US patent application US 2020/0255553 A1.

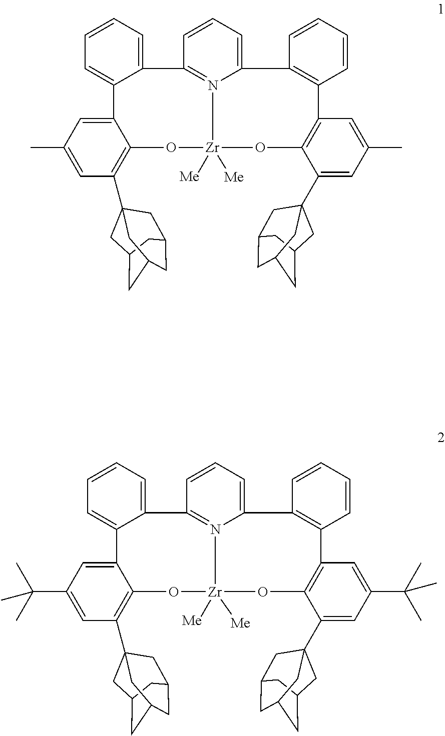

All reagents were purchased from commercial vendors (Sigma Aldrich, Fisher Scientific, Strem Chemical, or Oakwood Chemical) and used as received unless otherwise noted. Solvents were sparged with N₂ and dried over 3 Å molecular sieves. All chemical manipulations were performed in a nitrogen environment unless otherwise stated. Flash column chromatography was carried out with Sigma Aldrich silica gel 60 Å (70 Mesh-230 Mesh) using solvent systems specified. All anhydrous solvents were purchased from Fisher Chemical and were degassed and dried over molecular sieves prior to use. Deuterated solvents were purchased from Cambridge Isotope Laboratories and were degassed and dried over molecular sieves prior to use. ¹H NMR spectroscopic data were acquired at 250 MHz, 400 MHz, or 500 MHz using solutions prepared by dissolving approximately 10 mg of a sample in either C₆D₆, CD₂Cl₂, CDCl₃, D₈-toluene, or other deuterated solvent. The chemical shifts (δ) presented are relative to the residual protium in the deuterated solvent at 7.15 ppm, 5.32 ppm, 7.24 ppm, and 2.09 ppm for C₆D₆, CD₂Cl₂, CDCl₃, D₈-toluene, respectively.

### Synthesis of Ligands and Catalysts

ZrCl₄(ether)₂. Dichloromethane (100 mL) and ZrCl₄ (10.0 g, 42.9 mmol) were combined to form a slurry. Ether (9.54 g, 129 mmol) was added dropwise over 60 minutes. The mixture was stirred for 1 hour. The undissolved solids were allowed to settle, then the supernatant was decanted and filtered through Celite on a fritted disk. The filtrate was evaporated to near dryness to afford a slurry. Isohexane (60 mL) was added to the slurry and the mixture was stirred thoroughly. The resulting off-white solid was collected on a frit, washed with isohexane, and dried under reduced pressure. Yield: 12.5 g, 76.6%.

### Adamantyl Aryl Precursors

### 2-(1-adamantyl)-4-bromophenol

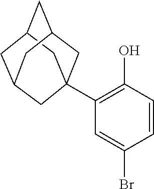 [SMILES: Oc1ccc(Br)cc1C12CC3CC(CC(C3)C1)C2]

To a solution of 1-adamantanol (26.5 g, 174 mmol) and 4-bromophenol (30.2 g, 174 mmol) in dichloromethane (50 mL) at 0° C., 98% sulfuric acid (24.4 g, 249 mmol) was added. The reaction was stirred at 0° C. for 1.5 hours, then stirred at ambient temperature for 0.5 hour. The reaction was diluted with dichloromethane (200 mL), then slowly quenched with aq. Na2CO3 (˜100 mL). After stirring the mixture for 30 minutes, the aqueous phase was separated and extracted with additional dichloromethane. The organic extracts were combined, dried over MgSO4, filtered, and concentrated to dryness. The crude product was slurried into pentane (50 mL), then cooled at −20° C. for 1 hour. Filtration of the mixture afforded the desired compound as a white solid (47.0 g, 88%). ¹H NMR (400 MHz, CDCl₃) δ 7.32 (s, 1H), 7.18 (d, J=8.3 Hz, 1H), 6.55 (d, J=8.4 Hz, 1H), 4.74 (s, 1H), 2.11 (s, 9H), 1.80 (s, 6H).

### 1-(5-bromo-2-(methoxymethoxy)phenyl)adamantane

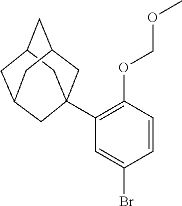 [SMILES: COCOc1ccc(Br)cc1C12CC3CC(CC(C3)C1)C2]

To a solution of 2-(1-adamantyl)-4-bromophenol (15.0 g, 48.8 mmol) in diethyl ether (80 mL), sodium hydride (1.37 g, 51 mmol) was added at ambient temperature. The reaction was stirred for 3 hours, then concentrated to dryness. The crude product was diluted with pentane (50 mL). The resulting mixture was stirred for 30 minutes, then filtered to afford the sodium aryloxide intermediate as a white solid.

To a solution of the sodium aryloxide intermediate in THF (50 mL), methoxymethyl bromide (5.33 g, 43 mmol) was added. The reaction was stirred for 3 hours, then concentrated to remove most of the THF. The crude product was diluted with dichloromethane (30 mL) and washed with water. The aqueous phase was separated and extracted with additional dichloromethane. The organic extracts were combined, dried over MgSO₄, filtered, and concentrated to dryness to afford the product as a yellow solid (12.8 g, 75%). ¹H NMR (400 MHz, CDCl₃) δ 7.34 (s, 1H), 7.26 (d, J=8.8 Hz, 1H), 7.00 (d, J=8.6 Hz, 1H), 5.22 (s, 2H), 3.53 (d, J=1.2 Hz, 3H), 2.10 (s, 9H), 1.79 (s, 6H).

### 2-(2-(1-adamantyl)-4-bromophenoxy)tetrahydro-2H-pyran

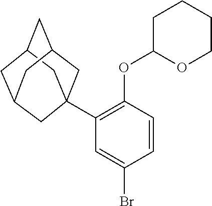 [SMILES: Brc1ccc(OC2CCCCO2)c(C23CC4CC(CC(C4)C2)C3)c1]

To a solution of 2-(1-adamantyl)-4-bromophenol (3.30 g, 10.7 mmol) and 3,4-dihydro-2H-pyran (2.71 g, 32.2 mmol) in dichloromethane (10 mL) at 0° C., p-toluenesulfonic acid monohydrate (20.4 mg, 0.1 mmol) was added. The reaction mixture was stirred for 45 minutes at 0° C. The reaction was poured into 1 M aqueous NaOH solution (10 mL), and the resulting mixture was extracted with dichloromethane (2×10 mL). The combined organic extracts were dried over MgSO₄, then evaporated to dryness. The residue was stirred in methanol for 2 hours. The product was isolated by filtration as a yellow solid (3.60 g, 86%). ¹H NMR (400 MHz, CDCl₃) δ 7.30 (d, J=2.1 Hz, 1H), 7.23 (d, J=8.7 Hz, 1H), 7.05 (d, J=8.7 Hz, 1H), 5.43 (s, 1H), 3.86 (t, J=9.6 Hz, 1H), 3.65 (d, J=12.0 Hz, 1H), 2.09 (br, 9H), 1.97-1.89 (m, 2H), 1.84-1.36 (m, 10H).

### (3-(1-adamantyl)-4-(methoxymethoxy)phenyl)trimethylsilane

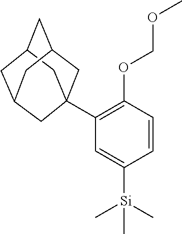 [SMILES: COCOc1ccc([Si](C)(C)C)cc1C12CC3CC(CC(C3)C1)C2]

To a solution of 10.0 g (28.5 mmol) of 1-(5-bromo-2-(methoxymethoxy)phenyl)adamantane in 150 mL of dry THF, 13.7 mL (34.2 mmol) of 2.5 M n-BuLi in hexanes was added dropwise over 30 minutes at −80° C. The reaction mixture was stirred for 1 hour at this temperature followed by addition of 4.33 g (39.9 mmol) of chlorotrimethylsilane. The obtained solution was stirred for 1 hour at room temperature, then poured into 300 mL of water. The crude product was extracted with dichloromethane (3×100 mL); the combined organic extracts were dried over Na₂SO4 and then evaporated to dryness. Yield 9.69 g (99%) of a white solid. ¹H NMR (CDCl₃, 400 MHz): δ 7.46 (d, J=1.6 Hz, 1H), 7.38 (dd, J=8.1, 1.6 Hz, 1H), 7.16 (d, J=8.1 Hz, 1H), 5.30 (s, 2H), 3.57 (s, 3H), 2.20-2.22 (m, 6H), 2.14 (br.s, 3H), 1.80-1.90 (m, 6H), 0.32 (s, 9H). ¹³C NMR (CDCl₃, 100 MHz): δ 157.1, 137.5, 132.3, 131.9, 131.6, 113.8, 94.0, 56.2, 40.6, 37.1, 29.1, −0.9.

### (3-(1-adamantyl)-4-(methoxymethoxy)-5-(4,4,5,5-tetramethyl-1,3,2-dioxaborolan-2-yl)phenyl)trimethylsilane

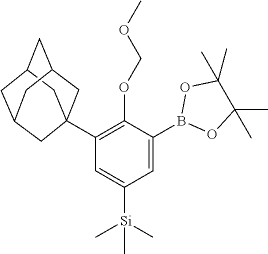 [SMILES: COCOc1c(B2OC(C)(C)C(C)(C)O2)cc([Si](C)(C)C)cc1C12CC3CC(CC(C3)C1)C2]

To a solution of 9.66 g (28.0 mmol) of (3-(1-adamantyl)-4-(methoxymethoxy)phenyl)trimethylsilane in 450 mL of diethyl ether, 16.8 mL (42.1 mmol) of 2.5 M n-BuLi in hexanes was added dropwise over 20 minutes at 0° C. The reaction mixture was stirred for 12 hours at room temperature, then cooled to −80° C. followed by addition of 11.5 mL (56.1 mmol) of 2-isopropoxy-4,4,5,5-tetramethyl-1,3,2-dioxaborolane. The formed suspension was stirred for 1 hour at room temperature, then poured into 300 mL of water. The obtained mixture was extracted with dichloromethane (3×300 mL); the combined organic extracts were dried over Na₂SO₄ and then evaporated to dryness. Yield 12.9 g (98%) of a white solid. ¹H NMR (CDCl₃, 400 MHz): δ 7.69 (d, J=1.7 Hz, 1H), 7.54 (d, J=1.7 Hz, 1H), 5.22 (s, 2H), 3.60 (s, 3H), 2.17-2.20 (m, 6H), 2.10 (br.s, 3H), 1.76-1.84 (m, 6H), 1.37 (s, 12H), 0.27 (s, 9H). ¹³C NMR (CDCl₃, 100 MHz): δ 162.8, 140.1, 139.7, 135.1, 133.2, 100.7, 83.6, 57.8, 41.1, 37.2, 37.1, 29.1, 24.8, −0.9.

### (5-(1-adamantyl)-2′-bromo-6-(methoxymethoxy)-[1,1′-biphenyl]-3-yl)trimethylsilane

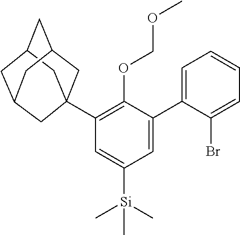 [SMILES: COCOc1c(-c2ccccc2Br)cc([Si](C)(C)C)cc1C12CC3CC(CC(C3)C1)C2]

To a solution of 5.00 g (10.6 mmol) of (3-(1-adamantyl)-4-(methoxymethoxy)-5-(4,4,5,5-tetramethyl-1,3,2-dioxaborolan-2-yl)phenyl)trimethylsilane in 30 mL of 1,4-dioxane, 3.00 g (10.6 mmol) of 2-bromoiodobenzene, 8.66 g (26.6 mmol) of cesium carbonate, and 15 mL of water were subsequently added. The mixture obtained was purged with argon for 10 minutes followed by addition of 614 mg (0.531 mmol) of Pd(PPh₃)₄. This mixture was stirred for 12 hours at 100° C., then cooled to room temperature and diluted with 100 ml of water. The obtained mixture was extracted with dichloromethane (3×100 mL); the combined organic extracts were dried over Na₂SO₄ and then evaporated to dryness. The residue was purified by flash chromatography on silica gel 60 (40-63 um, eluent: hexane-dichloromethane=10:1, vol.). Yield 2.44 g (46%) of a white solid. ¹H NMR (CDCl₃, 400 MHz): δ 7.71 (d, J=7.3 Hz, 1H), 7.51 (d, J=1.5 Hz, 1H), 7.35-7.45 (m, 2H), 7.20-7.26 (m, 2H), 4.56 (d, J=4.6 Hz, 1H, AB), 4.48 (d, J=4.6 Hz, 1H, AB), 3.26 (s, 3H), 2.21-2.24 (m, 6H), 2.14 (br.s, 3H), 1.79-1.86 (m, 6H), 0.30 (s, 9H). ¹³C NMR (CDCl₃, 100 MHz): δ 154.7, 141.9, 141.3, 135.1, 134.1, 134.0, 133.0, 132.3, 131.8, 128.7, 127.1, 124.2, 98.9, 57.2, 41.2, 37.4, 37.0, 29.1, −0.9.

### (4-(1-adamantyl)-6-isopropoxy-6H-dibenzo[c,e][1,2]oxaborinin-2-yl)trimethylsilane

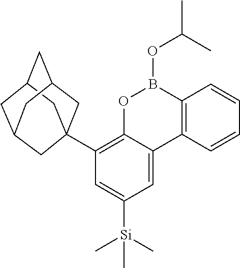 [SMILES: CC(C)OB1Oc2c(cc([Si](C)(C)C)cc2C23CC4CC(CC(C4)C2)C3)-c2ccccc21]

To a solution of 2.44 g (4.88 mmol) of (5-(1-adamantyl)-2′-bromo-6-(methoxymethoxy)-[1,1′-biphenyl]-3-yl)trimethylsilane in 50 mL of dry THF, 2.3 mL (5.86 mmol) of 2.5 M n-BuLi in hexanes was added dropwise over 20 minutes at −80° C. The reaction mixture was stirred for 1 hour at this temperature followed by addition of 1.49 ml (7.33 mmol) of 2-isopropoxy-4,4,5,5-tetramethyl-1,3,2-dioxaborolane. The obtained suspension was stirred for 1 hour at room temperature, then poured into 300 mL of water. This mixture was extracted with dichloromethane (3×100 mL); the combined organic extracts were dried over Na₂SO₄ and then evaporated to dryness. To the residue, 50 mL of isopropanol was added, and the resulting solution was refluxed for 2 hours. After cooling to room temperature, the precipitate formed was filtered off on a glass frit (G4), washed with 5 mL of cold isopropanol, and then dried under vacuum. Yield 2.21 g (96%) of a white solid. ¹H NMR (CDCl₃, 400 MHz): δ 8.25 (s, 1H), 8.24 (d, J=8.4 Hz, 1H), 8.10 (d, J=8.4 Hz, 1H), 7.69 (t, J=8.4 Hz, 1H), 7.55 (s, 1H), 7.45 (t, J=7.4 Hz, 1H), 5.30 (sept, J=6.2 Hz, 1H), 2.34-2.36 (m, 6H), 2.20 (br.s, 3H), 1.86-1.90 (m, 6H), 1.46 (d, J=6.2 Hz, 6H), 0.39 (s, 9H). ¹³C NMR (CDCl₃, 100 MHz): δ 151.2, 140.6, 138.6, 133.0, 132.5, 131.9, 131.2, 127.1, 126.7, 122.5, 121.6, 65.8, 40.7, 37.3, 37.1, 29.1, 24.8, −0.8.

### 2′,2″′-(Pyridine-2,6-diyl)bis(3-(1-adamantyl)-5-(trimethylsilyl)-[1,1′-biphenyl]-2-ol)

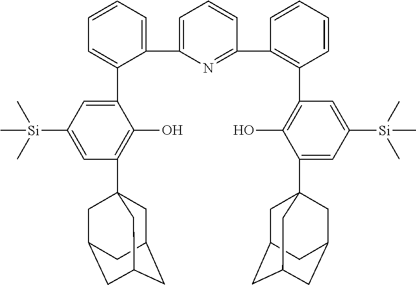

To a solution of 2.21 g (4.87 mmol) of (4-(1-adamantyl)-6-isopropoxy-6H-dibenzo[c,e][1,2]oxaborinin-2-yl)trimethylsilane in 12 mL of 1,4-dioxane, 559 mg (2.36 mmol) of 2,6-dibromopyridine, 4.05 g (12.4 mmol) of cesium carbonate, and 6 mL of water were subsequently added. The mixture obtained was purged with argon for 10 minutes followed by addition of 287 mg (0.25 mmol) of Pd(PPh₃)₄. This mixture was stirred for 12 hours at 100° C., then cooled to room temperature and diluted with 50 mL of water. The obtained mixture was extracted with dichloromethane (3×50 mL); the combined organic extracts were dried over Na₂SO₄ and then evaporated to dryness. The residue was purified by flash chromatography on silica gel 60 (40-63 um, eluent: hexane-ethyl acetate=10:1, vol.). Yield 910 mg (46%) of a mixture of two isomers as a white powder. ¹H NMR (CDCl₃, 400 MHz): δ 8.32 (s, 2H in A), 7.35-7.53 (m, 9H in A and B), 7.20 (d, J=1.3 Hz, 2H in A), 7.14 (d, J=1.3 Hz, 2H in B), 7.06 (d, J=7.8 Hz, 2H in B), 7.03 (s, 2H in B), 7.01 (d, J=7.8 Hz, 2H in A), 6.69 (d, J=1.3 Hz, 2H in A), 1.60-2.02 (m, 30H in A and B), 0.15 (s, 18H in B), 0.00 (s, 18H in A). ¹³C NMR (CDCl₃, 100 MHz, only A) (157.8, 153.4, 139.4, 137.5, 134.7, 131.8, 130.9, 130.8, 130.1, 129.9, 129.0, 127.8, 122.5, 40.4, 37.0, 36.9, 29.1, −0.9.

### (3-(1-adamantyl)-4-((tetrahydro-2H-pyran-2-yl)oxy)phenyl)triethylsilane

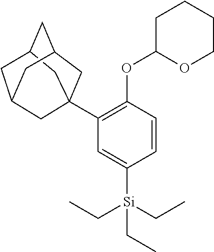 [SMILES: CC[Si](CC)(CC)c1ccc(OC2CCCCO2)c(C23CC4CC(CC(C4)C2)C3)c1]

To a solution of 2-(2-(1-adamantyl)-4-bromophenoxy)tetrahydro-2H-pyran (4.66 g, 11.9 mmol) and chlorotriethylsilane (3.59 g, 23.8 mmol) in THF (10 mL), magnesium powder (34.7 mg, 14 mmol) was added. Iodine was added in minimal quantities to initiate the reaction. The reaction mixture was refluxed for 16 hours, then concentrated to dryness. The crude mixture was slurried into hexane/dichloromethane (50:50). The solids were then removed by filtration, and the filtrate was concentrated to dryness. The residue was purified by flash chromatography on silica gel (10% dichloromethane in hexane) to afford the product as a clear oil (1.39 g, 27%). ¹H NMR (400 MHz, CDCl₃) δ 7.34 (s, 1H), 7.27 (d, J=9.9 Hz, 1H), 7.15 (d, J=8.1 Hz, 1H), 5.51 (s, 1H), 3.92 (t, J=10.3 Hz, 1H), 3.66 (d, J=11.7 Hz, 1H), 2.27-2.01 (m, 10H), 2.00-1.87 (m, 2H), 1.83-1.60 (m, 9H), 0.97 (t, J=7.9 Hz, 9H), 0.76 (q, J=7.9 Hz, 6H).

### (5-(1-adamantyl)-2′-bromo-6-((tetrahydro-2H-pyran-2-yl)oxy)-[1,1′-biphenyl]-3-yl)triethylsilane

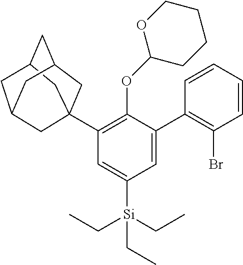 [SMILES: CC[Si](CC)(CC)c1cc(-c2ccccc2Br)c(OC2CCCCO2)c(C23CC4CC(CC(C4)C2)C3)c1]

To a solution of (3-(1-adamantyl)-4-((tetrahydro-2H-pyran-2-yl)oxy)phenyl)triethylsilane (1.82 g, 4.3 mmol) in diethyl ether (10 mL) at ambient temperature, n-BuLi in hexane (11 M, 0.43 mL, 4.7 mmol) was added. The solution was stirred for 1 hour, then concentrated to dryness. The lithiated intermediate was dissolved in hexane. To the resulting solution at 60° C., 2-bromochlorobenzene (0.86 g, 4.5 mmol) in hexane (1 mL) was added dropwise. The reaction was stirred for 1 hour at 60° C., then filtered through Celite. The filtrate was concentrated, and the residue was purified by flash chromatography on silica gel (10% dichloromethane in hexane) to afford the product as a foamy solid (2.24 g, 100%). ¹H NMR (400 MHz, CDCl₃) δ 7.66 (dd, J=30.4, 8.0 Hz, 1H), 7.45-7.28 (m, 3H), 7.24-7.16 (m, 1H), 7.06 (d, J=57.3 Hz, 1H), 4.32 (d, J=8.1 Hz, 1H), 3.77 (dd, J=41.1, 12.0 Hz, 1H), 2.96 (dt, J=99.6, 11.1 Hz, 1H), 2.34-1.99 (m, 9H), 1.82-1.61 (m, 8H), 1.47-1.06 (m, 4H), 1.05-0.91 (m, 9H), 0.82-0.68 (m, 6H).

### 2′,2″′-(pyridine-2,6-diyl)bis(3-(1-adamantanyl)-5-(triethylsilyl)-[1,1′-biphenyl]-2-ol)

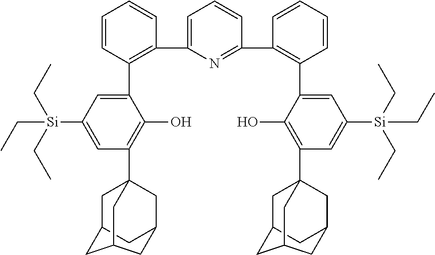 [SMILES: CC[Si](CC)(CC)c1cc(-c2ccccc2-c2cccc(-c3ccccc3-c3cc([Si](CC)(CC)CC)cc(C45CC6CC(CC(C6)C4)C5)c3O)n2)c(O)c(C23CC4CC(CC(C4)C2)C3)c1]

To a solution of (5-(1-adamantyl)-2′-bromo-6-((tetrahydro-2H-pyran-2-yl)oxy)-[1,1′-biphenyl]-3-yl)triethylsilane (2.24 g, 3.8 mmol) in THF (10 mL) at ambient temperature, n-BuLi in hexane (11 M, 0.35 mL, 3.8 mmol) was added. The solution was stirred for 1 hour. Zinc dichloride (0.49 g, 3.6 mmol) was then added, and the reaction mixture was stirred for 10 minutes. 2,6-dibromopyridine (0.34 g, 1.4 mmol) and Pd(P^{t}Bu₃)₂ (150 mg, 0.002 mmol) were subsequently added. The reaction mixture was stirred for 16 hours at 70° C., then cooled to ambient temperature. 1 M HCl (1 mL) was then added and the reaction mixture was stirred for 16 hours. The mixture was diluted with water and extracted with dichloromethane (3×10 mL). The combined organic extracts were dried over MgSO₄, then evaporated to dryness. The residue was purified by flash chromatography on silica gel (impurities eluted with 20% dichloromethane in hexane, followed by 20% dichloromethane+10% EtOAc in hexane to elute the product). The product was then dissolved in diethyl ether (˜1 mL), and hexane (5 mL) was subsequently added. The resulting mixture was cooled to −20° C. for 16 hours. The product was isolated by filtration as a white solid (0.316 g, 9.7%). ¹H NMR (400 MHz, CDCl₃) δ 7.78 (t, J=8.0 Hz, 1H), 7.63 (d, J=7.6 Hz, 4H), 7.44 (t, J=7.4 Hz, 2H), 7.26 (d, J=3.4 Hz, 4H), 7.17 (d, J=7.9 Hz, 2H), 7.01 (d, J=7.8 Hz, 2H), 6.84 (s, 2H), 2.03 (br, 12H), 1.76 (br, 8H), 1.26 (br, 10H), 0.99-0.79 (m, 18H), 0.70-0.57 (m, 12H).

### (3-(1-adamantyl)-4-(methoxymethoxy)phenyl)tripropylsilane

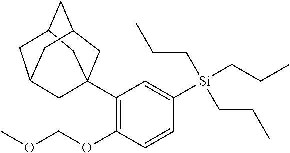 [SMILES: CCC[Si](CCC)(CCC)c1ccc(OCOC)c(C23CC4CC(CC(C4)C2)C3)c1]

To a solution of 1-(5-bromo-2-(methoxymethoxy)phenyl)adamantane (2.19 g, 6.23 mmol) in THF (5 mL) at −60° C., t-BuLi in pentane (1.7 M, 7.3 mL, 12.5 mmol) was added dropwise over 10 minutes. The reaction mixture was stirred for 1 hour at −60° C., followed by addition of tripropylchlorosilane (1.20 g, 6.23 mmol). The solution was stirred at −60° C. for 30 minutes, then stirred at ambient temperature for 1 hour. The reaction was poured into water (10 mL), and the resulting mixture was extracted with dichloromethane (3×100 mL). The combined organic extracts were dried over MgSO₄, then evaporated to dryness. The residue was purified by flash chromatography on silica gel (10% dichloromethane in hexane) to afford the product as a foamy solid (1.68 g, 63%). ¹H NMR (400 MHz, CDCl₃) δ 7.32 (d, J=1.7 Hz, 1H), 7.26-7.24 (m, 1H), 7.05 (d, J=8.0 Hz, 1H), 5.23 (s, 2H), 3.52 (s, 3H), 2.23-2.00 (m, 9H), 1.79 (br, 6H), 1.41-1.30 (m, 6H), 0.96 (t, J=7.2 Hz, 9H), 0.80-0.70 (m, 6H).

### (5-(1-adamantyl)-2′-bromo-6-(methoxymethoxy)-[1,1′-biphenyl]-3-yl)tripropylsilane

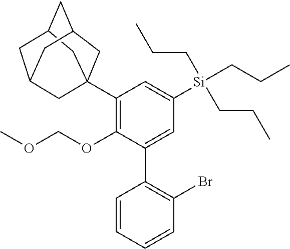 [SMILES: CCC[Si](CCC)(CCC)c1cc(-c2ccccc2Br)c(OCOC)c(C23CC4CC(CC(C4)C2)C3)c1]

To a solution of (3-(1-adamantyl)-4-(methoxymethoxy)phenyl)tripropylsilane (1.68 g, 3.9 mmol) in diethyl ether (10 mL) at ambient temperature, n-BuLi in hexane (1.6 M, 2.5 mL, 3.9 mmol) was added. The solution was stirred for 1 hour, then concentrated to dryness. The lithiated intermediate was dissolved in hexane. To the resulting solution at 60° C., 2-bromochlorobenzene (0.79 g, 4.1 mmol) in hexane (1 mL) was added dropwise. The reaction was stirred for 1 hour at 60° C., then filtered through Celite. The filtrate was concentrated, and the residue was purified by flash chromatography on silica gel (10% dichloromethane in hexane) to afford the product as a foamy solid (1.98 g, 87%). ¹H NMR (400 MHz, CDCl₃) δ 7.70 (dd, J=8.0, 1.2 Hz, 1H), 7.44-7.40 (m, 2H), 7.37 (td, J=7.4, 1.2 Hz, 1H), 7.23 (ddd, J=8.1, 7.2, 2.0 Hz, 1H), 7.17 (d, J=1.6 Hz, 1H), 4.49 (dd, J=54.8, 4.7 Hz, 2H), 3.24 (s, 3H), 2.32-2.03 (m, 9H), 1.82 (d, J=3.4 Hz, 6H), 1.50-1.32 (m, 6H), 0.98 (t, J=7.2 Hz, 9H), 0.83-0.75 (m, 6H).

### (4-(1-adamantyl)-6-isopropoxy-benzo[c][1,2]benzoxaborinin-2-yl)tripropylsilane

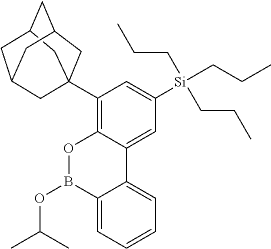 [SMILES: CCC[Si](CCC)(CCC)c1cc2c(c(C34CC5CC(CC(C5)C3)C4)c1)OB(OC(C)C)c1ccccc1-2]

To a solution of (5-(1-adamantyl)-2′-bromo-6-(methoxymethoxy)-[1,1′-biphenyl]-3-yl)tripropylsilane (1.98 g, 3.4 mmol) in THF (5 mL) at −60° C., n-BuLi in hexanes (2.5 M, 1.50 mL, 3.7 mmol) was added dropwise over 10 minutes. The reaction mixture was stirred for 1 hour at −60° C., followed by addition of 2-isopropoxy-4,4,5,5-tetramethyl-1,3,2-dioxaborolane (0.95 g, 5.1 mmol). The resulting suspension was stirred for 1 hour at ambient temperature, then poured into 5 mL of water. The resulting mixture was extracted with dichloromethane (3×5 mL). The combined organic extracts were dried over MgSO₄, then evaporated to dryness.

To the residue, isopropanol (20 mL) was added, and the resulting solution was refluxed for 16 hours. After allowing the reaction to cool to ambient temperature, the reaction was concentrated to dryness. The product was washed with cold isopropanol and isolated as a white solid (1.46 g, 81%). ¹H NMR (500 MHz, CDCl₃) δ 8.31-8.12 (m, 2H), 8.06 (d, J=6.9 Hz, 1H), 7.69 (dt, J=28.4, 7.8 Hz, 1H), 7.50-7.35 (m, 2H), 5.25 (q, J=6.2 Hz, 1H in B), 4.03 (q, J=6.0 Hz, 1H in A), 2.36-2.10 (m, 9H), 1.85 (br, 6H), 1.49-1.34 (m, 9H), 1.22 (d, J=6.1 Hz, 3H), 1.00 (td, J=7.3, 1.8 Hz, 9H), 0.89-0.78 (m, 6H).

### 2′,2″′-(pyridine-2,6-diyl)bis(3-(1-adamantyl)-5-(tripropylsilyl)-[1,1′-biphenyl]-2-ol)

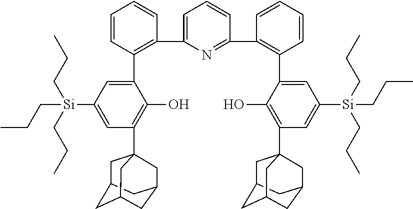 [SMILES: CCC[Si](CCC)(CCC)c1cc(-c2ccccc2-c2cccc(-c3ccccc3-c3cc([Si](CCC)(CCC)CCC)cc(C45CC6CC(CC(C6)C4)C5)c3O)n2)c(O)c(C23CC4CC(CC(C4)C2)C3)c1]

To a solution of (4-(1-adamantyl)-6-hydroxy-benzo[c][1,2]benzoxaborinin-2-yl)tripropylsilane (1.42 g, 2.9 mmol) in THF (8 mL), 2,6-dibromopyridine (0.34 g, 1.45 mmol), potassium carbonate (1.21 g, 8.7 mmol), Buchwald RuPhos Palladacycle Gen I precatalyst (Strem, CAS 1028206-60-1, 10.6 mg, 0.01 mmol), and water (2 mL) were subsequently added. The reaction mixture was stirred for 16 hours at 90° C., then cooled to ambient temperature and diluted with water (5 mL). The obtained mixture was extracted with dichloromethane (3×10 mL). The combined organic extracts were dried over MgSO₄, then evaporated to dryness. The residue was purified by flash chromatography on silica gel (impurities eluted with 20% dichloromethane in hexane, followed by 20% dichloromethane+10% EtOAc in hexane to elute the product). The product was isolated as a mixture of two isomers as a foamy solid (1.05 g, 79%). ¹H NMR (400 MHz, CDCl₃) δ 7.77 (s, 2H in A), 7.54-7.34 (m, 9H), 7.19-7.14 (m, 2H), 6.99 (d, J=7.8 Hz, 2H in A), 6.94 (d, J=1.5 Hz, 2H in B), 6.91 (d, J=7.8 Hz, 2H in B), 6.74 (d, J=1.6 Hz, 2H in A), 6.32 (s, 2H in B), 2.01-1.88 (m, 18H), 1.78-1.56 (m, 12H), 1.33-1.09 (m, 12H), 0.87 (t, J=7.3 Hz, 18H), 0.69-0.36 (m, 12H).

### (3-(1-adamantyl)-4-(methoxymethoxy)phenyl)tributylsilane

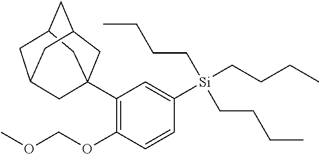 [SMILES: CCCC[Si](CCCC)(CCCC)c1ccc(OCOC)c(C23CC4CC(CC(C4)C2)C3)c1]

To a solution of 1-(5-bromo-2-(methoxymethoxy)phenyl)adamantane (5.07 g, 14.4 mmol) in THF (30 mL) at −55° C., t-BuLi in pentane (1.7 M, 17.0 mL, 28.8 mmol) was added dropwise over 10 minutes. The reaction mixture was stirred for 1 hour at −55° C., followed by addition of tributylchlorosilane (3.39 g, 14.4 mmol). The solution was stirred at −55° C. for 30 minutes, then stirred at ambient temperature for 1 hour. The reaction was poured into water (50 mL), and the resulting mixture was extracted with dichloromethane (3×100 mL). The combined organic extracts were dried over MgSO₄, then evaporated to dryness. The product was isolated as a clear oil (6.80 g, quantitative yield). ¹H NMR (400 MHz, CDCl₃) δ 7.34 (d, J=1.6 Hz, 1H), 7.26 (dd, J=8.0, 1.6 Hz, 1H), 7.06 (d, J=8.1 Hz, 1H), 5.23 (s, 2H), 3.53 (s, 3H), 2.15-2.05 (m, J=17.3, 3.5 Hz, 9H), 1.78 (s, 6H), 1.38-1.26 (m, 12H), 0.88 (t, J=6.8 Hz, 9H), 0.79-0.70 (m, 6H).

### (5-(1-adamantyl)-2′-bromo-6-(methoxymethoxy)-[1,1′-biphenyl]-3-yl)tributylsilane

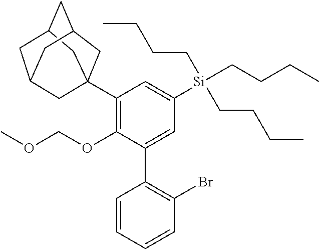 [SMILES: CCCC[Si](CCCC)(CCCC)c1cc(-c2ccccc2Br)c(OCOC)c(C23CC4CC(CC(C4)C2)C3)c1]

To a solution of (3-(1-adamantyl)-4-(methoxymethoxy)phenyl)tributylsilane (6.80 g, 14.4 mmol) in diethyl ether (50 mL) at ambient temperature, n-BuLi in hexane (1.6 M, 9.0 mL, 14.4 mmol) was added. The solution was stirred for 1 hour, then concentrated to dryness. The lithiated intermediate was dissolved in hexane. To the resulting solution at 60° C., 2-bromochlorobenzene (3.18 g, 16.6 mmol) in hexane (5 mL) was added dropwise. The reaction was stirred for 1 hour at 60° C., then filtered through Celite. The filtrate was concentrated, and the residue was purified by flash chromatography on silica gel (10% dichloromethane in hexane) to afford the product as a foamy solid (5.64 g, 63%). ¹H NMR (400 MHz, CDCl₃) δ 7.68 (d, J=8.0 Hz, 1H), 7.44-7.29 (m, 3H), 7.20 (t, J=7.7 Hz, 1H), 7.15 (s, 1H), 4.55 (d, J=4.7 Hz, 1H), 4.40 (d, J=4.7 Hz, 1H), 3.22 (d, J=1.2 Hz, 3H), 2.22-2.02 (m, 9H), 1.79 (s, 6H), 1.35-1.28 (m, 12H), 0.94-0.81 (m, 9H), 0.79-0.72 (d, J=9.3 Hz, 6H).

### (4-(1-adamantyl)-6-hydroxy-benzo[c][1,2]benzoxaborinin-2-yl)tributylsilane

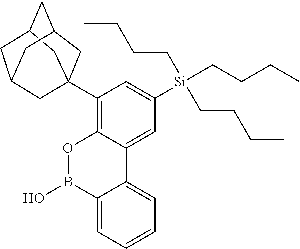 [SMILES: CCCC[Si](CCCC)(CCCC)c1cc2c(c(C34CC5CC(CC(C5)C3)C4)c1)OB(O)c1ccccc1-2]

To a solution of (5-(1-adamantyl)-2′-bromo-6-(methoxymethoxy)-[1,1′-biphenyl]-3-yl)tributylsilane (5.64 g, 8.5 mmol) in THF (30 mL) at −68° C., n-BuLi in hexanes (2.5 M, 3.73 mL, 9.3 mmol) was added dropwise over 10 minutes. The reaction mixture was stirred for 1 hour at −68° C., followed by addition of 2-isopropoxy-4,4,5,5-tetramethyl-1,3,2-dioxaborolane (2.36 g, 12.7 mmol). The resulting suspension was stirred for 1 hour at ambient temperature, then poured into 50 mL of water. The resulting mixture was extracted with dichloromethane (3×100 mL). The combined organic extracts were dried over MgSO₄, then evaporated to dryness.

To the residue, isopropanol (40 mL) was added, and the resulting solution was refluxed for 3 hours. After allowing the reaction to cool to ambient temperature, the reaction was concentrated to dryness. The product was purified by flash chromatography on silica gel (impurities eluted with 20% dichloromethane in hexane, followed by 20% dichloromethane+20% EtOAc in hexane to elute the product). The product was isolated as a foamy solid (2.58 g, 58%). ¹H NMR (400 MHz, CDCl₃) δ 8.33-8.14 (m, 2H), 8.08 (dd, J=18.9, 7.5 Hz, 1H), 7.73 (dt, J=15.3, 7.6 Hz, 1H), 7.48-7.40 (m, 2H), 4.57 (s, 1H), 2.35-2.11 (m, 6H), 2.08 (br, s, 3H), 1.87-1.74 (m, 6H), 1.41-1.29 (m, 12H), 0.93-0.81 (m, 15H).

### 2′,2″′-(pyridine-2,6-diyl)bis(3-(1-adamantyl)-5-(tributylsilyl)-[1,1′-biphenyl]-2-ol)

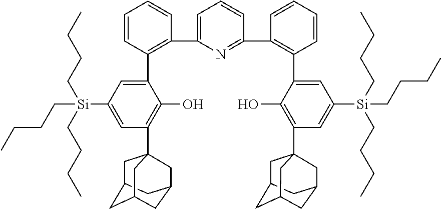 [SMILES: CCCC[Si](CCCC)(CCCC)c1cc(-c2ccccc2-c2cccc(-c3ccccc3-c3cc([Si](CCCC)(CCCC)CCCC)cc(C45CC6CC(CC(C6)C4)C5)c3O)n2)c(O)c(C23CC4CC(CC(C4)C2)C3)c1]

To a solution of (4-(1-adamantyl)-6-hydroxy-benzo[c][1,2]benzoxaborinin-2-yl)tributylsilane (2.50 g, 4.73 mmol) in 1,4-dioxane (30 mL), 2,6-dibromopyridine (0.56 g, 2.36 mmol), potassium carbonate (1.96 g, 14.2 mmol), Buchwald RuPhos Palladacycle Gen I precatalyst (Strem, CAS 1028206-60-1, 17.2 mg, 0.02 mmol), and water (15 mL) were subsequently added. This mixture was stirred for 16 hours at 100° C., then cooled to ambient temperature, and diluted with water (30 mL). The obtained mixture was extracted with dichloromethane (3×50 mL). The combined organic extracts were dried over MgSO₄, then evaporated to dryness. The residue was purified by flash chromatography on silica gel (impurities eluted with 20% dichloromethane in hexane, followed by 20% dichloromethane+20% EtOAc in hexane to elute the product). The product was isolated as a mixture of two isomers as a foamy solid (2.48 g, 97%). ¹H NMR (400 MHz, CDCl₃) δ 7.51-7.35 (m, 9H), 7.34 (s, 2H in A), 7.22 (s, 2H in B), 7.18 (s, 2H in A), 7.02 (d, J=7.8 Hz, 2H in A), 6.98 (d, J=1.4 Hz, 2H in B), 6.93 (d, J=7.8 Hz, 2H in B), 6.78 (d, J=1.4 Hz, 2H in A), 6.41 (s, 2H in B), 2.05-1.88 (m, 18H), 1.71 (s, 12H), 1.38-1.13 (m, 24H), 0.86 (t, J=7.1 Hz, 18H), 0.74-0.50 (m, 12H).

### (3-(1-adamantyl)-4-(methoxymethoxy)phenyl)triisopropylsilane

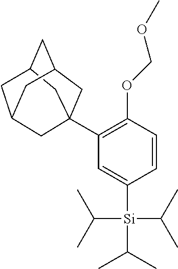 [SMILES: COCOc1ccc([Si](C(C)C)(C(C)C)C(C)C)cc1C12CC3CC(CC(C3)C1)C2]

To a solution of 14.0 g (39.8 mmol) of 1-(5-bromo-2-(methoxymethoxy)phenyl)adamantane in 300 mL of dry THF, 45.4 mL (81.7 mmol) of 1.8 M t-BuLi in pentane was added dropwise over 30 minutes at −80° C. The reaction mixture was stirred for 1 hour at this temperature followed by addition of 9.22 g (47.8 mmol) of triisopropylchlorosilane. The formed solution was stirred for 1 hour at room temperature, then poured into 300 mL of water. The obtained mixture was extracted with dichloromethane (3×100 mL); the combined organic extracts were dried over Na₂SO₄ and then evaporated to dryness. Yield 16.2 g (95%) of an off-white solid. ¹H NMR (CDCl₃, 400 MHz): δ 7.41 (d, J=1.5 Hz, 1H), 7.34 (dd, J=8.1, 1.5 Hz, 1H), 7.13 (d, J=8.1 Hz, 1H), 5.30 (s, 2H), 3.59 (s, 3H), 2.18-2.23 (m, 6H), 2.15 (br.s, 3H), 1.84-1.88 (m, 6H), 1.44 (sept, J=7.5 Hz, 3H), 1.15 (d, J=7.5 Hz, 18H). ¹³C NMR (CDCl₃, 100 MHz): δ 156.9, 137.0, 134.1, 133.5, 126.0, 113.4, 94.0, 56.2, 40.9, 37.2, 37.1, 29.2, 18.6, 10.9.

### (3-(1-adamantyl)-4-(methoxymethoxy)-5-(4,4,5,5-tetramethyl-1,3,2-dioxaborolan-2-yl)phenyl)triisopropylsilane

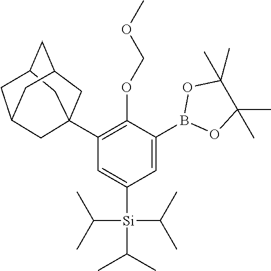 [SMILES: COCOc1c(B2OC(C)(C)C(C)(C)O2)cc([Si](C(C)C)(C(C)C)C(C)C)cc1C12CC3CC(CC(C3)C1)C2]

To a solution of 16.1 g (37.5 mmol) of (3-(1-adamantyl)-4-(methoxymethoxy)phenyl)triisopropylsilane in 300 mL of diethyl ether, 22.6 mL (56.3 mmol) of 2.5 M n-BuLi in hexanes was added dropwise over 20 minutes at 0° C. The reaction mixture was stirred for 12 hours at room temperature, then cooled to −80° C. followed by addition of 15.3 mL (75.0 mmol) of 2-isopropoxy-4,4,5,5-tetramethyl-1,3,2-dioxaborolane. The formed suspension was stirred for 1 hour at room temperature, then poured into 300 mL of water. The obtained mixture was extracted with dichloromethane (3×300 mL); the combined organic extracts were dried over Na₂SO₄ and then evaporated to dryness. The residue was triturated with small amount of n-hexane. Yield 20.5 g (98%) of a white solid. ¹H NMR (CDCl₃, 400 MHz): δ 7.66 (d, J=1.5 Hz, 1H), 7.49 (d, J=1.5 Hz, 1H), 5.25 (s, 2H), 3.60 (s, 3H), 2.14-2.21 (m, 6H), 2.10 (br.s, 3H), 1.75-1.85 (m, 6H), 1.40 (sept, J=7.5 Hz, 3H), 1.37 (s, 12H), 1.09 (d, J=7.5 Hz, 18H). ¹³C NMR (CDCl₃, 100 MHz): δ 162.4, 141.6, 139.3, 136.9, 127.3, 100.3, 83.5, 57.6, 41.3, 37.08, 37.05, 29.2, 24.7, 18.6, 10.9.

### (5-(1-adamantyl)-2′-bromo-6-(methoxymethoxy)-[1,1′-biphenyl]-3-yl)triisopropylsilane

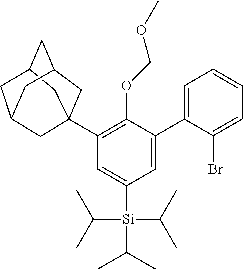 [SMILES: COCOc1c(-c2ccccc2Br)cc([Si](C(C)C)(C(C)C)C(C)C)cc1C12CC3CC(CC(C3)C1)C2]

To a solution of 20.5 g (36.9 mmol) of (3-(1-adamantyl)-4-(methoxymethoxy)-5-(4,4,5,5-tetramethyl-1,3,2-dioxaborolan-2-yl)phenyl)triisopropylsilane in 100 mL of 1,4-dioxane, 11.5 g (40.6 mmol) of 2-bromoiodobenzene, 15.3 g (111 mmol) of potassium carbonate, and 50 mL of water were subsequently added. The mixture obtained was purged with argon for 10 minutes followed by addition of 2.13 g (1.85 mmol) of Pd(PPh₃)₄. This mixture was stirred for 12 hours at 100° C., then cooled to room temperature, and diluted with 100 mL of water. The obtained mixture was extracted with dichloromethane (3×100 mL). The combined organic extracts were dried over Na₂SO₄ and then evaporated to dryness. The residue was purified by flash chromatography on silica gel 60 (40-63 um, eluent: hexane-dichloromethane=10:1, vol.). Yield 8.14 g (38%) of a white solid. ¹H NMR (CDCl₃, 400 MHz): δ 7.69 (d, J=8.0 Hz, 1H), 7.40-7.44 (m, 2H), 7.36 (dt, J=7.3, 1.1 Hz, 1H), 7.21 (dt, J=7.3, 1.8 Hz, 1H), 7.16 (d, J=1.5 Hz, 1H), 4.58-4.59 (m, 1H), 4.41-4.42 (m, 1H), 3.24 (s, 3H), 2.16-2.20 (m, 6H), 2.12 (br.s, 3H), 1.75-1.86 (m, 6H), 1.39 (sept, J=7.5 Hz, 3H), 1.10 (d, J=7.5 Hz, 9H), 1.08 (d, J=7.5 Hz, 9H). ¹³C NMR (CDCl₃, 100 MHz): δ 154.4, 141.5, 141.4, 136.8, 133.8, 133.7, 132.9, 132.4, 128.5, 128.4, 127.1, 124.3, 98.9, 57.2, 41.5, 37.4, 37.0, 29.2, 18.6, 10.9.

### (4-(1-adamantyl)-6-isopropoxy-6H-dibenzo[c,e][1,2]oxaborinin-2-yl)triisopropylsilane

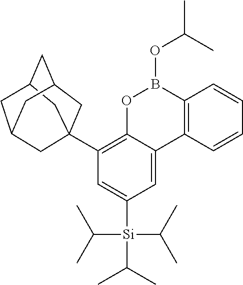 [SMILES: CC(C)OB1Oc2c(cc([Si](C(C)C)(C(C)C)C(C)C)cc2C23CC4CC(CC(C4)C2)C3)-c2ccccc21]

To a solution of 8.14 g (13.9 mmol) of (5-(1-adamantyl)-2′-bromo-6-(methoxymethoxy)-[1,1′-biphenyl]-3-yl)triisopropylsilane in 120 mL of dry THF, 5.86 mL (14.6 mmol) of 2.5 M n-BuLi in hexanes was added dropwise over 20 minutes at −80° C. The reaction mixture was stirred for 1 hour at this temperature followed by addition of 4.51 mL (20.9 mmol) of 2-isopropoxy-4,4,5,5-tetramethyl-1,3,2-dioxaborolane. The obtained suspension was stirred for 1 hour at room temperature, then poured into 300 mL of water. The obtained mixture was extracted with dichloromethane (3×100 mL). The combined organic extracts were dried over Na₂SO₄ and then evaporated to dryness. To the residue, 120 mL of isopropanol was added, and the resulting solution was refluxed for 2 hours. After cooling to room temperature, the precipitate formed was filtered through a glass frit (G4), washed with 10 mL of cold isopropanol, and then dried under vacuum. Yield 7.10 g (96%) of a white solid. ¹H NMR (CDCl₃, 400 MHz): 38.20 (d, J=1.0 Hz, 1H), 8.17 (d, J=8.3 Hz, 1H), 8.08 (dd, J=7.4, 1.1 Hz, 1H), 7.66 (dt, J=7.0, 1.5 Hz, 1H), 7.48 (d, J=1.3 Hz, 1H), 7.43 (t, J=8.0 Hz, 1H), 5.27 (sept, J=6.1 Hz, 1H), 2.28-2.32 (m, 6H), 2.17 (br.s, 3H), 1.82-1.90 (m, 6H), 1.49 (sept, J=7.5 Hz, 3H), 1.43 (d, J=6.1 Hz, 6H), 1.15 (d, J=7.5 Hz, 18H). ¹³C NMR (CDCl₃, 100 MHz): 3151.0, 140.8, 138.2, 133.4, 133.1, 131.9, 128.9, 126.9, 122.3, 121.5, 65.8, 40.9, 37.3, 37.2, 29.2, 24.7, 18.7, 10.9.

### 2′,2″′-(pyridine-2,6-diyl)bis(3-(1-adamantyl)-5-(triisopropylsilyl)-[1,1′-biphenyl]-2-ol)

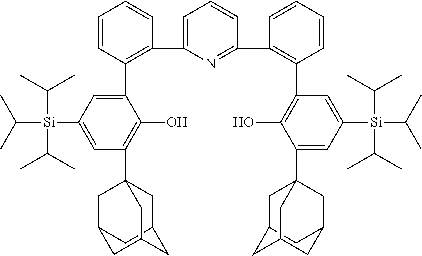 [SMILES: CC(C)[Si](c1cc(-c2ccccc2-c2cccc(-c3ccccc3-c3cc([Si](C(C)C)(C(C)C)C(C)C)cc(C45CC6CC(CC(C6)C4)C5)c3O)n2)c(O)c(C23CC4CC(CC(C4)C2)C3)c1)(C(C)C)C(C)C]

To a solution of 7.10 g (13.4 mmol) of (4-(1-adamantyl)-6-isopropoxy-6H-dibenzo[c,e][1,2]oxaborinin-2-yl)triisopropylsilane in 40 mL of 1,4-dioxane, 1.49 g (6.32 mmol) of 2,6-dibromopyridine, 13.2 g (40.3 mmol) of cesium carbonate, and 20 mL of water were subsequently added. The mixture obtained was purged with argon for 10 minutes followed by addition of 780 mg (0.67 mmol) of Pd(PPh₃)₄. This mixture was stirred for 12 hours at 100° C., then cooled to room temperature and diluted with 50 mL of water. The obtained mixture was extracted with dichloromethane (3×50 mL); the combined organic extracts were dried over Na₂SO₄ and then evaporated to dryness. The residue was purified by flash chromatography on silica gel 60 (40-63 um, eluent: hexane-ethyl acetate=10:1, vol.). Yield 4.50 g (69%) of a mixture of two isomers as a white powder. ¹H NMR (CDCl₃, 400 MHz): 37.38-7.50 (m, 11H), 7.21 (s, 2H in B), 7.19 (s, 2H in A), 6.99 (d, J=7.8 Hz, 2H in A), 6.96 (d, J=1.1 Hz, 2H in B), 6.86 (d, J=7.8 Hz, 2H in B), 6.82 (d, J=1.1 Hz, 2H in A), 6.09 (s, 2H in B), 1.98-2.04 (m, 18H in B), 1.91-1.97 (m, 18H in A), 1.74 (m, 12H in B), 1.68-1.74 (m, 12H in A), 1.26 (sept, J=7.6 Hz, 3H in B), 1.23 (sept, J=7.5 Hz, 3H in A), 0.99 (d, J=7.4 Hz, 18H in B), 0.98 (d, J=7.4 Hz, 18H in A), 0.93 (J=7.4 Hz, 18H in B), 0.90 (d, J=7.4 Hz, 18H in A). ¹³C NMR (CDCl₃, 100 MHz, signals attributed to the minor isomer are marked with *) 8157.8, 152.8, 152.2*, 140.7*, 139.9, 137.3, 136.9*, 136.7, 136.2*, 135.8*, 135.7, 135.50*, 135.46*, 133.0, 132.0, 131.6*, 130.8*, 130.7, 129.7, 128.9*, 128.8, 128.4*, 128.2*, 127.8, 124.0*, 123.9, 122.3, 122.2*, 40.5, 37.11, 37.07, 36.8*, 29.1, 18.6, 18.59*, 18.5, 10.74*, 10.7.

### (3-(1-adamantyl)-4-(methoxymethoxy)phenyl)(tert-butyl)diphenylsilane

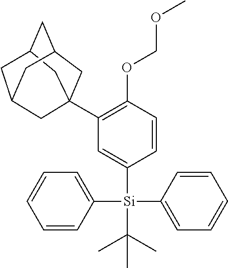 [SMILES: COCOc1ccc([Si](c2ccccc2)(c2ccccc2)C(C)(C)C)cc1C12CC3CC(CC(C3)C1)C2]

To a solution of 1-(5-bromo-2-(methoxymethoxy)phenyl)adamantane (1.48 g, 4.2 mmol) in THF (5 mL) at −60° C., t-BuLi in pentane (1.7 M, 5.0 mL, 8.4 mmol) was added dropwise over 10 minutes. The reaction mixture was stirred for 1 hour at −60° C., followed by addition of (tert-butyl)diphenylchlorosilane (1.16 g, 4.2 mmol). The solution was stirred at −60° C. for 30 minutes, then stirred at ambient temperature for 1 hour. The reaction was poured into water (10 mL), and the resulting mixture was extracted with dichloromethane (2×10 mL). The combined organic extracts were dried over MgSO₄, then evaporated to dryness. The crude product was used for the next step without further purification. ¹H NMR (400 MHz, CDCl₃) δ 7.74 (ddd, J=15.5, 7.9, 1.8 Hz, 1H), 7.61-7.55 (m, 4H), 7.52 (d, J=1.8 Hz, 1H), 7.46-7.31 (m, 6H), 7.03 (d, J=8.2 Hz, 1H), 5.24 (s, 2H), 3.53 (s, 3H), 2.06 (br, 9H), 1.75 (br, 6H), 1.17 (s, 9H).

### (5-(1-adamantyl)-2′-bromo-6-(methoxymethoxy)-[1,1′-biphenyl]-3-yl)(tert-butyl)diphenylsilane

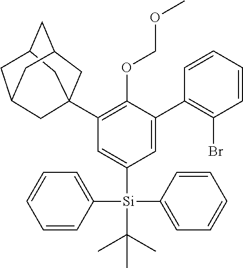 [SMILES: COCOc1c(-c2ccccc2Br)cc([Si](c2ccccc2)(c2ccccc2)C(C)(C)C)cc1C12CC3CC(CC(C3)C1)C2]

To a solution of (3-(1-adamantyl)-4-(methoxymethoxy)phenyl)(tert-butyl)diphenylsilane (2.30 g, 4.5 mmol) in diethyl ether (10 mL) at ambient temperature, n-BuLi in hexane (1.6 M, 2.8 mL, 4.5 mmol) was added. The solution was stirred for 1 hour, then concentrated to dryness. The crude solid was slurried into cold pentane (5 ml) for 5 minutes and was collected by filtration as a white solid (1.14 g, 43%).

The lithiated intermediate (1.14 g, 1.9 mmol) was dissolved in hexane. To the resulting solution at 60° C., 2-bromochlorobenzene (0.41 g, 2.1 mmol) in hexane (1 mL) was added dropwise. The reaction was stirred for 1 hour at 60° C., then filtered through Celite. The filtrate was concentrated, and the residue was purified by flash chromatography on silica gel (10% dichloromethane in hexane) to afford the product as a foamy solid (1.20 g, 93%). ¹H NMR (400 MHz, CDCl₃) δ 7.70-7.58 (m, 5H), 7.54 (d, J=1.8 Hz, 1H), 7.44-7.32 (m, 8H), 7.31 (d, J=1.7 Hz, 1H), 7.19 (td, J=7.7, 1.9 Hz, 1H), 4.60 (d, J=4.7 Hz, 1H), 4.43 (d, J=4.7 Hz, 1H), 3.25 (s, 3H), 2.14-2.04 (m, 9H), 1.77 (br, 6H), 1.19 (s, 9H).

### (4-(1-adamantyl)-6-isopropoxy-benzo[c][1,2]benzoxaborinin-2-yl)(tert-butyl)diphenylsilane

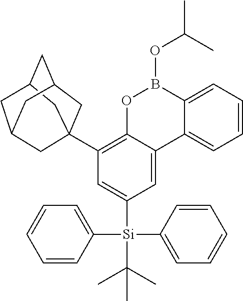 [SMILES: CC(C)OB1Oc2c(cc([Si](c3ccccc3)(c3ccccc3)C(C)(C)C)cc2C23CC4CC(CC(C4)C2)C3)-c2ccccc21]

To a solution of (5-(1-adamantyl)-2′-bromo-6-(methoxymethoxy)-[1,1′-biphenyl]-3-yl)(tert-butyl)diphenylsilane (1.19 g, 1.8 mmol) in THF (5 mL) at −60° C., n-BuLi in hexanes (2.5 M, 0.79 mL, 2.0 mmol) was added dropwise over 10 minutes. The reaction mixture was stirred for 1 hour at −60° C., followed by addition of 2-isopropoxy-4,4,5,5-tetramethyl-1,3,2-dioxaborolane (0.50 g, 2.7 mmol). The resulting suspension was stirred for 1 hour at ambient temperature, then poured into 5 mL of water. The resulting mixture was extracted with dichloromethane (2×5 mL). The combined organic extracts were dried over MgSO₄, then evaporated to dryness.

To the residue, isopropanol (20 mL) was added, and the resulting solution was refluxed for 2 hours. After allowing the reaction to cool to ambient temperature, the reaction was concentrated. The product was slowly precipitated out of solution below −20° C. and was collected by filtration as a white solid (0.85 g, 78%). ¹H NMR (400 MHz, CDCl₃) δ 8.20 (s, 1H), 8.04 (d, J=7.5 Hz, 1H), 7.85 (dd, J=17.6, 8.2 Hz, 1H), 7.66-7.61 (m, 4H), 7.61-7.49 (m, 2H), 7.46-7.31 (m, 7H), 5.35-5.13 (m, 1H in B), 4.03 (td, J=6.3, 4.1 Hz, 1H in A), 2.25-2.18 (m, 6H), 2.11 (br, 3H), 1.81 (br, 6H), 1.41 (d, J=6.1 Hz, 3H), 1.26-1.18 (m, 12H).

### 2′,2″′-(pyridine-2,6-diyl)bis(3-(1-adamantyl)-5-((tert-butyl)diphenylsilyl)-[1,1′-biphenyl]-2-ol)

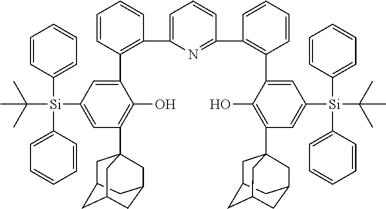 [SMILES: CC(C)(C)[Si](c1ccccc1)(c1ccccc1)c1cc(-c2ccccc2-c2cccc(-c3ccccc3-c3cc([Si](c4ccccc4)(c4ccccc4)C(C)(C)C)cc(C45CC6CC(CC(C6)C4)C5)c3O)n2)c(O)c(C23CC4CC(CC(C4)C2)C3)c1]

To a solution of (4-(1-adamantyl)-6-isopropoxy-benzo[c][1,2]benzoxaborinin-2-yl)(tert-butyl)diphenylsilane (0.73 g, 1.2 mmol) in 1,4-dioxane (4 mL), 2,6-dibromopyridine (0.14 g, 0.60 mmol), potassium carbonate (0.50 g, 3.6 mmol), Buchwald RuPhos Palladacycle Gen I precatalyst (Strem, CAS 1028206-60-1, 4 mg, 0.006 mmol), and water (2 mL) were subsequently added. This mixture was stirred for 16 hours at 100° C., then cooled to ambient temperature, and diluted with water (5 mL). The obtained mixture was extracted with dichloromethane (2×10 mL). The combined organic extracts were dried over MgSO₄, then evaporated to dryness. The residue was purified by flash chromatography on silica gel (impurities eluted with 20% dichloromethane in hexane, followed by 30% dichloromethane+10% EtOAc in hexane to elute the product). The product was isolated as a mixture of two isomers as a foamy solid (0.46 g, 66%). ¹H NMR (400 MHz, CDCl₃) δ 7.52-7.22 (m, 31H), 6.98 (s, 2H), 6.94 (d, J=7.8 Hz, 2H in A), 6.90 (d, J=1.6 Hz, 2H in A), 6.82 (d, J=7.8 Hz, 2H in B), 6.16 (s, 2H in B), 1.96-1.88 (m, 10H), 1.80 (br, 8H), 1.71-1.61 (m, 12H), 1.02 (s, 18H in A), 1.00 (s, 18H in B).

### (3-(1-adamantyl)-4-(methoxymethoxy)phenyl)(tert-butyl)dimethylsilane

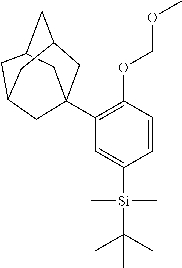 [SMILES: COCOc1ccc([Si](C)(C)C(C)(C)C)cc1C12CC3CC(CC(C3)C1)C2]

To a solution of 13.0 g (37.0 mmol) of 1-(5-bromo-2-(methoxymethoxy)phenyl)adamantane in 300 mL of dry THF, 42.0 mL (75.8 mmol) of 1.8 M t-BuLi in pentane was added dropwise over 30 minutes at −80° C. The reaction mixture was stirred for 1 hour at this temperature followed by addition of 6.69 g (44.4 mmol) of tert-butylchlorodimethylsilane. The obtained solution was stirred for 1 hour at room temperature, then poured into 300 mL of water. The obtained mixture was extracted with dichloromethane (3×100 mL); the combined organic extracts were dried over Na₂SO₄ and then evaporated to dryness. The residue was recrystallized from n-hexane. Yield 11.5 g (80%) of a light-yellow solid. ¹H NMR (CDCl₃, 400 MHz): δ 7.48 (d, J=1.6 Hz, 1H), 7.40 (dd, J=8.1, 1.6 Hz, 1H), 7.18 (d, J=8.1 Hz, 1H), 5.33 (s, 2H), 3.61 (s, 3H), 2.22-2.27 (m, 6H), 2.18 (br.s, 3H), 1.85-1.93 (m, 6H), 0.98 (s, 9H), 0.36 (s, 6H). ¹³C NMR (CDCl₃, 100 MHz): δ 157.1, 137.1, 133.4, 132.7, 129.2, 113.5, 94.0, 56.2, 40.7, 37.13, 37.06, 29.1, 26.5, 16.9, −6.0.

### (3-(1-adamantyl)-4-(methoxymethoxy)-5-(4,4,5,5-tetramethyl-1,3,2-dioxaborolan-2-yl)phenyl)(tert-butyl)dimethylsilane

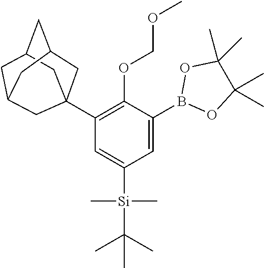 [SMILES: COCOc1c(B2OC(C)(C)C(C)(C)O2)cc([Si](C)(C)C(C)(C)C)cc1C12CC3CC(CC(C3)C1)C2]

To a solution of 11.5 g (29.7 mmol) of (3-(1-adamantyl)-4-(methoxymethoxy)phenyl)(tert-butyl)dimethylsilane in 300 mL of diethyl ether, 17.8 mL (44.6 mmol) of 2.5 M n-BuLi in hexanes was added dropwise over 20 minutes at 0° C. The reaction mixture was stirred for 12 hours at room temperature, then cooled to −80° C. followed by addition of 12.2 mL (59.4 mmol) of 2-isopropoxy-4,4,5,5-tetramethyl-1,3,2-dioxaborolane. The formed suspension was stirred for 1 hour at room temperature, then poured into 300 mL of water. The obtained mixture was extracted with dichloromethane (3×300 mL); the combined organic extracts were dried over Na₂SO₄ and then evaporated to dryness. The residue was recrystallized from n-hexane. Yield 14.1 g (93%) of a white solid. ¹H NMR (CDCl₃, 400 MHz): δ 7.66 (d, J=1.7 Hz, 1H), 7.52 (d, J=1.7 Hz, 1H), 5.23 (s, 2H), 3.60 (s, 3H), 2.14-2.20 (m, 6H), 2.09 (br.s, 3H), 1.77-1.85 (m, 6H), 1.37 (s, 12H), 0.89 (s, 9H), 0.27 (s, 6H). ¹³C NMR (CDCl₃, 100 MHz): δ 162.7, 140.7, 139.6, 136.1, 130.5, 100.5, 83.6, 57.7, 41.2, 37.12, 37.05, 29.2, 26.6, 24.8, 16.9, −6.0.

### (5-(1-adamantyl)-2′-bromo-6-(methoxymethoxy)-[1,1′-biphenyl]-3-yl)(tert-butyl)dimethylsilane

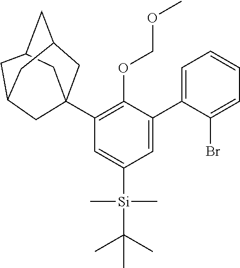 [SMILES: COCOc1c(-c2ccccc2Br)cc([Si](C)(C)C(C)(C)C)cc1C12CC3CC(CC(C3)C1)C2]

To a solution of 14.0 g (27.4 mmol) of (3-(1-adamantyl)-4-(methoxymethoxy)-5-(4,4,5,5-tetramethyl-1,3,2-dioxaborolan-2-yl)phenyl)(tert-butyl)dimethylsilane in 80 mL of 1,4-dioxane, 8.15 g (28.8 mmol) of 2-bromoiodobenzene, 11.4 g (82.3 mmol) of potassium carbonate, and 40 mL of water were subsequently added. The mixture obtained was purged with argon for 10 minutes followed by addition of 1.57 g (1.36 mmol) of Pd(PPh₃)₄. This mixture was stirred for 12 hours at 100° C., then cooled to room temperature, and diluted with 100 mL of water. The obtained mixture was extracted with dichloromethane (3×100 mL); the combined organic extracts were dried over Na₂SO₄ and then evaporated to dryness. The residue was purified by flash chromatography on silica gel 60 (40-63 um, eluent: hexane-dichloromethane=10:1, vol.). Yield 6.75 g (46%) of a white solid. ¹H NMR (CDCl₃, 400 MHz): δ 7.70 (dd, J=8.0, 1.0 Hz, 1H), 7.47 (d, J=1.6 Hz, 1H), 7.41 (dd, J=7.6, 1.8 Hz, 1H), 7.37 (dt, J=7.4, 1.0 Hz, 1H), 7.20-7.25 (m, 2H), 4.57-4.58 (m, 1H), 4.44-4.45 (m, 1H), 3.25 (s, 3H), 2.18-2.23 (m, 6H), 2.13 (br.s, 3H), 1.78-1.86 (m, 6H), 0.90 (s, 9H), 0.30 (s, 3H), 0.28 (s, 3H). ¹³C NMR (CDCl₃, 100 MHz): δ 154.7, 141.6, 141.3, 136.1, 133.7, 133.0, 132.9, 132.4, 131.5, 128.6, 127.1, 124.2, 98.9, 57.2, 41.3, 37.4, 37.0, 29.2, 26.5, 17.0, −6.10,-6.13.

### (4-(1-adamantyl)-6-isopropoxy-6H-dibenzo[c,e][1,2]oxaborinin-2-yl)(tert-butyl)dimethylsilane

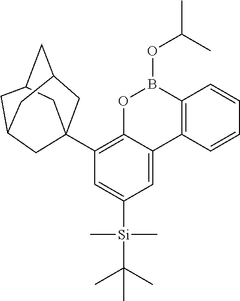 [SMILES: CC(C)OB1Oc2c(cc([Si](C)(C)C(C)(C)C)cc2C23CC4CC(CC(C4)C2)C3)-c2ccccc21]

To a solution of 6.75 g (12.6 mmol) of (5-(1-adamantyl)-2′-bromo-6-(methoxymethoxy)-[1,1′-biphenyl]-3-yl)(tert-butyl)dimethylsilane in 100 mL of dry THF, 5.31 mL (13.3 mmol) of 2.5 M n-BuLi in hexanes was added dropwise over 20 minutes at −80° C. The reaction mixture was stirred for 1 hour at this temperature followed by addition of 3.83 mL (18.9 mmol) of 2-isopropoxy-4,4,5,5-tetramethyl-1,3,2-dioxaborolane. The obtained suspension was stirred for 1 hour at room temperature, then poured into 300 mL of water. The obtained mixture was extracted with dichloromethane (3×100 mL); the combined organic extracts were dried over Na₂SO₄ and then evaporated to dryness. To the residue, 120 mL of isopropanol was added, and the resulting solution was refluxed for 2 hours. After cooling to room temperature, the precipitate formed was filtered off using a glass frit (G4), washed with 10 mL of cold isopropanol, and then dried under vacuum. Yield 6.14 g (96%) of a white solid. ¹H NMR (CDCl₃, 400 MHz): 38.21 (s, 1H), 8.20 (d, J=8.0 Hz, 1H), 8.09 (dd, J=7.5, 1.4 Hz, 1H), 7.67 (dt, J=8.2, 1.5 Hz, 1H), 7.50 (d, J=1.3 Hz, 1H), 7.43 (t, J=7.4 Hz, 1H), 5.27 (sept, J=6.2 Hz, 1H), 2.29-2.33 (m, 6H), 2.18 (br.s, 3H), 1.83-1.89 (m, 6H), 1.43 (d, J=6.2 Hz, 6H), 0.94 (s, 9H), 0.37 (s, 6H). ¹³C NMR (CDCl₃, 100 MHz): 3151.2, 140.7, 138.3, 133.1, 132.4, 131.9, 129.9, 128.1, 126.7, 122.2, 121.6, 65.8, 40.8, 37.3, 37.2, 29.1, 26.6, 24.7, 17.0, −5.9.

### 2′,2″′-(pyridine-2,6-diyl)bis(3-(1-adamantyl)-5-(tert-butyldimethylsilyl)-[1,1′-biphenyl]-2-ol)

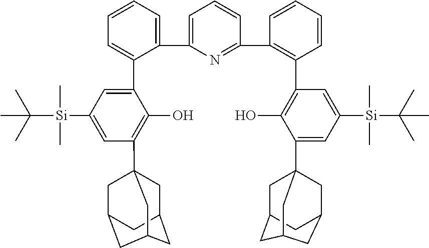 [SMILES: CC(C)(C)[Si](C)(C)c1cc(-c2ccccc2-c2cccc(-c3ccccc3-c3cc([Si](C)(C)C(C)(C)C)cc(C45CC6CC(CC(C6)C4)C5)c3O)n2)c(O)c(C23CC4CC(CC(C4)C2)C3)c1]

To a solution of 5.87 g (12.1 mmol) of (4-(1-adamantyl)-6-isopropoxy-6H-dibenzo[c,e][1,2]oxaborinin-2-yl)(tert-butyl)dimethylsilane in 30 mL of 1,4-dioxane, 1.32 g (5.56 mmol) of 2,6-dibromopyridine, 11.8 g (36.2 mmol) of cesium carbonate, and 15 mL of water were subsequently added. The mixture obtained was purged with argon for 10 minutes followed by addition of 703 mg (0.61 mmol) of Pd(PPh₃)₄. This mixture was stirred for 12 hours at 100° C., then cooled to room temperature, and diluted with 50 mL of water. The obtained mixture was extracted with dichloromethane (3×50 mL); the combined organic extracts were dried over Na₂SO₄ and then evaporated to dryness. The residue was purified by flash chromatography on silica gel 60 (40-63 um, eluent: hexane-ethyl acetate=10:1, vol.). Yield 4.21 g (84%) of a mixture of two isomers as a white powder. ¹H NMR (CDCl₃, 400 MHz): δ 8.25 (s, 2H in A), 7.36-7.56 (m, 9H), 7.20 (d, J=1.3 Hz, 2H in A), 7.03 (d, J=1.4 Hz, 2H in B), 6.97 (d, J=7.8 Hz, 2H in A), 6.94 (d, J=7.8 Hz, 2H in B), 6.72 (d, J=1.4 Hz, 2H in A), 6.70 (d, J=1.3 Hz, 2H in B), 1.83-2.04 (m, 18H), 1.63-1.72 (m, 12H), 0.75 (s, 18H in B), 0.61 (s, 18H in A), 0.15 (s, 12H in B), 0.05 (s, 6H in A), 0.04 (s, 6H in A). ¹³C NMR (CDCl₃, 100 MHz) δ 157.7, 153.3, 139.3, 137.3, 137.0, 135.4, 132.2, 132.0, 131.1, 129.8, 129.0, 127.9, 127.2, 122.6, 40.5, 37.0, 36.8, 29.1, 26.3, 16.7, −6.1, −6.3.

### (3-(1-adamantyl)-4-(methoxymethoxy)phenyl)(butyl)dimethylsilane

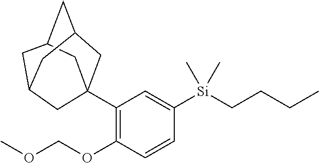 [SMILES: CCCC[Si](C)(C)c1ccc(OCOC)c(C23CC4CC(CC(C4)C2)C3)c1]

To a solution of 1-(5-bromo-2-(methoxymethoxy)phenyl)adamantane (2.10 g, 6.0 mmol) in THF (5 mL) at −60° C., t-BuLi in pentane (1.7 M, 7.0 mL, 12.0 mmol) was added dropwise over 10 minutes. The reaction mixture was stirred for 1 hour at −60° C., followed by addition of (butyl)dimethylchlorosilane (0.90 g, 6.0 mmol). The solution was stirred at −60° C. for 30 minutes, then stirred at ambient temperature for 1 hour. The reaction was poured into water (10 mL), and the resulting mixture was extracted with dichloromethane (3×10 mL). The combined organic extracts were dried over MgSO₄, then evaporated to dryness. The residue was purified by flash chromatography on silica gel (10% dichloromethane in hexane) to afford the product as a foamy solid (1.51 g, 65.3%). ¹H NMR (400 MHz, CDCl₃) δ 7.37 (d, J=1.7 Hz, 1H), 7.29 (dd, J=8.0, 1.6 Hz, 1H), 7.08 (d, J=8.0 Hz, 1H), 5.23 (s, 2H), 3.52 (s, 3H), 2.26-1.96 (m, 9H), 1.78 (br, 6H), 1.45-1.20 (m, 4H), 0.95-0.81 (m, 3H), 0.77-0.65 (m, 2H), 0.23 (s, 6H).

### (5-(1-adamantyl)-2′-bromo-6-(methoxymethoxy)-[1,1′-biphenyl]-3-yl)(butyl)dimethylsilane

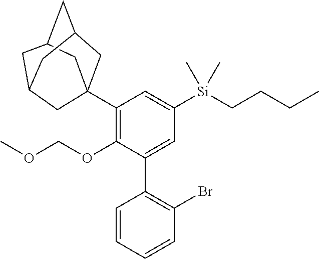 [SMILES: CCCC[Si](C)(C)c1cc(-c2ccccc2Br)c(OCOC)c(C23CC4CC(CC(C4)C2)C3)c1]

To a solution of (3-(1-adamantyl)-4-(methoxymethoxy)phenyl)(butyl)dimethylsilane (1.70 g, 4.4 mmol) in diethyl ether (10 mL) at ambient temperature, n-BuLi in hexane (1.6 M, 2.8 mL, 4.4 mmol) was added. The solution was stirred for 1 hour, then concentrated to dryness. The lithiated intermediate was dissolved in hexane. To the resulting solution at 60° C., 2-bromochlorobenzene (0.88 g, 4.6 mmol) in hexane (1 mL) was added dropwise. The reaction was stirred for 1 hour at 60° C., then filtered through Celite. The filtrate was concentrated, and the residue was purified by flash chromatography on silica gel (10% dichloromethane in hexane) to afford the product as a foamy solid (1.94 g, 81%). ¹H NMR (400 MHz, CDCl₃) δ 7.68 (dd, J=8.0, 1.2 Hz, 1H), 7.45 (d, J=1.7 Hz, 1H), 7.40 (dd, J=7.6, 1.9 Hz, 1H), 7.35 (td, J=7.4, 1.2 Hz, 1H), 7.23-7.20 (m, 1H), 7.19 (d, J=1.7 Hz, 1H), 4.48 (dd, J=43.0, 4.7 Hz, 2H), 3.23 (s, 3H), 2.28-2.04 (m, 9H), 1.79 (br, 6H), 1.39-1.28 (m, 4H), 0.93-0.82 (m, 3H), 0.79-0.66 (m, 2H), 0.25 (d, J=4.2 Hz, 6H).

(4-(1-adamantyl)-6-isopropoxy-benzo[c][1,2]benzoxaborinin-2-yl)(butyl)dimethylsilane

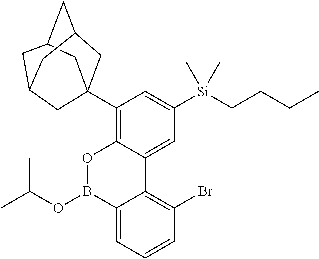 [SMILES: CCCC[Si](C)(C)c1cc2c(c(C34CC5CC(CC(C5)C3)C4)c1)OB(OC(C)C)c1cccc(Br)c1-2]

To a solution of (5-(1-adamantyl)-2′-bromo-6-(methoxymethoxy)-[1,1′-biphenyl]-3-yl)(butyl)dimethylsilane (1.94 g, 3.6 mmol) in THF (5 mL) at −60° C., n-BuLi in hexanes (2.5 M, 1.60 mL, 3.9 mmol) was added dropwise over 10 minutes. The reaction mixture was stirred for 1 hour at −60° C., followed by addition of 2-isopropoxy-4,4,5,5-tetramethyl-1,3,2-dioxaborolane (1.00 g, 5.4 mmol). The resulting suspension was stirred for 1 hour at ambient temperature, then poured into 5 mL of water. The resulting mixture was extracted with dichloromethane (3×5 mL). The combined organic extracts were dried over MgSO₄, then evaporated to dryness.

To the residue, isopropanol (20 mL) was added, and the resulting solution was refluxed for 4 hours. After allowing the reaction to cool to ambient temperature, the reaction was concentrated. The crude product was slowly precipitated out of solution as a white solid below −20° C. The pure product (1.32 g, 76%) was isolated by filtration. ¹H NMR (400 MHz, CDCl₃) δ 8.27-8.15 (m, 2H), 8.06 (d, J=7.4 Hz, 1H), 7.68 (dddd, J=22.7, 8.4, 7.2, 1.6 Hz, 1H), 7.52-7.37 (m, 2H), 5.25 (p, J=6.1 Hz, 1H in B), 4.04 (pd, J=6.1, 4.2 Hz, 1H in A), 2.36-2.07 (m, 9H), 1.85 (br, 6H), 1.41 (d, J=6.1 Hz, 3H), 1.40-1.31 (m, 4H), 1.22 (d, J=6.1 Hz, 3H), 0.94-0.85 (m, 3H), 0.85-0.75 (m, 2H), 0.33 (s, 6H).

### 2′,2″′-(pyridine-2,6-diyl)bis(3-(1-adamantanyl)-5-(butyldimethylsilyl)-[1,1′-biphenyl]-2-ol)

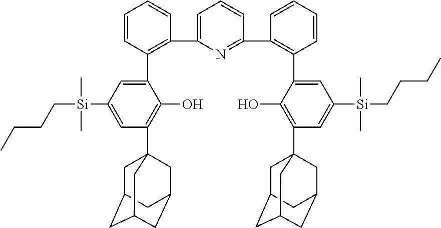 [SMILES: CCCC[Si](C)(C)c1cc(-c2ccccc2-c2cccc(-c3ccccc3-c3cc([Si](C)(C)CCCC)cc(C45CC6CC(CC(C6)C4)C5)c3O)n2)c(O)c(C23CC4CC(CC(C4)C2)C3)c1]

To a solution of (4-(1-adamantyl)-6-isopropoxy-benzo[c][1,2]benzoxaborinin-2-yl)(butyl)dimethylsilane (1.21 g, 2.50 mmol) in THF (8 mL), 2,6-dibromopyridine (0.29 g, 1.25 mmol), potassium carbonate (1.03 g, 7.5 mmol), Buchwald RuPhos Palladacycle Gen I precatalyst (Strem, CAS 1028206-60-1, 9.1 mg, 0.01 mmol), and water (2 mL) were subsequently added. This mixture was stirred for 16 hours at 90° C., then cooled to ambient temperature, and diluted with water (5 mL). The obtained mixture was extracted with dichloromethane (2×10 mL). The combined organic extracts were dried over MgSO₄, then evaporated to dryness. The residue was purified by flash chromatography on silica gel (impurities eluted with 20% dichloromethane in hexane, followed by 30% dichloromethane+10% EtOAc in hexane to elute the product). The product was isolated as a mixture of two isomers as a foamy solid (0.89 g, 78%). ¹H NMR (400 MHz, CDCl₃) δ 8.13 (s, 2H in A), 7.54-7.34 (m, 9H), 7.21 (s, 2H), 7.09 (d, J=1.5 Hz, 2H in B), 7.06-6.96 (m, 2H), 6.86 (s, 2H in B), 6.72 (d, J=1.5 Hz, 2H in A), 2.06-1.75 (m, 18H), 1.73-1.57 (m, 12H), 1.36-1.20 (m, 8H in A), 1.18-1.09 (qd, J=8.3, 5.8 Hz, 8H in B), 0.84 (t, J=7.2 Hz, 6H), 0.68-0.59 (m, 4H in B), 0.53 (td, J=7.8, 5.9 Hz, 4H in A), 0.13 (s, 12H in B), 0.00 (d, J=6.0 Hz, 12H in A).

### (3-(1-adamantyl)-4-(methoxymethoxy)phenyl)(octyl)dimethylsilane

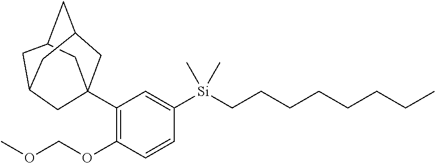 [SMILES: CCCCCCCC[Si](C)(C)c1ccc(OCOC)c(C23CC4CC(CC(C4)C2)C3)c1]

To a solution of 1-(5-bromo-2-(methoxymethoxy)phenyl)adamantane (2.00 g, 5.7 mmol) in THF (5 mL) at −60° C., t-BuLi in pentane (1.7 M, 6.7 mL, 11.4 mmol) was added dropwise over 10 minutes. The reaction mixture was stirred for 1 hour at −60° C., followed by addition of dimethyl(octyl)chlorosilane (1.18 g, 5.7 mmol). The solution was stirred at −60° C. for 30 minutes, then stirred at ambient temperature for 1 hour. The reaction was poured into water (10 mL), and the resulting mixture was extracted with dichloromethane (2×10 mL). The combined organic extracts were dried over MgSO₄, then evaporated to dryness. The residue was purified by flash chromatography on silica gel (10% dichloromethane in hexane) to afford the product as a foamy solid (1.78 g, 71%). ¹H NMR (400 MHz, CDCl₃) δ 7.37 (d, J=1.7 Hz, 1H), 7.29 (dd, J=8.0, 1.6 Hz, 1H), 7.08 (d, J=8.0 Hz, 1H), 5.23 (s, 2H), 3.52 (s, 3H), 2.17-2.03 (m, 9H), 1.83-1.65 (m, 6H), 1.41-1.13 (m, 12H), 0.91-0.86 (m, 3H), 0.77-0.63 (m, 2H), 0.22 (s, 6H).

### (5-(1-adamantyl)-2′-bromo-6-(methoxymethoxy)-[1,1′-biphenyl]-3-yl)(octyl)dimethylsilane

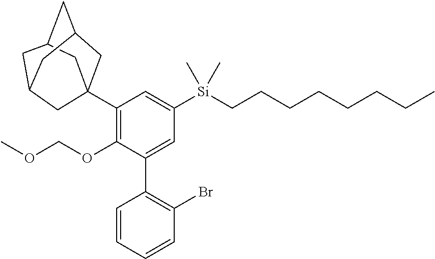 [SMILES: CCCCCCCC[Si](C)(C)c1cc(-c2ccccc2Br)c(OCOC)c(C23CC4CC(CC(C4)C2)C3)c1]

To a solution of (3-(1-adamantyl)-4-(methoxymethoxy)phenyl)(octyl)dimethylsilane (1.77 g, 4.0 mmol) in diethyl ether (10 mL) at ambient temperature, n-BuLi in hexane (1.6 M, 2.5 mL, 4.0 mmol) was added. The solution was stirred for 1 hour, then concentrated to dryness. The lithiated intermediate was dissolved in hexane. To the resulting solution at 60° C., 2-bromochlorobenzene (0.84 g, 4.4 mmol) in hexane (1 mL) was added dropwise. The reaction was stirred for 1 hour at 60° C., then filtered through Celite. The filtrate was concentrated, and the residue was purified by flash chromatography on silica gel (10% dichloromethane in hexane) to afford the product as a foamy solid (1.74 g, 73%). ¹H NMR (400 MHz, CDCl₃) δ 7.68 (d, J=7.9 Hz, 1H), 7.45 (s, 1H), 7.42-7.31 (m, 2H), 7.24-7.14 (m, 2H), 4.60-4.26 (m, 2H), 3.23 (s, 3H), 2.26-2.02 (m, 9H), 1.79 (br, 6H), 1.40-1.22 (m, 12H), 0.93-0.83 (m, 3H), 0.73 (t, J=7.9 Hz, 2H), 0.29-0.20 (m, 6H).

### (4-(1-adamantyl)-6-hydroxy-benzo[c][1,2]benzoxaborinin-2-yl)(octyl)dimethylsilane

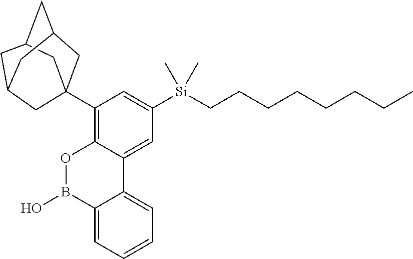 [SMILES: CCCCCCCC[Si](C)(C)c1cc2c(c(C34CC5CC(CC(C5)C3)C4)c1)OB(O)c1ccccc1-2]

To a solution of (5-(1-adamantyl)-2′-bromo-6-(methoxymethoxy)-[1,1′-biphenyl]-3-yl)(octyl)dimethylsilane (1.70 g, 2.8 mmol) in THF (5 mL) at −60° C., n-BuLi in hexanes (2.5 M, 1.25 mL, 3.1 mmol) was added dropwise over 10 minutes. The reaction mixture was stirred for 1 hour at −60° C., followed by addition of 2-isopropoxy-4,4,5,5-tetramethyl-1,3,2-dioxaborolane (0.79 g, 4.3 mmol). The resulting suspension was stirred for 1 hour at ambient temperature, then poured into 5 mL of water. The resulting mixture was extracted with dichloromethane (3×5 mL). The combined organic extracts were dried over MgSO₄, then evaporated to dryness.

To the residue, isopropanol (20 mL) was added, and the resulting solution was refluxed for 2 hours. After allowing the reaction to cool to ambient temperature, the reaction was concentrated to dryness. The product was purified by flash chromatography on silica gel (impurities eluted with 20% dichloromethane in hexane, followed by 20% dichloromethane+20% EtOAc in hexane to elute the product). The product was isolated as a foamy solid (0.90 g, 58%). ¹H NMR (400 MHz, CDCl₃) δ 8.36-8.17 (m, 2H), 8.08 (dd, J=13.4, 7.4 Hz, 1H), 7.73 (dt, J=14.8, 7.7 Hz, 1H), 7.51-7.38 (m, 2H), 4.51 (s, 1H), 2.30-2.06 (m, 9H), 1.87-1.74 (m, 6H), 1.44-1.12 (m, 12H), 0.95-0.68 (m, 5H), 0.33 (d, J=5.9 Hz, 6H).

### 2′,2″′-(pyridine-2,6-diyl)bis(3-(1-adamantanyl)-5-(octyldimethylsilyl)-[1,1′-biphenyl]-2-ol)

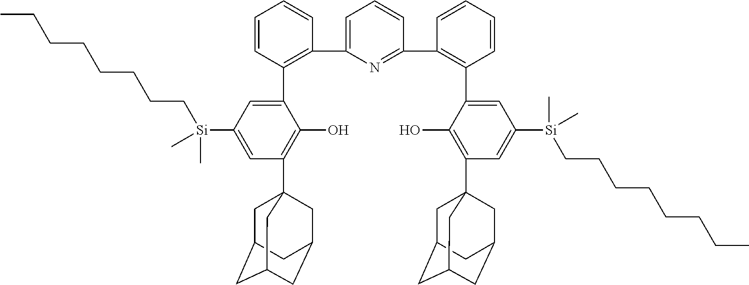 [SMILES: CCCCCCCC[Si](C)(C)c1cc(-c2ccccc2-c2cccc(-c3ccccc3-c3cc([Si](C)(C)CCCCCCCC)cc(C45CC6CC(CC(C6)C4)C5)c3O)n2)c(O)c(C23CC4CC(CC(C4)C2)C3)c1]

To a solution of (4-(1-adamantyl)-6-hydroxy-benzo[c][1,2]benzoxaborinin-2-yl)(octyl)dimethylsilane (0.85 g, 1.56 mmol) in 1,4-dioxane (4 mL), 2,6-dibromopyridine (0.18 g, 0.78 mmol), potassium carbonate (0.65 g, 4.7 mmol), Buchwald RuPhos Palladacycle Gen I precatalyst (Strem, CAS 1028206-60-1, 5.7 mg, 0.008 mmol), and water (2 mL) were subsequently added. This mixture was stirred for 16 hours at 100° C., then cooled to ambient temperature, and diluted with water (5 mL). The obtained mixture was extracted with dichloromethane (2×10 mL). The combined organic extracts were dried over MgSO₄, then evaporated to dryness. The residue was purified by flash chromatography on silica gel (impurities eluted with 25% dichloromethane in hexane, followed by 30% dichloromethane+10% EtOAc in hexane to elute the product). The product was isolated as a mixture of two isomers as a foamy solid (0.46 g, 57%). ¹H NMR (400 MHz, CDCl₃) δ 8.11 (s, 2H in A), 7.54-7.32 (m, 9H), 7.17 (s, 2H), 7.06 (s, 2H in B), 6.99 (dd, J=8.1, 4.2 Hz, 2H), 6.84 (s, 2H in B), 6.68 (s, 2H in A), 2.03-1.74 (m, 18H), 1.66 (br, 12H), 1.32-1.18 (m, 24H), 0.87 (t, J=6.5 Hz, 6H), 0.65-0.38 (m, 4H), 0.00 (s, 12H in B), −0.04 (d, J=4.9 Hz, 12H in A).

### (3-(1-adamantyl)-4-(methoxymethoxy)phenyl)(3,3-dimethylbutyl)dimethylsilane

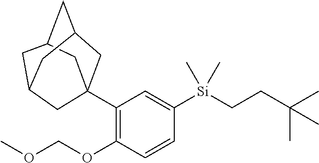 [SMILES: COCOc1ccc([Si](C)(C)CCC(C)(C)C)cc1C12CC3CC(CC(C3)C1)C2]

To a solution of 1-(5-bromo-2-(methoxymethoxy)phenyl)adamantane (2.15 g, 6.1 mmol) in THF (5 mL) at −60° C., t-BuLi in pentane (1.7 M, 7.2 mL, 12.2 mmol) was added dropwise over 10 minutes. The reaction mixture was stirred for 1 hour at −60° C., followed by addition of (3,3-dimethylbutyl)-dimethylchlorosilane (1.09 g, 6.1 mmol). The solution was stirred at −60° C. for 30 minutes, then stirred at ambient temperature for 1 hour. The reaction was poured into water (10 mL), and the resulting mixture was extracted with dichloromethane (2×10 mL). The combined organic extracts were dried over MgSO₄, then evaporated to dryness. The residue was purified by flash chromatography on silica gel (10% dichloromethane in hexane) to afford the product as a foamy solid (1.97 g, 78%). ¹H NMR (400 MHz, CDCl₃) δ 7.37 (d, J=1.7 Hz, 1H), 7.30 (dd, J=8.0, 1.6 Hz, 1H), 7.08 (d, J=8.1 Hz, 1H), 5.24 (s, 2H), 3.52 (s, 3H), 2.23-2.01 (m, 9H), 1.78 (br, 6H), 1.25-1.11 (m, 2H), 0.85 (s, 9H), 0.71-0.56 (m, 2H), 0.22 (s, 6H).

### (5-(1-adamantyl)-2′-bromo-6-(methoxymethoxy)-[1,1′-biphenyl]-3-yl)(3,3-dimethylbutyl)dimethylsilane

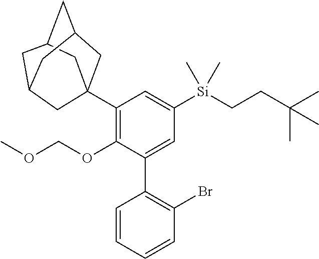 [SMILES: COCOc1c(-c2ccccc2Br)cc([Si](C)(C)CCC(C)(C)C)cc1C12CC3CC(CC(C3)C1)C2]

To a solution of (3-(1-adamantyl)-4-(methoxymethoxy)phenyl)(3,3-dimethylbutyl)-dimethylsilane (1.96 g, 4.7 mmol) in diethyl ether (10 mL) at ambient temperature, n-BuLi in hexane (1.6 M, 3.0 mL, 4.7 mmol) was added. The solution was stirred for 1 hour, then concentrated to dryness. The lithiated intermediate was dissolved in hexane. To the resulting solution at 60° C., 2-bromochlorobenzene (0.95 g, 5.0 mmol) in hexane (1 mL) was added dropwise. The reaction was stirred for 1 hour at 60° C., then filtered through Celite. The filtrate was concentrated, and the residue was purified by flash chromatography on silica gel (10% dichloromethane in hexane) to afford the product as a foamy solid (2.45 g, 91%). ¹H NMR (400 MHz, CDCl₃) δ 7.68 (dd, J=8.1, 1.2 Hz, 1H), 7.45 (d, J=1.6 Hz, 1H), 7.42-7.31 (m, 2H), 7.24-7.14 (m, 2H), 4.54 (d, J=4.6 Hz, 1H), 4.42 (d, J=4.6 Hz, 1H), 3.23 (s, 3H), 2.28-2.04 (m, 9H), 1.79 (br, 6H), 1.24-1.15 (m, 2H), 0.84 (s, 9H), 0.70-0.59 (m, 2H), 0.24 (d, J=6.4 Hz, 6H).

### (4-(1-adamantyl)-6-isopropoxy-benzo[c][1,2]benzoxaborinin-2-yl)(3,3-dimethylbutyl)dimethylsilane

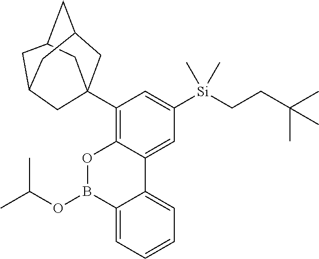 [SMILES: CC(C)OB1Oc2c(cc([Si](C)(C)CCC(C)(C)C)cc2C23CC4CC(CC(C4)C2)C3)-c2ccccc21]

To a solution of (5-(1-adamantyl)-2′-bromo-6-(methoxymethoxy)-[1,1′-biphenyl]-3-yl)(3,3-dimethylbutyl)dimethylsilane (2.42 g, 4.2 mmol) in THF (5 mL) at −60° C., n-BuLi in hexanes (2.5 M, 1.90 mL, 4.7 mmol) was added dropwise over 10 minutes. The reaction mixture was stirred for 1 hour at −60° C., followed by addition of 2-isopropoxy-4,4,5,5-tetramethyl-1,3,2-dioxaborolane (1.19 g, 6.3 mmol). The resulting suspension was stirred for 1 hour at ambient temperature, then poured into 5 mL of water. The resulting mixture was extracted with dichloromethane (3×5 mL). The combined organic extracts were dried over MgSO₄, then evaporated to dryness.

To the residue, isopropanol (20 mL) was added, and the resulting solution was refluxed for 16 hours. After allowing the reaction to cool to ambient temperature, the reaction was concentrated and cooled below −20° C. for 1 hour. The product was collected by filtration and washed with a small amount of cold isopropanol to afford a white solid (1.54 g, 70%). ¹H NMR (400 MHz, CDCl₃) δ 8.27-8.16 (m, 2H), 8.06 (d, J=7.7 Hz, 1H), 7.68 (dtd, J=23.3, 8.2, 7.7, 1.5 Hz, 1H), 7.53-7.37 (m, 2H), 5.25 (p, J=6.2 Hz, 1H in B), 4.03 (p, J=6.1 Hz, 1H in A), 2.37-2.07 (m, 9H), 1.84 (d, J=3.3 Hz, 6H), 1.41 (d, J=6.1 Hz, 3H), 1.27-1.13 (m, 5H), 0.87 (s, 9H), 0.79-0.67 (m, 2H), 0.32 (s, 6H).

### 2′,2″′-(pyridine-2,6-diyl)bis(3-(1-adamantyl)-5-((3,3-dimethylbutyl)dimethylsilyl)-[1,1′-biphenyl]-2-ol)

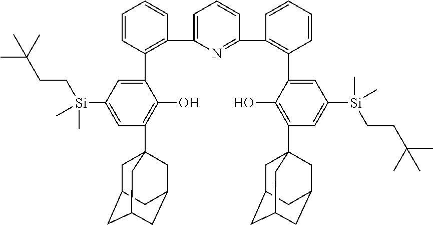 [SMILES: CC(C)(C)CC[Si](C)(C)c1cc(-c2ccccc2-c2cccc(-c3ccccc3-c3cc([Si](C)(C)CCC(C)(C)C)cc(C45CC6CC(CC(C6)C4)C5)c3O)n2)c(O)c(C23CC4CC(CC(C4)C2)C3)c1]

To a solution of (4-(1-adamantyl)-6-isopropoxy-benzo[c][1,2]benzoxaborinin-2-yl)(3,3-dimethylbutyl)dimethylsilane (1.52 g, 3.0 mmol) in 1,4-dioxane (4 mL), 2,6-dibromopyridine (0.35 g, 1.5 mmol), potassium carbonate (1.23 g, 8.9 mmol), Buchwald RuPhos Palladacycle Gen I precatalyst (Strem, CAS 1028206-60-1, 11.0 mg, 0.015 mmol), and water (2 mL) were subsequently added. This mixture was stirred for 16 hours at 100° C., then cooled to ambient temperature, and diluted with water (5 mL). The obtained mixture was extracted with dichloromethane (2×10 mL). The combined organic extracts were dried over MgSO₄, then evaporated to dryness. The residue was purified by flash chromatography on silica gel (impurities eluted with 10% dichloromethane in hexane, followed by 20% dichloromethane in hexane to elute the product). The product was isolated as a mixture of two isomers as a foamy solid (1.29 g, 90%). ¹H NMR (400 MHz, CDCl₃) δ 8.02 (s, 2H in A), 7.57-7.33 (m, 9H), 7.21-7.15 (m, 2H), 7.08 (d, J=1.5 Hz, 2H in B), 7.02 (d, J=7.7 Hz, 2H), 6.85 (s, 2H in B), 6.71 (d, J=1.5 Hz, 2H in A), 1.99-1.84 (m, 18H), 1.74-1.50 (m, 12H), 1.18-1.04 (m, 4H), 0.82 (s, 18H), 0.61-0.52 (m, 4H in B), 0.54-0.40 (m, 4H in A), 0.12 (d, J=3.9 Hz, 12H in B), −0.03 (d, J=14.3 Hz, 12H in A).

### (3-(1-adamantyl)-4-(methoxymethoxy)phenyl)(2,4,4-trimethylpentyl)dimethylsilane

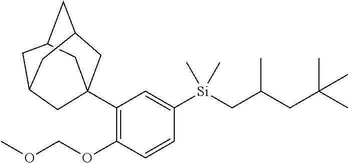 [SMILES: COCOc1ccc([Si](C)(C)CC(C)CC(C)(C)C)cc1C12CC3CC(CC(C3)C1)C2]

To a solution of 1-(5-bromo-2-(methoxymethoxy)phenyl)adamantane (2.08 g, 5.9 mmol) in THF (5 mL) at −60° C., t-BuLi in pentane (1.7 M, 7.0 mL, 12.0 mmol) was added dropwise over 10 minutes. The reaction mixture was stirred for 1 hour at −60° C., followed by addition of (2,4,4-trimethylpentyl)-dimethylchlorosilane (1.27 g, 6.1 mmol). The solution was stirred at −60° C. for 30 minutes, then stirred at ambient temperature for 1 hour. The reaction was poured into water (10 mL), and the resulting mixture was extracted with dichloromethane (2×10 mL). The combined organic extracts were dried over MgSO₄, then evaporated to dryness. The residue was purified by flash chromatography on silica gel (10% dichloromethane in hexane) to afford the product as a foamy solid (1.61 g, 61%). ¹H NMR (400 MHz, CDCl₃) δ 7.37 (d, J=1.6 Hz, 1H), 7.29 (dd, J=8.1, 1.6 Hz, 1H), 7.07 (d, J=8.1 Hz, 1H), 5.23 (s, 2H), 3.51 (s, 3H), 2.36-1.97 (m, 9H), 1.78 (br, 6H), 1.23 (dd, J=14.0, 4.3 Hz, 1H), 1.11 (dd, J=13.9, 6.4 Hz, 1H), 1.00-0.78 (m, 14H), 0.69 (dd, J=14.7, 8.8 Hz, 1H), 0.27 (d, J=3.0 Hz, 6H).

### (5-(1-adamantyl)-2′-bromo-6-(methoxymethoxy)-[1,1′-biphenyl]-3-yl)(2,4,4-trimethylpentyl)dimethylsilane

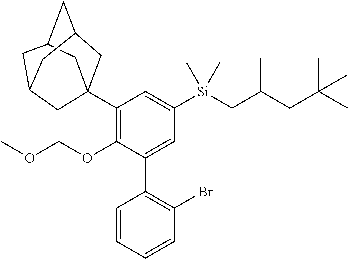 [SMILES: COCOc1c(-c2ccccc2Br)cc([Si](C)(C)CC(C)CC(C)(C)C)cc1C12CC3CC(CC(C3)C1)C2]

To a solution of (3-(1-adamantyl)-4-(methoxymethoxy)phenyl)(2,4,4-trimethylpentyl)dimethylsilane (1.60 g, 3.6 mmol) in diethyl ether (10 mL) at ambient temperature, n-BuLi in hexane (1.6 M, 2.3 mL, 3.6 mmol) was added. The solution was stirred for 1 hour, then concentrated to dryness. The lithiated intermediate was dissolved in hexane. To the resulting solution at 60° C., 2-bromochlorobenzene (0.70 g, 3.6 mmol) in hexane (1 mL) was added dropwise. The reaction was stirred for 1 hour at 60° C., then filtered through Celite. The filtrate was concentrated, and the residue was purified by flash chromatography on silica gel (10% dichloromethane in hexane) to afford the product as a foamy solid (1.95 g, 90%). ¹H NMR (400 MHz, CDCl₃) δ 7.68 (dd, J=8.0, 1.1 Hz, 1H), 7.46 (d, J=1.7 Hz, 1H), 7.42-7.31 (m, 2H), 7.24-7.15 (m, 2H), 4.52 (dd, J=4.6, 1.4 Hz, 1H), 4.43 (d, J=4.7 Hz, 1H), 3.22 (s, 3H), 2.26-2.04 (m, 9H), 1.79 (br, 6H), 1.21 (dt, J=14.0, 3.9 Hz, 1H), 1.09 (ddd, J=13.9, 6.5, 3.6 Hz, 1H), 0.97 (d, J=6.6 Hz, 1H), 0.91 (d, J=6.5 Hz, 3H), 0.89-0.82 (m, 1H), 0.81 (d, J=2.1 Hz, 9H), 0.70 (dd, J=14.7, 8.6 Hz, 1H), 0.29 (dd, J=3.9, 2.7 Hz, 6H).

### (4-(1-adamantyl)-6-hydroxy-benzo[c][1,2]benzoxaborinin-2-yl)(2,4,4-trimethylpentyl)dimethylsilane

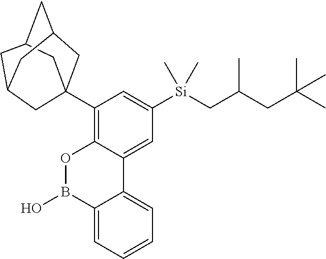 [SMILES: CC(CC(C)(C)C)C[Si](C)(C)c1cc2c(c(C34CC5CC(CC(C5)C3)C4)c1)OB(O)c1ccccc1-2]

To a solution of (5-(1-adamantyl)-2′-bromo-6-(methoxymethoxy)-[1,1′-biphenyl]-3-yl)(2,4,4-trimethylpentyl)dimethylsilane (1.95 g, 3.3 mmol) in THF (5 mL) at −60° C., ⁿBuLi in hexanes (2.5 M, 1.40 mL, 3.6 mmol) was added dropwise over 10 minutes. The reaction mixture was stirred for 1 hour at −60° C., followed by addition of 2-isopropoxy-4,4,5,5-tetramethyl-1,3,2-dioxaborolane (0.91 g, 4.9 mmol). The resulting suspension was stirred for 1 hour at ambient temperature, then poured into 5 mL of water. The resulting mixture was extracted with dichloromethane (3×5 mL). The combined organic extracts were dried over MgSO₄, then evaporated to dryness.

To the residue, isopropanol (20 mL) was added, and the resulting solution was refluxed for 6 hours. After allowing the reaction to cool to ambient temperature, the reaction was concentrated to dryness. The product was purified by flash chromatography on silica gel (impurities eluted with 20% dichloromethane in hexane, followed by 20% dichloromethane+10% EtOAc in hexane to elute the product). The product was isolated as a foamy solid (0.53 g, 33%). ¹H NMR (400 MHz, CDCl₃) δ 8.41-8.19 (m, 2H), 8.12 (ddd, J=17.0, 7.5, 1.5 Hz, 1H), 7.80-7.70 (m, 1H), 7.56-7.37 (m, 2H), 4.74 (s, 1H), 2.30 (d, J=2.9 Hz, 4H), 2.20-2.08 (m, 5H), 1.95-1.70 (m, 6H), 1.31-1.27 (m, 1H), 1.18 (ddd, J=13.9, 6.4, 2.9 Hz, 1H), 1.00 (d, J=6.6 Hz, 1H), 0.96 (dd, J=6.6, 2.8 Hz, 3H), 0.94-0.74 (m, 11H), 0.41 (dd, J=6.1, 5.1 Hz, 6H).

### 2′,2″′-(pyridine-2,6-diyl)bis(3-(1-adamantyl)-5-((2,4,4-trimethylpentyl)dimethylsilyl)-[1,1′-biphenyl]-2-ol)

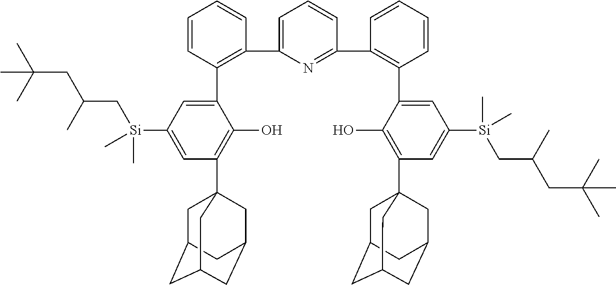 [SMILES: CC(CC(C)(C)C)C[Si](C)(C)c1cc(-c2ccccc2-c2cccc(-c3ccccc3-c3cc([Si](C)(C)CC(C)CC(C)(C)C)cc(C45CC6CC(CC(C6)C4)C5)c3O)n2)c(O)c(C23CC4CC(CC(C4)C2)C3)c1]

To a solution of (4-(1-adamantyl)-6-hydroxy-benzo[c][1,2]benzoxaborinin-2-yl)(2,4,4-trimethylpentyl)dimethylsilane (0.51 g, 1.0 mmol) in 1,4-dioxane (4 mL), 2,6-dibromopyridine (0.12 g, 0.5 mmol), potassium carbonate (0.42 g, 3.0 mmol), Buchwald RuPhos Palladacycle Gen I precatalyst (Strem, CAS 1028206-60-1, 3.7 mg, 0.005 mmol), and water (2 mL) were subsequently added. This mixture was stirred for 16 hours at 100° C., then cooled to ambient temperature, and diluted with water (5 mL). The obtained mixture was extracted with dichloromethane (2×10 mL). The combined organic extracts were dried over MgSO₄, then evaporated to dryness. The residue was purified by flash chromatography on silica gel (impurities eluted with 10% dichloromethane in hexane, followed by 20% dichloromethane in hexane to elute the product). The product was isolated as a mixture of two isomers as a foamy solid (0.45 g, 90%). ¹H NMR (400 MHz, CDCl₃) δ 7.97 (dd, J=84.0, 77.0 Hz, 2H in A), 7.58-7.32 (m, 9H), 7.21 (s, 2H), 7.14-7.07 (m, 2H in B), 7.08-6.98 (m, 2H), 6.89 (dd, J=35.9, 6.4 Hz, 2H in B), 6.78-6.67 (m, 2H in A), 2.05-1.87 (m, 18H), 1.77-1.57 (m, 12H), 1.26-1.15 (m, 2H), 1.15-1.01 (m, 2H), 0.96-0.70 (m, 28H), 0.66-0.44 (m, 2H), 0.22-0.16 (m, 12H in B), 0.12-0 (m, 12H in A).

### Preparation of Transition Metal Complexes

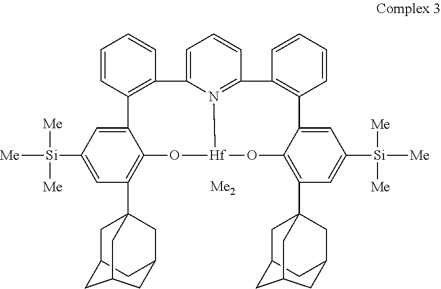

To a suspension of 97 mg (0.301 mmol) of hafnium tetrachloride in 20 mL of dry toluene, 436 uL (1.26 mmol) of 2.9 M MeMgBr in diethyl ether was added in one portion via syringe at 0° C. To the resulting suspension, 250 mg (0.301 mmol) of 2′,2″′-(pyridine-2,6-diyl)bis(3-(1-adamantyl)-5-(trimethylsilyl)-[1,1′-biphenyl]-2-ol) was immediately added in one portion. The reaction mixture was stirred for 4 hours at room temperature and then evaporated to near dryness. The solids obtained were extracted with 2×20 mL of hot toluene, and the combined organic extracts were filtered through a thin pad of Celite 503. Next, the filtrate was evaporated to dryness. The residue was triturated with 5 mL of n-hexane; the obtained precipitate was filtered off, washed two times with 5 mL of n-hexane, and then dried in vacuo. Yield 266 mg (85%) of a white-beige solid. Anal. Calc. for C₅₇H₆₉HfNSi₂O₂: C, 66.16; H, 6.72; N, 1.35. Found: C 66.47; H, 6.99; N 1.20. ¹H NMR (C₆D₆, 400 MHz): δ 7.75 (d, J=1.7 Hz, 2H), 7.28 (d, J=1.7 Hz, 2H), 6.95-7.19 (m, 8H), 6.32-6.39 (m, 3H), 2.51-2.58 (m, 6H), 2.37-2.44 (m, 6H), 2.18 (br.s, 6H), 1.95-2.02 (m, 6H), 1.80-1.87 (m, 6H), 0.30 (s, 18H), −0.11 (s, 6H). ¹³C NMR (C₆D₆, 100 MHz) δ 162.9, 157.8, 143.5, 139.8, 138.8, 134.4, 133.9, 133.6, 132.9, 132.5, 131.7, 131.4, 128.5, 128.3, 125.0, 51.8, 41.9, 38.3, 37.8, 30.0, −0.11.

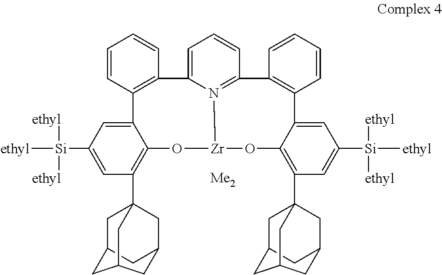

To a mixture of ZrCl₄(Et₂O)₂ (63 mg, 0.165 mmol) and 2′,2″′-(pyridine-2,6-diyl)bis(3-(1-adamantyl)-5-(triethylsilyl)-[1,1′-biphenyl]-2-ol) (375 mg, 0.150 mmol) in toluene (˜8 mL) chilled at 0° C., MeMgBr (3.0 M, 0.24 mL, 0.721 mmol) was added dropwise. The reaction mixture was stirred at ambient temperature for 90 minutes, stored at −40° C. overnight, then evaporated to near dryness. The resulting solid was extracted with pentane (˜9 mL) and toluene (˜1 mL). Extracts were filtered through Celite on a glass fiber plug. The resulting filtrate was concentrated under vacuum to an oily residue, which was triturated multiple times with pentane to eventually give alight tan foam (127 mg). The foam was dissolved in pentane and a minimal amount of toluene. The resulting solution was stored at −40° C. to afford colorless crystals, which were isolated by decantation and dried under vacuum. Yield 65.2 mg (42%). ¹H NMR (C₆D₆, 400 MHz): δ 7.73 (s, 2H), 7.21 (d, J=8.7 Hz, 4H), 7.06 (dt, J=18.9, 7.4 Hz, 4H), 6.92 (d, J=7.3 Hz, 2H), 6.55-6.50 (m, 1H), 6.42 (d, J=7.6 Hz, 2H), 2.58 (d, J=12.1 Hz, 6H), 2.44 (d, J=12.3 Hz, 6H), 2.18 (s, 6H), 1.98 (d, J=12.0 Hz, 6H), 1.83 (d, J=12.2 Hz, 6H), 1.05 (t, J=7.8 Hz, 18H), 0.83 (q, J=7.6 Hz, 12H), 0.14 (s, 6H).

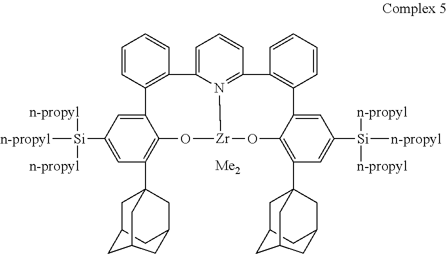

To a mixture of ZrCl₄(Et₂O)₂ (82.2 mg, 0.216 mmol) and 2′,2″′-(pyridine-2,6-diyl)bis(3-(1-adamantyl)-5-(tripropylsilyl)-[1,1′-biphenyl]-2-ol) (202 mg, 0.203 mmol) in toluene (˜3 mL) chilled at −40° C., MeMgBr (3.0 M, 0.30 mL, 0.900 mmol) was added dropwise. The reaction mixture was stirred at ambient temperature for 80 minutes, then evaporated to dryness. The resulting solid was extracted with pentane, and the combined extracts were filtered through Celite. The filtrate (˜10 mL) was stored at ambient temperature, allowing for slow evaporation. After several days, the pentane had evaporated to give clear blocks coated in brown residue, which was washed with cold pentane, then dried under vacuum to afford the product as off-white blocks (130.2 mg, 58%).

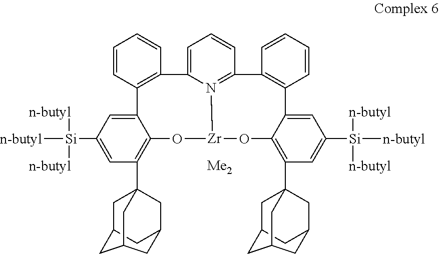

To a mixture of ZrCl₄(Et₂O)₂ (143 mg, 0.375 mmol) and 2′,2″′-(pyridine-2,6-diyl)bis(3-(1-adamantyl)-5-(tributylsilyl)-[1,1′-biphenyl]-2-ol) (375 mg, 0.347 mmol) in toluene (˜6 mL) chilled at −40° C., MeMgBr (3.0 M, 0.52 mL, 1.56 mmol) was added dropwise. The reaction mixture was stirred at ambient temperature for 25 minutes, then evaporated to near dryness. The resulting residue was triturated with pentane three times, then concentrated under vacuum to a beige solid. The solid was extracted with pentane, and the combined extracts were filtered through Celite. The filtrate (already containing some microcrystalline material) was then stored at −40° C., allowing for slow evaporation. After several days, the brown supernatant was removed, and the remaining solid was washed with cold pentane (3×0.5 mL), then dried under vacuum to afford the product as white microcrystalline solid (136 mg, 33%). The supernatant and pentane washes were combined and concentrated under vacuum to a brown foam (223 mg). Total mass recovery: 359 mg, 86%. ¹H NMR (C₆D₆, 400 MHz): δ 7.78 (d, J=1.8 Hz, 2H), 7.32-7.21 (m, 4H), 7.07 (dtd, J=21.1, 7.4, 1.5 Hz, 4H), 6.95 (dd, J=7.5, 1.6 Hz, 2H), 6.75-6.67 (m, 1H), 6.50 (d, J=7.8 Hz, 2H), 2.68-2.39 (m, 12H), 2.17 (d, J=5.1 Hz, 6H), 2.04-1.73 (m, 12H), 1.56-1.31 (m, 24H), 1.10-0.70 (m, 30H), 0.14 (s, 6H).

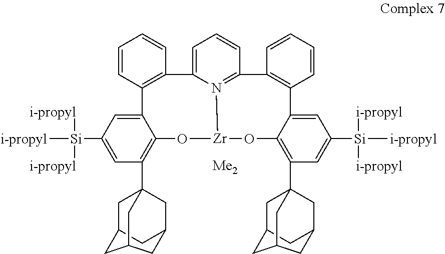

To a suspension of 701 mg (3.01 mmol) of zirconium tetrachloride in 350 mL of dry toluene, 4.36 mL (12.6 mmol, 2.9 M) of MeMgBr in diethyl ether was added in one portion via syringe at −30° C. To the resulting suspension, 3.00 g (3.01 mmol) of 2′,2″′-(pyridine-2,6-diyl)bis(3-(1-adamantyl)-5-(triisopropylsilyl)-[1,1′-biphenyl]-2-ol) was immediately added in one portion. The reaction mixture was stirred for 3 hours at room temperature and then evaporated to near dryness. The solids obtained were extracted with 2×100 mL of toluene, and the combined organic extract was filtered through a thin pad of Celite 503. Next, the filtrate was evaporated to dryness. The residue was triturated with 10 mL of n-hexane; the obtained precipitate was filtered off, washed two times with 10 mL of n-hexane, and then dried in vacuum. Yield 3.24 g (96%) of a light-beige solid. Anal. Calc. for C₆₉H₉₃ZrSi₂NO₂: C, 74.27; H, 8.40; N, 1.26. Found: C 74.41; H, 8.58; N 1.10. ¹H NMR (C₆D₆, 400 MHz): δ 7.69 (d, J=1.5 Hz, 2H), 7.23 (dd, J=7.6, 1.2 Hz, 2H), 6.99-7.14 (m, 6H), 6.94 (dd, J=7.5, 1.3 Hz, 2H), 6.71 (t, J=7.7 Hz, 1H), 6.54 (d, J=7.8 Hz, 2H), 2.54-2.63 (m, 6H), 2.40-2.49 (m, 6H), 2.18 (br.s, 6H), 1.94-2.03 (m, 6H), 1.77-1.86 (m, 6H), 1.29-1.44 (m, 6H), 1.16 (d, J=8.0 Hz, 24H), 1.14 (d, J=7.7 Hz, 12H), 0.15 (s, 6H). ¹³C NMR (C₆D₆, 100 MHz): δ 162.1, 158.5, 143.6, 137.9, 136.3, 134.6, 133.6, 133.4, 133.1, 131.7, 131.1, 124.5, 122.3, 43.7, 42.2, 38.4, 37.8, 30.0, 19.3, 11.6.

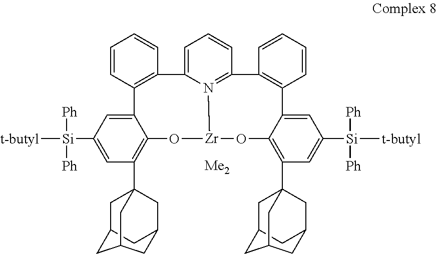

To a mixture of ZrCl₄(Et₂O)₂ (33.5 mg, 0.088 mmol) and 2′,2″′-(pyridine-2,6-diyl)bis(3-(1-adamantyl)-5-((tert-butyl)diphenylsilyl)-[1,1′-biphenyl]-2-ol) (96.6 mg, 0.083 mmol) in toluene (˜2 mL) chilled at −40° C., MeMgBr (3.0 M, 0.12 mL, 0.360 mmol) was added dropwise. The reaction mixture was stirred at ambient temperature for 95 minutes, then evaporated to dryness. The resulting solid was extracted with toluene, and the combined extracts were filtered through Celite. The resulting filtrate was concentrated under vacuum to afford the product as a solid.

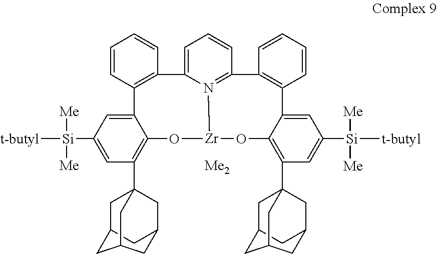

To a suspension of 766 mg (3.28 mmol) of zirconium tetrachloride in 350 mL of dry toluene, 4.80 mL (13.8 mmol) of 2.9 M MeMgBr in diethyl ether was added in one portion via syringe at −30° C. To the resulting suspension, 3.00 g (3.28 mmol) of 2′,2″′-(pyridine-2,6-diyl)bis(3-(1-adamantyl)-5-(tert-butyldimethylsilyl)-[1,1′-biphenyl]-2-ol) was immediately added in one portion. The reaction mixture was stirred for 3 hours at room temperature and then evaporated to near dryness. The solids obtained were extracted with 2×100 mL of toluene, and the combined organic extract was filtered through a thin pad of Celite 503. Next, the filtrate was evaporated to dryness. The residue was triturated with 10 mL of n-hexane; the obtained precipitate was filtered off, washed two times with 10 mL of n-hexane, and then dried in vacuum. Yield 3.14 g (93%) of a light-beige solid. Anal. Calc. for C₆₃H₈₁ZrSi₂NO₂: C, 73.34; H, 7.91; N, 1.36. Found: C 73.25; H, 7.98; N 1.32. ¹H NMR (C₆D₆, 400 MHz): δ 7.72 (d, J=1.6 Hz, 2H), 7.21-7.24 (m, 4H), 6.99-7.10 (m, 4H), 6.96 (dd, J=7.5, 1.8 Hz, 2H), 6.52 (dd, J=8.3, 7.2 Hz, 1H), 6.39 (d, J=7.6 Hz, 2H), 2.53-2.62 (m, 6H), 2.39-2.48 (m, 6H), 2.17 (br.s, 6H), 1.93-2.02 (m, 6H), 1.78-1.87 (m, 6H), 0.99 (s, 18H), 0.29 (s, 6H), 0.27 (s, 6H), 0.13 (s, 6H). ¹³C NMR (C₆D₆, 100 MHz): δ 162.3, 158.3, 143.5, 139.6, 137.9, 135.4, 133.9, 133.6, 133.0, 131.7, 131.2, 125.8, 124.5, 43.7, 42.1, 38.4, 37.8, 30.0, 27.3, 17.7, −5.3, −5.5.

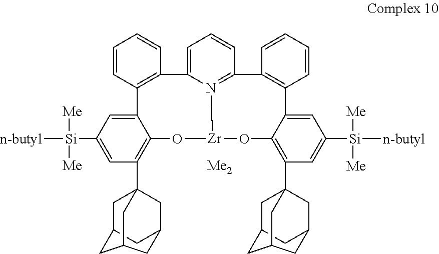

To a mixture of ZrCl₄(Et₂O)₂ (80 mg, 0.210 mmol) and 2′,2″′-(pyridine-2,6-diyl)bis(3-(1-adamantyl)-5-(n-butyldimethylsilyl)-[1,1′-biphenyl]-2-ol) (180 mg, 0.197 mmol) in toluene (˜3 mL) chilled at −40° C., MeMgBr (3.0 M, 0.30 mL, 0.900 mmol) was added dropwise. The reaction mixture was stirred at ambient temperature for 80 minutes, then evaporated to near dryness. The resulting solid was extracted with pentane, and the combined extracts were filtered through Celite. The filtrate (˜2 mL) was stored at ambient temperature, allowing for slow evaporation. After several days, the pentane had evaporated to give a solid, which was washed with cold pentane on a plastic fritted funnel, then dried under vacuum to afford the product as an off-white powder (75.8 mg, 37%).

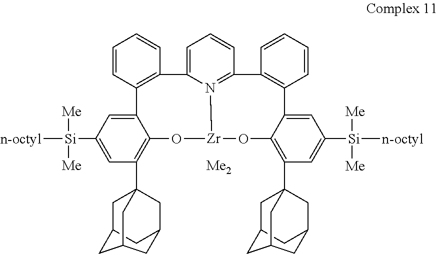

To a mixture of ZrCl₄(Et₂O)₂ (55 mg, 0.144 mmol) and 2′,2″′-(pyridine-2,6-diyl)bis(3-(1-adamantanyl)-5-(dimethyl(octyl)silyl)-[1,1′-biphenyl]-2-ol) (141 mg, 0.137 mmol) in toluene (˜3 mL) chilled at −40° C., MeMgBr (3.0 M, 0.2 mL, 0.600 mmol) was added dropwise. The reaction mixture was stirred at ambient temperature for 30 minutes, then evaporated to near dryness. The resulting solid was extracted with pentane. Extracts were filtered through Celite on a glass fiber plug. The resulting filtrate was concentrated under vacuum to give a light tan foam. Yield 54.2 mg (34.5%).

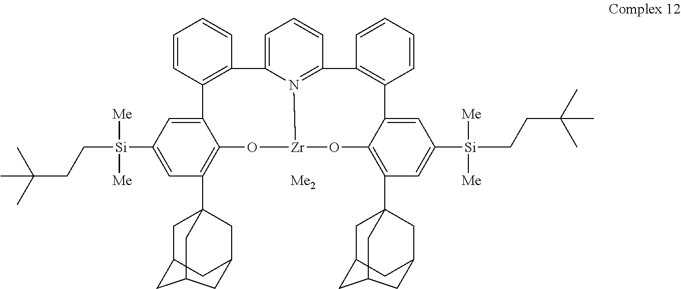

To a mixture of ZrCl₄(Et₂O)₂ (54.4 mg, 0.143 mmol) and 2′,2″′-(pyridine-2,6-diyl)bis(3-(1-adamantyl)-5-((3,3-dimethylbutyl)dimethylsilyl)-[1,1′-biphenyl]-2-ol) (130 mg, 0.134 mmol) in toluene (˜2 mL) chilled at −40° C., MeMgBr (3.0 M, 0.20 mL, 0.600 mmol) was added dropwise. The reaction mixture was stirred at ambient temperature for 2 hours, then evaporated to dryness. The resulting solid was extracted with pentane, and the combined extracts were filtered through Celite.

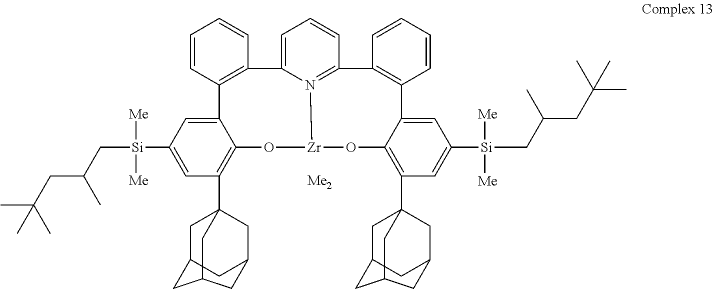

To a mixture of ZrCl₄(Et₂O)₂ (55.4 mg, 0.145 mmol) and 2′,2″′-(pyridine-2,6-diyl)bis(3-(1-adamantyl)-5-((2,4,4-trimethylpentyl)dimethylsilyl)-[1,1′-biphenyl]-2-ol) (140 mg, 0.137 mmol) in toluene (˜2 mL) chilled at −40° C., MeMgBr (3.0 M, 0.20 mL, 0.600 mmol) was added dropwise. The reaction mixture was stirred at ambient temperature for 2 hours, then evaporated to dryness. The resulting solid was extracted with pentane, and the combined extracts were filtered through Celite.

### Solubility of Complexes

General considerations: Solubility studies for complexes 2, 6, and 9 were performed using recrystallized material. Solubility studies for all other complexes were performed using material as synthesized. Complex 2 was co-crystallized with 1.4 equivalents of methycyclohexane. Complex 9 was co-crystallized with 0.52 equivalents of isohexane. Solvents used were sparged with nitrogen (30-60 minutes) and dried over 3 Å mole sieves. Unless stated otherwise, all measurements were performed at ambient temperature (20-25° C.).

General procedure: Solubility was determined using the following Method 1 or Method 2. For calculations, a value of 0.672 g/mL was used for the density of isohexane.

Method 1. A tared vial was loaded with a small amount of the complex (actual mass recorded, including any residual solvent as noted above, typically 5-30 mg). Then a small stir bar (8 mm) was added. Solvent was then added and the mixture was stirred rapidly (1000 rpm). If a homogeneous mixture did not form within 30 minutes, then additional solvent was added and mixture was stirred for an additional 30 minutes. This process was repeated until either a clear solution was obtained (no visible solids or murkiness) or the vial was full. As the mixture approached homogeneity (i.e., few remaining solids observed) the volume of the solvent additions was kept small (<1 mL) to minimize excess beyond the solvent required to achieve homogeneity. The stir bar was then removed and the mass of the mixture was measured. If a clear solution had formed then the solubility of the complex was calculated as a single value, based on the mass of complex and the amount of solvent added to achieve a homogeneous solution. If the mixture remained heterogeneous (visible solids or murky), then the value reported is given as being “less than” the calculated value.

Method 2. A measured amount of complex (actual mass recorded, including any residual solvent as noted above) was added to a tared vial, followed by a stir bar. Dry isohexanes were added in small portions and the resulting mixture was stirred after each portion of isohexanes. If a clear solution had formed then the solubility was reported as a range, the lower bound of solubility calculated using the total solvent added to achieve a homogenous solution and the upper bound of solubility calculated using the total solvent measured prior to achieving a homogenous solution. If the mixture remained heterogeneous (visible solids or murky), the upper bound of solubility was calculated using the total solvent added.

Formula used to calculate solubility are listed below. Solvent present in the complex is included in the mass and formula weight of the complexes.

$$Solubility ( in mM ) = [ \text{} {10}^{6} ] * [ ( grams of complex ) / ( formula wt . of complex in g / mol ) ] / [ ( total volume of solvent in mL ) ] ,$$

$$or$$

$$Solubility ( in mM ) = [ \text{} {10}^{6} ] * [ \text{} ( grams of complex ) / ( formula wt . of complex in g / mol ) ] / [ \text{} ( grams of solvent ) / ( density of solvent in g / mL ) ]$$

$$Solubility ( in wt \% ) = [ \text{} 100 ] * [ \text{} ( grams of complex ) / [ ( grams of complex ) + ( total volume of solvent in mL ) * ( density of solvent in g / mL ) ] ] ,$$

$$or$$

$$Solubility ( in wt \% ) = [ 100 ] * [ ( weight of complex ) / ( weight of solution ) ] .$$

TABLE 1
Solubility of select complexes in isohexane at ambient temperature.

| | Solubility (s) in | Solubility (s) in |
|---|---|---|
| Complex | Isohexane (mM) | Isohexane (wt %) |
| 1 | <0.6 | <0.08 |
| 2 | 0.52 | 0.081 |
| 6 | 15.5 ≤ s < 31.0 | 2.61 ≤ s < 5.09 |
| 7 | <0.9 | <0.14 |
| 9 | <3.0 | <0.52 |

### Polymerization Examples

Solutions of the pre-catalysts were made using toluene (ExxonMobil Chemical-anhydrous, stored under N₂) (98%) or isohexane (ExxonMobil Chemical—polymerization grade, and purified as described below). Pre-catalyst solutions were typically 0.5 mmol/L.

Solvents, polymerization grade toluene and/or isohexanes were supplied by ExxonMobil Chemical Co. and are purified by passing through a series of columns: two 500 cc Oxyclear cylinders in series from Labclear (Oakland, Calif.), followed by two 500 cc columns in series packed with dried 3 Amole sieves (8-12 mesh; Aldrich Chemical Company), and two 500 cc columns in series packed with dried 5 Å mole sieves (8-12 mesh; Aldrich Chemical Company).

Polymerization grade propylene (C₃) was used and further purified by passing it through a series of columns: 2250 cc Oxiclear cylinder from Labclear followed by a 2250 cc column packed with 3 Å mole sieves (8-12 mesh; Aldrich Chemical Company), then two 500 cc columns in series packed with 5 Å mole sieves (8-12 mesh; Aldrich Chemical Company), then a 500 cc column packed with Selexsorb CD (BASF), and finally a 500 cc column packed with Selexsorb COS (BASF).

Activation of the pre-catalysts was either by dimethylanilinium tetrakisperfluorophenylborate (Boulder Scientific or Albemarle Corp; Act ID=A) or is (hydrogenated tallow alkyl)methylammonium tetrakis(pentafluorophenyl)borate supplied as a 10 wt % solution in methylcyclohexane (Boulder Scientific; Act ID=B). Activators were typically used as a 0.25 mmol/L solution in toluene or isohexane.

Tri-n-octylaluminum (TnOAl or TNOA, Neat, AkzoNobel) was also used as a scavenger prior to introduction of the activator and pre-catalyst into the reactor. TNOA was typically used as a 5 mmol/L solution in toluene or isohexane.

### Reactor Description and Preparation:

Polymerizations were conducted in an inert atmosphere (N2) drybox using autoclaves equipped with an external heater for temperature control, glass inserts (internal volume of 22.5 mL), septum inlets, regulated supply of nitrogen and propylene, and equipped with disposable PEEK mechanical stirrers (800 RPM). The autoclaves were prepared by purging with dry nitrogen at 110° C. or 115° C. for 5 hours and then at 25° C. for 5 hours.

### Propylene Polymerization (PP):

The reactor was prepared as described above, then heated to 40° C., and then purged with propylene gas at atmospheric pressure. Toluene or isohexanes, liquid propylene (1.0 mL) and scavenger (TNOA, 0.5 μmol) were added via syringe. The reactor was then brought to process temperature (70° C. or 100° C.) while stirring at 800 RPM. The activator solution, followed by the pre-catalyst solution, were injected via syringe to the reactor at process conditions. Reactor temperature was monitored and typically maintained within +/−1° C. Polymerizations were halted by addition of approximately 50 psi compressed dry air gas mixture to the autoclaves for approximately 30 seconds. The polymerizations were quenched based on a predetermined pressure loss (maximum quench value) or for a maximum of 30 minutes. The reactors were cooled and vented. The polymers were isolated after the solvent was removed in-vacuo. The actual quench time (s) is reported as quench time (s). Yields reported include total weight of polymer and residual catalyst. Catalyst activity is reported as grams of polymer per mmol transition metal compound per hour of reaction time (g/mmol·hr). Propylene homopolymerization examples are reported in Table 2 with additional characterization in Table 3.

### Polymer Characterization

For analytical testing, polymer sample solutions were prepared by dissolving polymer in 1,2,4-trichlorobenzene (TCB, 99+% purity from Sigma-Aldrich) containing 2,6-di-tert-butyl-4-methylphenol (BHT, 99% from Aldrich) at 165° C. in a shaker oven for approximately 3 hours. The typical concentration of polymer in solution was between 0.1 to 0.9 mg/mL with a BHT concentration of 1.25 mg BHT/mL of TCB. Samples were cooled to 135° C. for testing.

High temperature size exclusion chromatography was performed using an automated “Rapid GPC” system as described in U.S. Pat. Nos. 6,491,816; 6,491,823; 6,475,391; 6,461,515; 6,436,292; 6,406,632; 6,175,409; 6,454,947; 6,260,407; and 6,294,388; each of which is incorporated herein by reference. Molecular weights (weight average molecular weight (Mw), number average molecular weight (Mn) and z average molecular weight (Mz)) and molecular weight distribution (MWD=Mw/Mn), which is also sometimes referred to as the polydispersity (PDI) of the polymer, were measured by Gel Permeation Chromatography using a Symyx Technology GPC equipped with evaporative light scattering detector (ELSD) and calibrated using polystyrene standards (Polymer Laboratories: Polystyrene Calibration Kit S-M-10: Mp (peak Mw) between 5000 and 3,390,000). Alternatively, samples were measured by Gel Permeation Chromatography using a Symyx Technology GPC equipped with dual wavelength infrared detector and calibrated using polystyrene standards (Polymer Laboratories: Polystyrene Calibration Kit S-M-10: Mp (peak Mw) between 580 and 3,039,000). Samples (250 μL of a polymer solution in TCB were injected into the system) were run at an eluent flow rate of 2.0 mL/minute (135° C. sample temperatures, 165° C. oven/columns) using three Polymer Laboratories: PLgel 10 μm Mixed-B 300×7.5 mm columns in series. No column spreading corrections were employed. Numerical analyses were performed using Epoch® software available from Symyx Technologies or Automation Studio software available from Freeslate. The molecular weights obtained are relative to linear polystyrene standards. Molecular weight data is reported in Table 2 under the headings Mn, Mw, Mz and PDI as defined above.

Differential Scanning Calorimetry (DSC) measurements were performed on a TA-Q100 instrument to determine the melting point of the polymers. Samples were pre-annealed at 220° C. for 15 minutes and then allowed to cool to room temperature overnight. The samples were then heated to 220° C. at a rate of 100° C./minute and then cooled at a rate of 50° C./minute. Melting points were collected during the heating period. The results are reported in the Table 2 under the heading, Tm (° C.).

¹³C NMR spectroscopy was used to characterize some polypropylene polymer samples produced in experiments collected in Table 2. This data is collected in Table 3. Unless otherwise indicated the polymer samples for ¹³C NMR spectroscopy were dissolved in d₂-1,1,2,2-tetrachloroethane and the samples were recorded at 125° C. using a NMR spectrometer with a ¹³C NMR frequency of 150 MHz. Polymer resonance peaks are referenced to mmmm=21.8 ppm. Calculations involved in the characterization of polymers by NMR follow the work of F. A. Bovey in “Polymer Conformation and Configuration” Academic Press, New York 1969 and J. Randall in “Polymer Sequence Determination, Carbon-13 NMR Method”, Academic Press, New York, 1977.

The stereodefects measured as “stereo defects/10,000 monomer units” are calculated from the sum of the intensities of mmrr, mmrm+rrmr, and rmrm resonance peaks times 5000. The intensities used in the calculations are normalized to the total number of monomers in the sample. Methods for measuring 2,1 regio defects/10,000 monomers and 1,3 regio defects/10,000 monomers follow standard methods. Additional references include Grassi, A. et.al. Macromolecules, 1988, v) 21, pp. 617-622 and Busico et.al. Macromolecules, 1994, v)27, pp. 7538-7543. The average meso run length=10000/[(stereo defects/10000 C)+(2,1-regio defects/10000 C)+(1,3-regio-defects/10000 C)].

Polymerization results are collected in Tables 2 and 3. “Ex #” stands for example number. Example numbers starting with a “C” are comparative examples. “Cat ID” identifies the pre-catalyst used in the experiment. Corresponding numbers identifying the pre-catalyst (also referred to as pre-catalyst, catalyst, complex or compound) are located in the synthetic experimental section. T(° C.) is the polymerization temperature which was typically maintained within +/−1° C. “Yield” is polymer yield, and is not corrected for catalyst residue. “Quench time (s)” is the actual duration of the polymerization run in seconds. For propylene homopolymerization runs, quench value indicates the maximum set pressure loss (conversion) of propylene (for PP runs) during the polymerization. Activity is reported at grams polymer per mmol of catalyst per hour.

Standard polymerization conditions include 0.015 μmol catalyst complex, 1.1 equivalence of activator, 0.5 μmol TNOA scavenger, 1.0 ml propylene, 4.1 ml total solvent, with quench value at 8 psi pressure loss, or a maximum reaction time of 30 minutes. Activator A is N,N-dimethylanilinium tetrakis(pentafluorophenyl)borate activator and activator B is (hydrogenated tallow alkyl)methylammonium tetrakis(pentafluorophenyl)borate. When activator A was used, both the pre-catalyst and activator solutions were in toluene. When activator B was used, both pre-catalyst and activator solutions were in isohexane. Small amounts of methylcyclohexane (MCH) result from activator B being supplied by the manufacturer as a 10 wt % solution in methylcyclohexane.

TABLE 2
Propylene Polymerizations

| | | | | | | | quench | | Activity | | | | | |
|---|---|---|---|---|---|---|---|---|---|---|---|---|---|---|
| Ex | Cat | Act | MCH | Isohexane | Toluene | T | time | yield | (gP/mmol | | | | | Tm |
| # | ID | ID | (uL) | (uL) | (uL) | (C.) | (s) | (g) | cat · hr) | Mn | Mw | Mz | PDI | (° C.) |
| 1 | 3 | A | 0 | 3874 | 226 | 70 | 65 | 0.2910 | 1,074,462 | 207,387 | 482,608 | 1,606,480 | 2.33 | 156.1 |
| 2 | 3 | A | 0 | 3874 | 226 | 70 | 80 | 0.3448 | 1,034,400 | 171,566 | 466,890 | 1,492,212 | 2.72 | 157.0 |
| 3 | 3 | A | 0 | 3874 | 226 | 70 | 72 | 0.3513 | 1,171,000 | 155,002 | 420,998 | 1,264,177 | 2.72 | 154.8 |
| 4 | 3 | A | 0 | 3874 | 226 | 100 | 48 | 0.1951 | 975,500 | 79,240 | 150,590 | 373,139 | 1.90 | 157.8 |
| 5 | 3 | A | 0 | 3874 | 226 | 100 | 32 | 0.1897 | 1,422,750 | 67,470 | 147,194 | 455,494 | 2.18 | 157.9 |
| 6 | 3 | A | 0 | 3874 | 226 | 100 | 40 | 0.2209 | 1,325,400 | 70,422 | 133,053 | 315,235 | 1.89 | 155.1 |
| 7 | 4 | A | 0 | 3874 | 226 | 70 | 27 | 0.4172 | 3,708,444 | 111,418 | 458,896 | 1,444,241 | 4.12 | 147.2 |
| 8 | 4 | A | 0 | 3874 | 226 | 70 | 15 | 0.4012 | 6,419,200 | 88,190 | 466,932 | 1,932,156 | 5.29 | 147.0 |
| 9 | 4 | A | 0 | 3874 | 226 | 70 | 8 | 0.3956 | 11,868,000 | 140,453 | 462,025 | 1,341,517 | 3.29 | 148.2 |
| 10 | 4 | A | 0 | 3874 | 226 | 100 | 18 | 0.3276 | 4,368,000 | 42,699 | 164,756 | 618,265 | 3.86 | 146.9 |
| 11 | 4 | A | 0 | 3874 | 226 | 100 | 11 | 0.2715 | 5,923,636 | 49,951 | 172,391 | 614,329 | 3.45 | 147.0 |
| 12 | 4 | A | 0 | 3874 | 226 | 100 | 10 | 0.2749 | 6,597,600 | 43,188 | 171,112 | 619,199 | 3.96 | 148.4 |
| 13 | 5 | A | 0 | 3974 | 126 | 70 | 13 | 0.3805 | 7,024,615 | 85,456 | 420,052 | 1,542,633 | 4.92 | 146.4 |
| 14 | 5 | A | 0 | 3974 | 126 | 70 | 61 | 0.3981 | 1,566,295 | 102,035 | 493,388 | 2,047,813 | 4.84 | 147.4 |
| 15 | 5 | A | 0 | 3974 | 126 | 70 | 13 | 0.3599 | 6,644,308 | 75,770 | 496,267 | 2,992,143 | 6.55 | 146.8 |
| 16 | 5 | A | 0 | 3974 | 126 | 100 | 15 | 0.2184 | 3,494,400 | 55,624 | 189,989 | 853,831 | 3.42 | 145.5 |
| 17 | 5 | A | 0 | 3974 | 126 | 100 | 31 | 0.1824 | 1,412,129 | 97,375 | 267,726 | 902,909 | 2.75 | 147.4 |
| 18 | 5 | B | 0.23 | 4100 | 0 | 70 | 43 | 0.3251 | 1,814,512 | 167,716 | 526,312 | 1,686,282 | 3.14 | 146.9 |
| 19 | 5 | B | 0.23 | 4100 | 0 | 70 | 34 | 0.3003 | 2,119,765 | 149,836 | 534,430 | 2,196,975 | 3.57 | 147.8 |
| 20 | 5 | B | 0.23 | 4100 | 0 | 70 | 44 | 0.2563 | 1,398,000 | 144,284 | 504,478 | 1,858,330 | 3.50 | 147.9 |
| 21 | 5 | B | 0.23 | 4100 | 0 | 100 | 21 | 0.1763 | 2,014,857 | 71,824 | 221,836 | 809,937 | 3.09 | 145.9 |
| 22 | 5 | B | 0.23 | 4100 | 0 | 100 | 25 | 0.1819 | 1,746,240 | 63,723 | 241,005 | 1,444,639 | 3.78 | 147.3 |
| 23 | 5 | B | 0.23 | 4100 | 0 | 100 | 30 | 0.2155 | 1,724,000 | 88,985 | 243,309 | 868,657 | 2.73 | 146.1 |
| 24 | 6 | A | 0 | 3974 | 126 | 70 | 15 | 0.3649 | 5,838,400 | 91,040 | 398,867 | 1,389,534 | 4.38 | 146.3 |
| 25 | 6 | A | 0 | 3974 | 126 | 70 | 26 | 0.4091 | 3,776,308 | 87,008 | 393,015 | 1,277,810 | 4.52 | 145.3 |
| 26 | 6 | A | 0 | 3974 | 126 | 70 | 9 | 0.3577 | 9,538,667 | 85,731 | 397,120 | 1,339,491 | 4.63 | 146.2 |
| 27 | 6 | A | 0 | 3974 | 126 | 100 | 47 | 0.2842 | 1,451,234 | 55,036 | 148,207 | 433,931 | 2.69 | 144.9 |
| 28 | 6 | A | 0 | 3974 | 126 | 100 | 21 | 0.2056 | 2,349,714 | 64,081 | 156,406 | 459,866 | 2.44 | 145.0 |
| 29 | 6 | B | 0.23 | 4100 | 0 | 70 | 83 | 0.2697 | 779,855 | 350,605 | 675,058 | 1,632,056 | 1.93 | 147.8 |
| 30 | 6 | B | 0.23 | 4100 | 0 | 70 | 74 | 0.2562 | 830,919 | 368,689 | 699,636 | 1,617,401 | 1.90 | 148.4 |
| 31 | 6 | B | 0.23 | 4100 | 0 | 70 | 63 | 0.2934 | 1,117,714 | 268,328 | 592,180 | 1,606,073 | 2.21 | 148.1 |
| 32 | 6 | B | 0.23 | 4100 | 0 | 100 | 54 | 0.1327 | 589,778 | 154,898 | 315,221 | 819,971 | 2.04 | 147.1 |
| 33 | 6 | B | 0.23 | 4100 | 0 | 100 | 42 | 0.1780 | 1,017,143 | 144,864 | 277,639 | 726,182 | 1.92 | 146.1 |
| 34 | 6 | B | 0.23 | 4100 | 0 | 100 | 85 | 0.2642 | 745,976 | 131,943 | 248,630 | 593,285 | 1.88 | 146.6 |
| 35 | 7 | A | 0 | 3974 | 126 | 70 | 20 | 0.3234 | 3,880,800 | 109,708 | 378,019 | 1,254,295 | 3.45 | 146.0 |
| 36 | 7 | A | 0 | 3974 | 126 | 70 | 37 | 0.3984 | 2,584,216 | 108,723 | 385,903 | 1,219,686 | 3.55 | 146.5 |
| 37 | 7 | A | 0 | 3974 | 126 | 70 | 29 | 0.3967 | 3,283,034 | 133,405 | 468,982 | 1,734,426 | 3.52 | 147.7 |
| 38 | 7 | A | 0 | 3974 | 126 | 100 | 17 | 0.2857 | 4,033,412 | 61,750 | 164,696 | 520,671 | 2.67 | 144.7 |
| 39 | 7 | A | 0 | 3974 | 126 | 100 | 15 | 0.2860 | 4,576,000 | 48,136 | 152,464 | 473,832 | 3.17 | 144.7 |
| 40 | 7 | A | 0 | 3974 | 126 | 100 | 23 | 0.2622 | 2,736,000 | 80,339 | 196,647 | 564,933 | 2.45 | 145.8 |
| 41 | 7 | B | 0.23 | 4100 | 0 | 70 | 84 | 0.3567 | 1,019,143 | 267,000 | 548,385 | 1,345,439 | 2.05 | 148.1 |
| 42 | 7 | B | 0.23 | 4100 | 0 | 70 | 77 | 0.3541 | 1,103,688 | 236,088 | 568,095 | 1,552,441 | 2.41 | 147.8 |
| 43 | 7 | B | 0.23 | 4100 | 0 | 70 | 45 | 0.3075 | 1,640,000 | 224,163 | 525,886 | 1,376,123 | 2.35 | 148.1 |
| 44 | 7 | B | 0.23 | 4100 | 0 | 100 | 99 | 0.2509 | 608,242 | 131,490 | 267,532 | 645,739 | 2.03 | 147.1 |
| 45 | 7 | B | 0.23 | 4100 | 0 | 100 | 31 | 0.2089 | 1,617,290 | 119,345 | 250,044 | 685,814 | 2.10 | 145.9 |
| 46 | 7 | B | 0.23 | 4100 | 0 | 100 | 34 | 0.2108 | 1,488,000 | 113,741 | 243,230 | 650,726 | 2.14 | 147.0 |
| 47 | 9 | A | 0 | 3974 | 126 | 70 | 49 | 0.3277 | 1,605,061 | 199,705 | 480,415 | 1,309,951 | 2.41 | 148.6 |
| 48 | 9 | A | 0 | 3974 | 126 | 70 | 19 | 0.3763 | 4,753,263 | 88,071 | 410,310 | 1,273,292 | 4.66 | 146.0 |
| 49 | 9 | A | 0 | 3974 | 126 | 70 | 12 | 0.3942 | 7,884,000 | 142,514 | 507,081 | 1,687,349 | 3.56 | 146.8 |
| 50 | 9 | A | 0 | 3974 | 126 | 100 | 27 | 0.2734 | 2,430,222 | 32,705 | 148,534 | 490,893 | 4.54 | 143.6 |
| 51 | 9 | A | 0 | 3974 | 126 | 100 | 20 | 0.3100 | 3,720,000 | 40,569 | 154,778 | 557,201 | 3.82 | 145.0 |
| 52 | 9 | A | 0 | 3974 | 126 | 100 | 23 | 0.2991 | 3,121,043 | 44,934 | 150,040 | 494,063 | 3.34 | 143.9 |
| 53 | 9 | B | 0.23 | 4100 | 0 | 70 | 55 | 0.3585 | 1,564,364 | 202,016 | 521,245 | 1,457,630 | 2.58 | 147.3 |
| 54 | 9 | B | 0.23 | 4100 | 0 | 70 | 34 | 0.3044 | 2,148,706 | 176,615 | 523,744 | 1,647,575 | 2.97 | 147.7 |
| 55 | 9 | B | 0.23 | 4100 | 0 | 70 | 29 | 0.3639 | 3,011,586 | 185,056 | 536,480 | 1,609,807 | 2.90 | 148.1 |
| 56 | 9 | B | 0.23 | 4100 | 0 | 100 | 29 | 0.2483 | 2,054,897 | 92,604 | 239,867 | 726,886 | 2.59 | 146.1 |
| 57 | 9 | B | 0.23 | 4100 | 0 | 100 | 20 | 0.2268 | 2,721,600 | 84,511 | 221,351 | 689,069 | 2.62 | 145.6 |
| 58 | 9 | B | 0.23 | 4100 | 0 | 100 | 25 | 0.2851 | 2,736,960 | 87,978 | 215,651 | 644,793 | 2.45 | 145.4 |
| 59 | 10 | A | 0 | 3974 | 126 | 70 | 19 | 0.3348 | 4,229,053 | 62,555 | 407,565 | 1,635,854 | 6.52 | 144.3 |
| 60 | 10 | A | 0 | 3974 | 126 | 70 | 14 | 0.3815 | 6,540,000 | 82,678 | 430,493 | 2,158,752 | 5.21 | 145.4 |
| 61 | 10 | A | 0 | 3974 | 126 | 70 | 17 | 0.4157 | 5,868,706 | 52,431 | 437,768 | 1,721,768 | 8.35 | 144.8 |
| 62 | 10 | A | 0 | 3974 | 126 | 100 | 30 | 0.3246 | 2,596,800 | 30,836 | 130,267 | 741,310 | 4.22 | 143.3 |
| 63 | 10 | A | 0 | 3974 | 126 | 100 | 11 | 0.2480 | 5,410,909 | 38,571 | 167,300 | 1,003,634 | 4.34 | 144.4 |
| 64 | 10 | A | 0 | 3974 | 126 | 100 | 30 | 0.3005 | 2,404,000 | 20,521 | 139,126 | 739,678 | 6.78 | 142.9 |
| 65 | 10 | B | 0.23 | 4100 | 0 | 70 | 52 | 0.3847 | 1,775,538 | 127,580 | 519,767 | 1,779,669 | 4.07 | 147.9 |
| 66 | 10 | B | 0.23 | 4100 | 0 | 70 | 47 | 0.3832 | 1,956,766 | 139,176 | 586,040 | 2,797,405 | 4.21 | 147.1 |
| 67 | 10 | B | 0.23 | 4100 | 0 | 70 | 44 | 0.3344 | 1,824,000 | 180,904 | 590,647 | 2,091,623 | 3.26 | 148.1 |
| 68 | 10 | B | 0.23 | 4100 | 0 | 100 | 25 | 0.2120 | 2,035,200 | 80,710 | 236,834 | 804,834 | 2.93 | 146.3 |
| 69 | 10 | B | 0.23 | 4100 | 0 | 100 | 26 | 0.2169 | 2,002,154 | 85,893 | 235,585 | 808,095 | 2.74 | 146.6 |
| 70 | 10 | B | 0.23 | 4100 | 0 | 100 | 32 | 0.2341 | 1,755,750 | 96,837 | 247,645 | 942,277 | 2.56 | 146.3 |
| C1 | 1 | A | 0 | 3874 | 226 | 70 | 15 | 0.3543 | 5,668,800 | 57,753 | 372,797 | 1,464,190 | 6.46 | 147.5 |
| C2 | 1 | A | 0 | 3874 | 226 | 70 | 13 | 0.4127 | 7,619,077 | 64,376 | 502,821 | 2,141,863 | 7.81 | 147.3 |
| C3 | 1 | A | 0 | 3874 | 226 | 70 | 14 | 0.4037 | 6,920,571 | 67,290 | 428,075 | 1,753,319 | 6.36 | 148.1 |
| C4 | 1 | A | 0 | 3874 | 226 | 100 | 16 | 0.2621 | 3,931,500 | 28,762 | 152,087 | 646,646 | 5.29 | 145.8 |
| C5 | 1 | A | 0 | 3874 | 226 | 100 | 17 | 0.3151 | 4,448,471 | 34,553 | 155,815 | 665,846 | 4.51 | 145.8 |
| C6 | 1 | A | 0 | 3874 | 226 | 100 | 20 | 0.2204 | 2,644,800 | 48,560 | 169,007 | 624,200 | 3.48 | 147.0 |
| C7 | 2 | A | 0 | 3974 | 126 | 70 | 17 | 0.3777 | 5,332,235 | 51,771 | 409,655 | 1,643,708 | 7.91 | 147.1 |
| C8 | 2 | A | 0 | 3974 | 126 | 70 | 22 | 0.4310 | 4,701,818 | 73,251 | 422,884 | 1,794,768 | 5.77 | 147.1 |
| C9 | 2 | A | 0 | 3974 | 126 | 70 | 10 | 0.4143 | 9,943,200 | 79,137 | 427,915 | 1,704,507 | 5.41 | 148.3 |
| C10 | 2 | A | 0 | 3974 | 126 | 100 | 19 | 0.2842 | 3,589,895 | 41,269 | 157,755 | 608,816 | 3.82 | 147.6 |
| C11 | 2 | A | 0 | 3974 | 126 | 100 | 21 | 0.3363 | 3,843,429 | 20,519 | 118,735 | 547,511 | 5.79 | 145.6 |
| C12 | 2 | A | 0 | 3974 | 126 | 100 | 8 | 0.2458 | 7,374,000 | 31,384 | 149,968 | 649,731 | 4.78 | 146.6 |
| C13 | 2 | B | 0.23 | 4100 | 0 | 70 | 41 | 0.3535 | 2,069,268 | 142,243 | 528,329 | 1,786,121 | 3.71 | 148.8 |
| C14 | 2 | B | 0.23 | 4100 | 0 | 70 | 20 | 0.3501 | 4,201,200 | 146,842 | 583,343 | 2,112,818 | 3.97 | 149.3 |
| C15 | 2 | B | 0.23 | 4100 | 0 | 70 | 22 | 0.2818 | 3,074,182 | 153,727 | 515,347 | 1,774,716 | 3.35 | 148.6 |
| C16 | 2 | B | 0.23 | 4100 | 0 | 100 | 24 | 0.2345 | 2,345,000 | 63,491 | 180,083 | 621,548 | 2.84 | 148.0 |
| C17 | 2 | B | 0.23 | 4100 | 0 | 100 | 22 | 0.2459 | 2,682,545 | 54,833 | 161,679 | 531,840 | 2.95 | 147.3 |
| C18 | 2 | B | 0.23 | 4100 | 0 | 100 | 31 | 0.2874 | 2,225,032 | 47,288 | 169,722 | 733,298 | 3.59 | 148.0 |

TABLE 3
¹³C NMR characterization of select polypropylene examples. All defects are reported as defects
per 10,000 monomer units. No 2,1-regio (te) defects and 1,3-regio defects were observed.

| | | | | | | | | | | | | | | | 2,1-regio | 2,1-regio |
|---|---|---|---|---|---|---|---|---|---|---|---|---|---|---|---|---|
| Ex | Cat | Act | | | | | | | mmrm + | | | | | stereo | (ee) | (et) |
| # | ID | ID | m | r | mmmm | mmmr | rmmr | mmrr | rmrr | rmrm | rrrr | mrrr | mrrm | defects | defects | defects |
| 1 | 3 | A | 0.988 | 0.012 | 0.968 | 0.008 | 0.004 | 0.007 | 0.006 | 0.003 | 0.000 | 0.001 | 0.003 | 75.9 | 17.4 | 4.7 |
| 6 | 3 | A | 0.987 | 0.013 | 0.967 | 0.008 | 0.005 | 0.008 | 0.004 | 0.002 | 0.000 | 0.002 | 0.004 | 71.0 | 15.5 | 0.0 |
| 8 | 4 | A | 0.987 | 0.013 | 0.967 | 0.009 | 0.003 | 0.010 | 0.003 | 0.001 | 0.000 | 0.001 | 0.005 | 71.9 | 64.3 | 9.8 |
| 12 | 4 | A | 0.985 | 0.015 | 0.958 | 0.011 | 0.006 | 0.012 | 0.005 | 0.003 | 0.000 | 0.000 | 0.004 | 97.6 | 69.2 | 9.2 |
| 14 | 5 | A | 0.986 | 0.014 | 0.965 | 0.010 | 0.004 | 0.007 | 0.006 | 0.002 | 0.001 | 0.001 | 0.005 | 71.6 | 67.4 | 10.5 |
| 17 | 5 | A | 0.971 | 0.029 | 0.933 | 0.014 | 0.007 | 0.011 | 0.016 | 0.005 | 0.002 | 0.004 | 0.008 | 153.1 | 68.2 | 9.9 |
| 19 | 5 | B | 0.988 | 0.012 | 0.969 | 0.009 | 0.003 | 0.008 | 0.005 | 0.001 | 0.000 | 0.001 | 0.005 | 67.0 | 68.1 | 10.5 |
| 22 | 5 | B | 0.974 | 0.026 | 0.938 | 0.013 | 0.008 | 0.013 | 0.012 | 0.005 | 0.001 | 0.002 | 0.008 | 148.0 | 63.8 | 9.3 |
| 26 | 6 | A | 0.984 | 0.016 | 0.958 | 0.010 | 0.008 | 0.009 | 0.005 | 0.001 | 0.001 | 0.002 | 0.005 | 72.1 | 72.2 | 13.5 |
| 27 | 6 | A | 0.984 | 0.016 | 0.960 | 0.007 | 0.010 | 0.009 | 0.005 | 0.001 | 0.000 | 0.003 | 0.005 | 75.4 | 73.3 | 11.8 |
| 30 | 6 | B | 0.984 | 0.016 | 0.959 | 0.009 | 0.010 | 0.006 | 0.007 | 0.002 | 0.001 | 0.003 | 0.005 | 70.0 | 70.3 | 12.7 |
| 34 | 6 | B | 0.982 | 0.018 | 0.953 | 0.010 | 0.010 | 0.007 | 0.008 | 0.002 | 0.000 | 0.003 | 0.006 | 83.9 | 85.8 | 17.2 |
| 36 | 7 | A | 0.983 | 0.017 | 0.967 | 0.006 | 0.004 | 0.006 | 0.005 | 0.001 | 0.001 | 0.003 | 0.007 | 57.6 | 66.9 | 10.0 |
| 39 | 7 | A | 0.978 | 0.022 | 0.944 | 0.013 | 0.010 | 0.012 | 0.007 | 0.002 | 0.001 | 0.003 | 0.007 | 105.7 | 72.5 | 13.2 |
| 43 | 7 | B | 0.985 | 0.015 | 0.959 | 0.010 | 0.009 | 0.007 | 0.006 | 0.001 | 0.000 | 0.003 | 0.005 | 70.5 | 68.4 | 13.4 |
| 46 | 7 | B | 0.981 | 0.019 | 0.949 | 0.012 | 0.010 | 0.010 | 0.009 | 0.002 | 0.001 | 0.002 | 0.005 | 101.4 | 68.4 | 14.1 |
| 49 | 9 | A | 0.980 | 0.020 | 0.951 | 0.011 | 0.009 | 0.010 | 0.006 | 0.002 | 0.001 | 0.004 | 0.006 | 86.1 | 67.4 | 8.5 |
| 51 | 9 | A | 0.973 | 0.027 | 0.934 | 0.014 | 0.012 | 0.011 | 0.009 | 0.004 | 0.002 | 0.005 | 0.008 | 117.3 | 78.4 | 18.1 |
| 55 | 9 | B | 0.984 | 0.016 | 0.960 | 0.009 | 0.007 | 0.007 | 0.006 | 0.001 | 0.001 | 0.003 | 0.005 | 70.2 | 71.7 | 11.4 |
| 58 | 9 | B | 0.984 | 0.016 | 0.959 | 0.011 | 0.006 | 0.008 | 0.006 | 0.001 | 0.000 | 0.002 | 0.005 | 78.1 | 79.3 | 13.5 |
| 60 | 10 | A | 0.985 | 0.015 | 0.962 | 0.010 | 0.005 | 0.008 | 0.006 | 0.002 | 0.001 | 0.001 | 0.005 | 78.8 | 70.2 | 10.9 |
| 64 | 10 | A | 0.981 | 0.019 | 0.948 | 0.014 | 0.008 | 0.008 | 0.010 | 0.004 | 0.001 | 0.001 | 0.006 | 107.1 | 76.1 | 14.5 |
| 66 | 10 | B | 0.981 | 0.019 | 0.947 | 0.011 | 0.011 | 0.008 | 0.011 | 0.004 | 0.001 | 0.002 | 0.005 | 112.0 | 65.7 | 8.3 |
| 69 | 10 | B | 0.970 | 0.030 | 0.931 | 0.014 | 0.009 | 0.012 | 0.015 | 0.006 | 0.002 | 0.003 | 0.008 | 158.1 | 75.5 | 11.0 |
| C1 | 1 | A | 0.987 | 0.013 | 0.964 | 0.008 | 0.006 | 0.010 | 0.004 | 0.002 | 0.000 | 0.001 | 0.004 | 78.0 | 64.9 | 9.1 |
| C4 | 1 | A | 0.979 | 0.021 | 0.953 | 0.008 | 0.007 | 0.011 | 0.006 | 0.003 | 0.002 | 0.002 | 0.007 | 100.5 | 66.5 | 11.0 |
| C9 | 2 | A | 0.980 | 0.020 | 0.957 | 0.008 | 0.005 | 0.011 | 0.007 | 0.003 | 0.001 | 0.002 | 0.006 | 99.4 | 64.7 | 8.9 |
| C12 | 2 | A | 0.970 | 0.030 | 0.935 | 0.011 | 0.009 | 0.014 | 0.011 | 0.006 | 0.002 | 0.003 | 0.009 | 153.5 | 63.0 | 10.8 |
| C14 | 2 | B | 0.988 | 0.012 | 0.970 | 0.007 | 0.004 | 0.009 | 0.004 | 0.002 | 0.000 | 0.001 | 0.004 | 71.6 | 59.9 | 8.0 |
| C17 | 2 | B | 0.982 | 0.018 | 0.957 | 0.009 | 0.006 | 0.011 | 0.006 | 0.003 | 0.001 | 0.001 | 0.006 | 96.2 | 65.9 | 9.0 |

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges may appear in one or more claims below. All numerical values are “about” or “approximately” the indicated value, and take into account experimental error and variations that would be expected by a person having ordinary skill in the art. Any of the values in the tables can provide the end points for ranges that define their respective measurement or property, with an additional +/−10%.

All documents described herein are incorporated by reference herein, including any priority documents and/or testing procedures to the extent they are not inconsistent with this text. As is apparent from the foregoing general description and the specific embodiments, while forms of the present disclosure have been illustrated and described, various modifications can be made without departing from the spirit and scope of the present disclosure. Accordingly, it is not intended that the present disclosure be limited thereby.

While the present disclosure has been described with respect to a number of embodiments and examples, those skilled in the art, having benefit of this disclosure, will appreciate that other embodiments can be devised which do not depart from the scope and spirit of the present disclosure.

1. A catalyst compound represented by Formula (I): 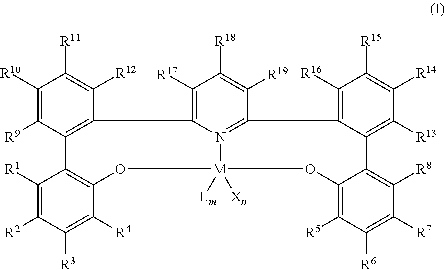
wherein:
M is a group 3, 4, or 5 metal;
L is a Lewis base;
X is an anionic ligand;
n is 1, 2, or 3;
m is 0, 1, or 2;
n+m is not greater than 4;
each of R¹, R², R³, R⁴, R⁵, R⁶, R⁷, and R⁸ is independently hydrogen, C₁-C₄₀ hydrocarbyl, C₁-C₁₂₀ substituted hydrocarbyl, a heteroatom or a heteroatom-containing group, or one or more of R¹ and R², R² and R³, R³ and R⁴, R⁵ and R⁶, R⁶ and R⁷, or R⁷ and R⁸ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R⁹, R¹⁰, R¹¹, and R¹² is independently hydrogen, C₁-C₄₀ hydrocarbyl, C₁-C₁₂₀ substituted hydrocarbyl, a heteroatom or a heteroatom-containing group, or one or more of R⁹ and R¹⁰, R¹⁰ and R¹¹, or R¹¹ and R¹² may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹³, R¹⁴, R¹⁵, and R¹⁶ is independently hydrogen, C₁-C₄₀ hydrocarbyl, C₁-C₁₂₀ substituted hydrocarbyl, a heteroatom or a heteroatom-containing group, or one or more of R¹³ and R¹⁴, R¹⁴ and R¹⁵, or R¹⁵ and R¹⁶ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
each of R¹⁷, R¹⁸, and R¹⁹ is independently hydrogen, C₁-C₄₀ hydrocarbyl, C₁-C₁₂₀ substituted hydrocarbyl, a heteroatom or a heteroatom-containing group, or one or more of R¹⁷ and R¹⁸, R¹⁸ and R¹⁹, or R¹⁷ and R¹⁹ may be joined to form one or more substituted hydrocarbyl rings, unsubstituted hydrocarbyl rings, substituted heterocyclic rings, or unsubstituted heterocyclic rings each having 5, 6, 7, or 8 ring atoms;
any two L groups may be joined together to form a bidentate Lewis base;
an X group may be joined to an L group to form a monoanionic bidentate group;
any two X groups may be joined together to form a dianionic ligand group;
and with the proviso that at least one of R¹, R², R³, R⁶, R⁷, R⁸, R⁹, R¹⁰, R¹¹, R¹², R¹³, R¹⁴, R¹⁵, and R¹⁶ independently contains a silyl or germyl group of the form A(R^{a})(R^{b})(R^{c}) where A is Si or Ge and each of R^{a}, R^{b}, and R^{c} is independently C₁-C₄₀ hydrocarbyl or C₁-C₄₀ substituted hydrocarbyl, or one or more of R^{a} and R^{b}, R^{a} and R^{c}, or R^{b} and R^{c} may be joined to form one or more substituted hydrocarbyl rings or unsubstituted hydrocarbyl rings.

2. The catalyst compound of claim 1, wherein the catalyst compound is represented by Formula (II), 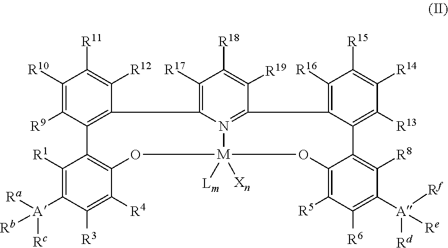
wherein:
each of A′ and A″ is independently Si or Ge; and each of R^{a}, R^{b}, R^{c}, R^{d}, R^{e}, and R^{f} is independently C₁-C₄₀ hydrocarbyl or C₁-C₄₀ substituted hydrocarbyl, or one or more of R^{a} and R^{b}, R^{a} and R^{c}, R^{b} and R^{c}, R^{d} and R^{e}, R^{d} and R^{f} or R^{e} and R^{f} may be joined to form one or more substituted hydrocarbyl rings or unsubstituted hydrocarbyl rings.

3. The catalyst compound of claim 1, wherein R² and R⁷ independently contain a silyl or germyl group, where A is Si or Ge, and optionally A(R^{a})(R^{b})(R^{c}) contains at least seven carbons.

4. The catalyst compound of claim 1, wherein R² and R⁷ each contain a silyl group of the form A(R^{a})(R^{b})(R^{c}), where A is Si, A(R^{a})(R^{b})(R^{c}) contains at least seven carbons, and at least one, of R^{a}, R^{b}, and R^{c} is an aliphatic (C₃-C₄₀)hydrocarbyl or (C₂-C₄₀)heterohydrocarbyl containing a linear carbon chain at least three carbons in length terminally bound to A.

5. The catalyst compound of claim 2, with A′ and A″ being Si, A′(R^{a})(R^{b})(R^{c}) containing at least seven carbons, and A″(R^{e})(R^{f})(R^{g}) containing at least seven carbons.

6. The catalyst compound of claim 2, with A′ and A″ being Si, A′(R^{a})(R^{b})(R^{c}) containing at least seven carbons, at least one, of R^{a}, R^{b}, and R^{c} being an aliphatic (C₃-C₄₀)hydrocarbyl or (C₂-C₄₀)heterohydrocarbyl containing a linear carbon chain at least three carbons in length terminally bound to A′, A″(R^{e})(R^{f})(R^{g}) containing at least seven carbons, and at least one of R^{d}, R^{e}, and R^{f} being an aliphatic (C₃-C₄₀)hydrocarbyl or (C₂-C₄₀)heterohydrocarbyl containing a linear carbon chain at least three carbons in length terminally bound to A″.

7. The catalyst compound of claim 1, wherein R⁴ and R⁵ are independently adamantyl or substituted adamantyl.

8. The catalyst compound of claim 1, wherein the catalyst compound is one of the following:

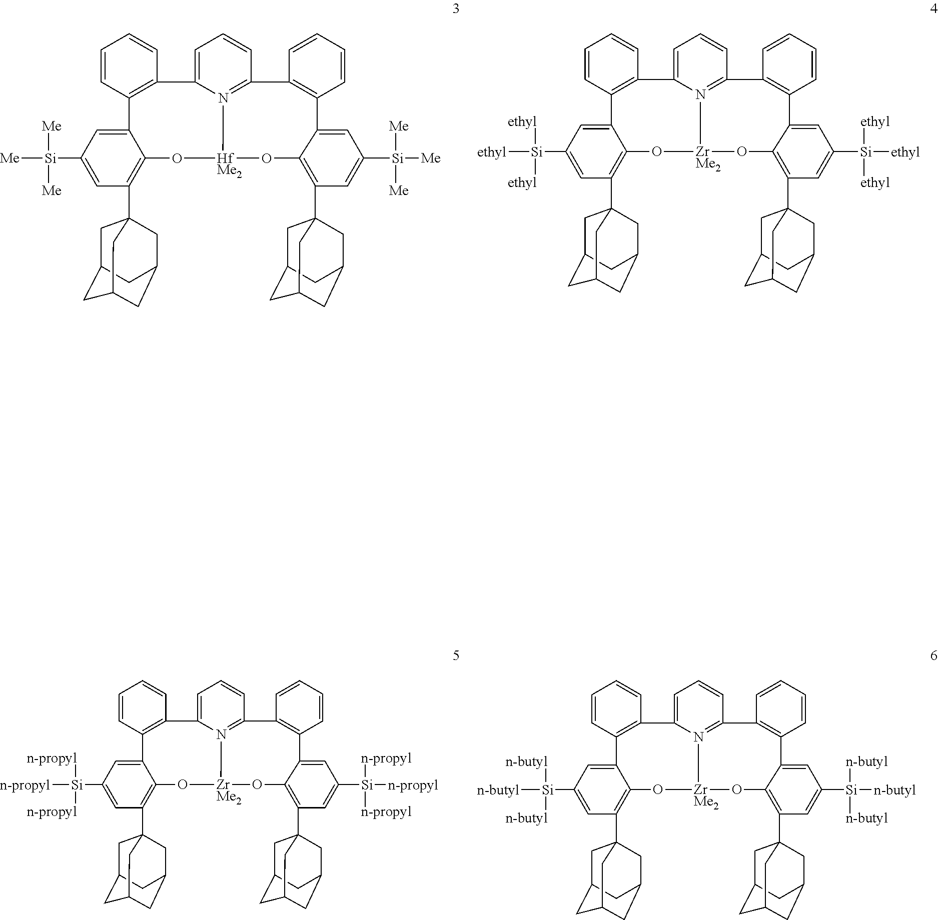

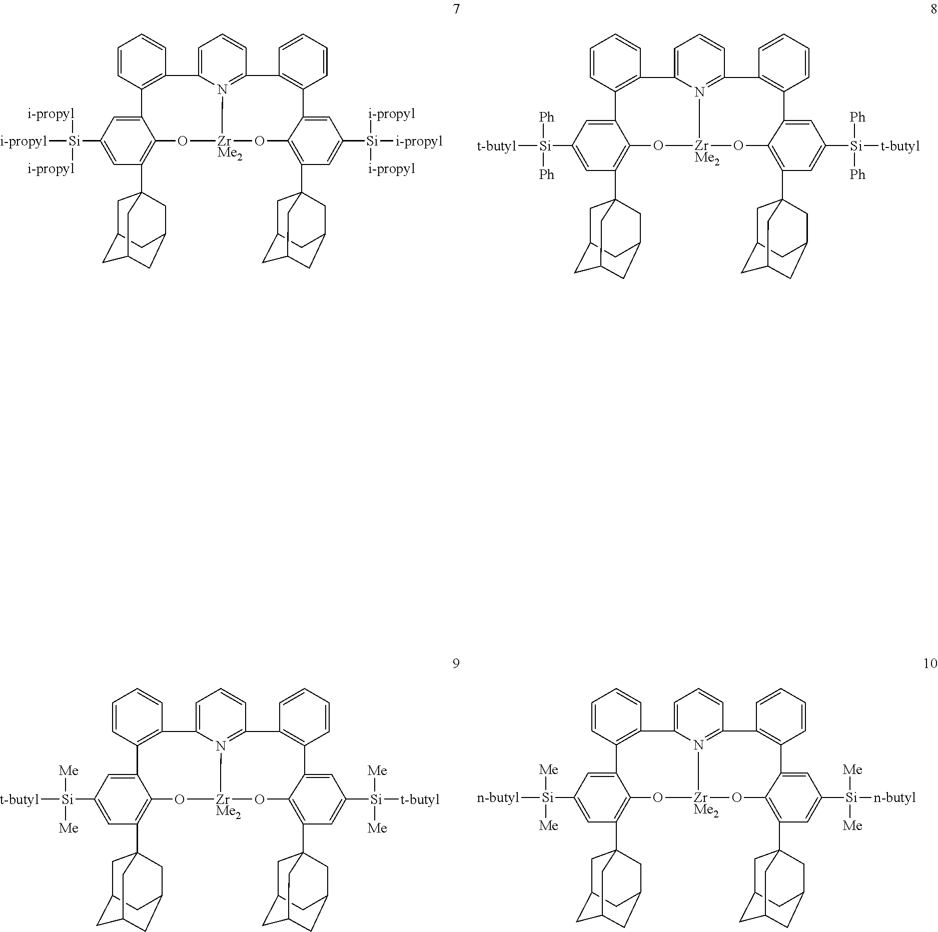

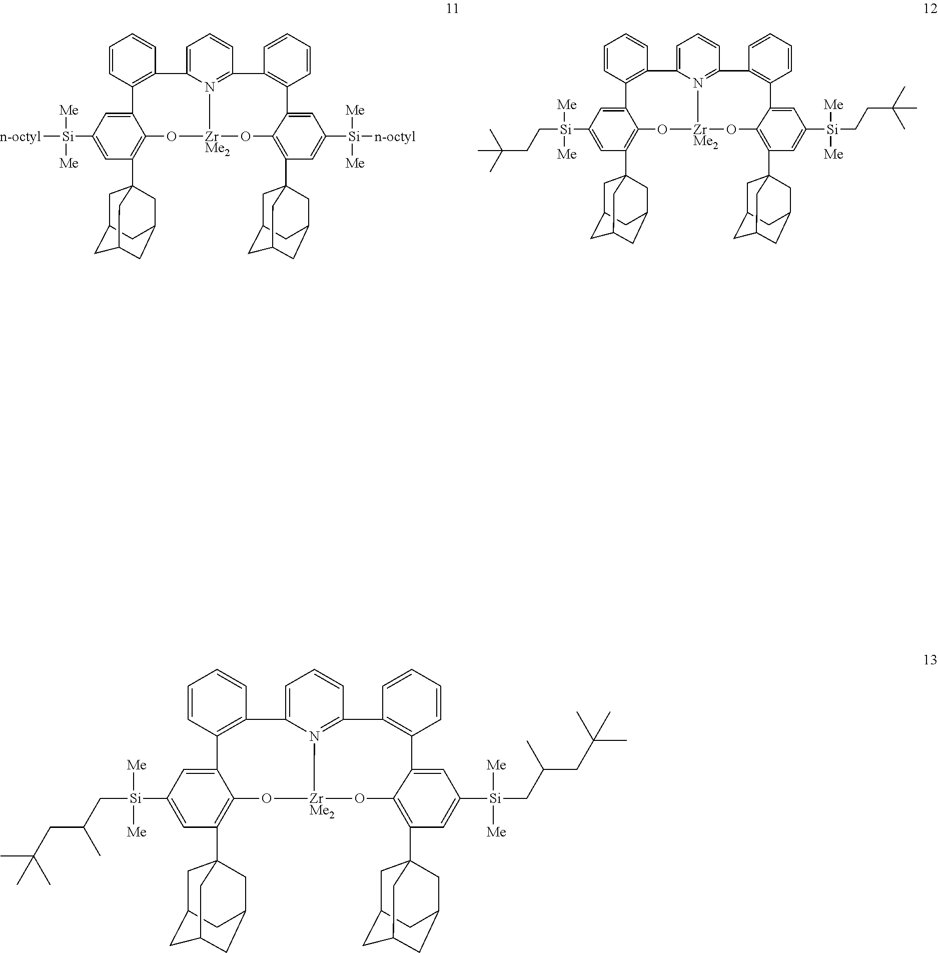

9. A catalyst system comprising an activator, and optionally a support material, and the catalyst compound of claim 1.

10. A homogeneous solution, comprising:
an aliphatic hydrocarbon solvent; and
at least one catalyst compound of claim 1, with a concentration of the at least one catalyst compound being 0.20 wt % or greater.

11. The homogeneous solution of claim 10, wherein the aliphatic hydrocarbon solvent is isohexane, cyclohexane, methylcyclohexane, pentane, isopentane, heptane, an isoparaffin solvent, a non-aromatic cyclic solvent, or combinations thereof.

12. A process for the production of a propylene or ethylene based polymer or copolymer, comprising: polymerizing propylene and/or ethylene and an optional comonomer by contacting the propylene and/or ethylene and an optional comonomer with a catalyst system of claim 9, in one or more continuous stirred tank reactors or loop reactors, in series or in parallel, at a reactor pressure of from 0.05 MPa to 1,500 MPa and a reactor temperature of from 30° C. to 230° C. to form the propylene or ethylene based polymer or copolymer.

13. The process of claim 12, wherein the catalyst system and the activator are fed into the reactor(s) separately.

14. The process of claim 12, wherein the catalyst system and the activator are pre-mixed prior to being fed into the reactor(s).
